(19) United States
(12) Patent Application Publication
(10) Pub. No.: US 2022/0379267 A1
(43) Pub. Date: Dec. 1, 2022

(54) SYSTEMS AND METHODS FOR PURIFYING AQUEOUS SOLUTIONS

(71) Applicant: VANDERBILT UNIVERSITY, Nashville, TN (US)

(72) Inventors: Shihong Lin, Nashville, TN (US); Thomas Horseman, Nashville, TN (US)

(21) Appl. No.: 17/825,110

(22) Filed: May 26, 2022

Related U.S. Application Data
(60) Provisional application No. 63/193,942, filed on May 27, 2021.

(51) Int. Cl. B01D 69/12; C02F 1/44; B01D 71/26; B01D 71/36; B01D 71/48; B01D 71/34; B01D 71/50; B01D 71/54

(52) U.S. Cl. CPC B01D 69/12; C02F 1/447; B01D 71/26; B01D 71/36; B01D 71/48; B01D 71/34; B01D 71/50; B01D 71/54; B01D 2325/22; B01D 2325/36

(57) ABSTRACT

Disclosed herein are systems and methods for purifying aqueous solutions. For example, disclosed herein are flexible membrane distillation systems comprising one or more stages stacked on top of each other, wherein each stage comprises: a feedwater layer; a membrane distillation layer; a distillate layer; and a thermally conductive layer. The systems further comprise substantially impermeable top surface, bottom surface, and perimeter. Each feedwater layer is independently receives a portion of a contaminated aqueous solution (a feed solution). Each feedwater layer further receives heat from a heat source to distill at least a portion of the feed solution through the membrane distillation layer, thereby producing a distillate in the distillate layer. Distilling said portion of the feed solution through the membrane distillation layer purifies said portion of the feed solution to produce a purified aqueous solution, which is condensed in the distillate layer to form a condensate.

### CROSS-REFERENCE TO RELATED APPLICATIONS

This application claims the benefit of priority to U.S. Provisional Application No. 63/193,942 filed May 27, 2021, which is hereby incorporated herein by reference in its entirety.

### BACKGROUND

The demand for freshwater is beginning to exceed what is readily available. With population increase, industrialization, and drought, the gap between freshwater supply and demand is only expected to increase. Thus, desalination and water reuse are essential to sustainable future development. However, due to technical difficulties in treating these contaminated waters, desalination and water reuse are inherently energy intensive. As such, centralized water treatment systems are not always practical where energy sources are limited.

The growing demand for water conservation to augment the sustainability of the water supply requires the development of technology that can facilitate conservation through desalination, water harvesting, and reuse. Furthermore, technologies that can utilize readily available, renewable energy sources to desalinate and reuse water, would promote universal access to freshwater. The systems and methods described herein address these and other needs.

### SUMMARY

In accordance with the purposes of the disclosed systems and methods, as embodied and broadly described herein, the disclosed subject matter relates to systems and methods for purifying contaminated aqueous solutions. For example, the systems and methods for purifying contaminated aqueous solutions can be used for water conservation by means of harvest and reuse.

For example, disclosed herein are flexible membrane distillation systems for purifying a contaminated aqueous solution to form a purified aqueous solution for collection in a receptacle; the systems comprising one or more stages stacked on top of each other (e.g., from a first stage to a last stage), wherein each stage comprises, stacked on top of each other in the following order from top to bottom: a feedwater layer; a membrane distillation layer; a distillate layer; and a thermally conductive layer; wherein the system further comprises one or more feedwater protrusion(s) fluidly connected to each feedwater layer and one or more distillate protrusion(s) fluidly connected to each distillate layer. The systems further comprise: a top surface; a bottom surface opposite and spaced apart from the top surface; a perimeter defined by an edge; and one or more conduits; wherein the top surface, the bottom surface, and the perimeter of the system are each substantially impermeable; wherein the perimeter of the system is perforated by the one or more conduits; wherein each of the one or more conduits has an exterior surface that is substantially impermeable and an interior surface that defines a lumen; wherein the lumen of each of the one or more conduits contains a first portion of at least one of the protrusions and a second portion of said protrusion extends beyond the distal end of the conduit; and wherein the second portion of each of the one or more feedwater protrusions is configured to be in contact with the contaminated aqueous solution.

When the system comprises a plurality of stages, the stages are stacked on top of each other from the first stage to the final stage, such that the thermally conductive layer of a preceding stage is disposed on top of and in physical and thermal contact with the feedwater layer of a subsequent stage.

When the system is deployed, the second portion of each of the one or more feedwater protrusions are each independently configured to be in contact with a contaminated aqueous solution. Each of the one or more feedwater layers is independently configured to receive a portion of the contaminated aqueous solution from its respective feedwater protrusion, said portion of the contaminated aqueous solution being a feed solution.

Each of the one or more feedwater layers is further configured to receive heat from a heat source to thereby at least a portion of the feed solution through the membrane distillation layer, thereby producing a distillate in the distillate layer.

For example, the feedwater layer of at least the first stage further comprises a solar absorber material, the system is coupled to an external heat source (e.g., a hot contaminated aqueous source, a heat exchanger, a heater, etc.), the system further comprises a solar absorber layer on top of and in physical and thermal contact with the feedwater layer of the first stage, or a combination thereof. The system is configured to conduct the heat provided by the external heat source and/or heat collected by the solar absorber material to the feedwater layer of the first stage to thereby distill at least a portion of the feed solution through the membrane distillation layer, thereby producing a distillate in the distillate layer.

When the system includes two or more stages, the thermally conductive layer of a preceding stage is configured to collect the latent heat of condensation released during the formation of the condensate in said preceding stage and conduct the collected latent heat of condensation to the feedwater layer of a subsequent stage to thereby distill at least a portion of the feed solution through the membrane distillation layer of said subsequent stage, thereby producing a distillate in said distillate layer.

Each distillate layer is configured to receive said distillate from said membrane distillation layer and condense the distillate to form a condensate and release a latent heat of condensation. Distilling said portion of the feed solution through the membrane distillation layer purifies said portion of the feed solution to produce a purified aqueous solution as the condensate.

The second portion of each of the one or more distillate protrusions are each independently configured to be disposed within a receptacle, such that the receptacle is configured to receive and collect the purified aqueous solution from each of the one or more distillate layers via their respective distillate protrusions.

In some examples, the system further comprises the receptacle.

In some examples, the system is buoyant. In some examples, the system further comprises a buoyant frame that is configured to be coupled to the system and/or the receptacle such that the system and/or the receptacle is buoyant. In some examples, the system is configured to be deployed in a reservoir containing the contaminated aqueous solution, the contaminated aqueous solution in the reservoir having a surface, and wherein the system is configured to be buoyant, such that the system floats in the contaminated aqueous solution when deployed therein, such that at least the solar absorber layer is disposed above the surface of the contaminated aqueous solution.

In some examples, the system further comprises a solar absorber layer and the solar absorber layer comprises black paint, a carbonaceous material, or a combination thereof.

In some examples, each of the protrusions and their respective feedwater or distillate layers independently comprise a hydrophilic polymer. In some examples, each of the protrusions and their respective feedwater or distillate layers independently comprise cellulose or derivatives thereof, polyacrylonitrile or derivatives thereof, or combinations thereof.

In some examples, the top surface of each membrane distillation layer is superhydrophobic. In some examples, each membrane distillation layer independently comprises a porous distillation membrane. In some examples, he porous distillation membrane comprises a hydrophobic polymer. In some examples, the porous distillation membrane comprises polyvinylidene fluoride (PVDF), polypropylene, polytetrafluoroethylene (PTFE), polyamide, derivatives thereof, or combinations thereof.

In some examples, each of the thermally conductive layers independently comprises a thermally conductive and corrosion resistant material.

In some examples, the system has five or more stages in total.

In some examples, the top surface of the system has an area of from 0.1-1 m².

In some examples, the system has a specific water productivity of 1 liters of water per square meter of area of the top surface of the system per hour (L m⁻² h⁻¹, LMH) or more (e.g., 2.5 LMH or more, 5 LMH or more, 8 LMH or more, or 10 MH or more).

In some examples, the system is configured as a portable solar-driven system for potable water production.

In some examples, the contaminated aqueous solution comprises seawater. In some examples, the contaminated aqueous solution comprises saline water.

In some examples, the purified aqueous solution comprises potable water.

In some examples, the system further comprises one or more pumps configured to pump the contaminated aqueous solution into each feedwater layer and/or to pump the purified aqueous solution into the receptacle.

In some examples, the system is configured to be robust, such that the system can be rolled and/or folded to be stored and then unrolled/unfolded to be deployed multiple times without the layers being damaged or delaminating, such that the specific water productivity is substantially unaffected.

Also disclosed herein are methods of use of the systems disclosed herein. In some examples, the method comprises deploying the system in a contaminated aqueous solution and exposing the system to solar radiation to form a purified aqueous solution.

Also disclosed herein are methods of making the systems disclosed herein. In some examples, the method comprises disposing each of the layers within a stage on top of one another, subsequently stacking each of the stages on top of one another and disposing or coating the solar absorber layer on the top surface. In some examples, the method further comprises making each of the layers. In some examples, the method comprises layer-by-layer electrospinning of the layers.

Also disclosed herein are methods of sealing the perimeter of each layer and/or methods of sealing the layers of one or more stage of any of the systems disclosed herein. In some examples, the method comprises using layer-by-layer electrospinning of the layers, solvent induced welding, an adhesive, heat pressing, or a combination thereof to seal the perimeter of each layer and/or to seal the layers together.

Additional advantages of the disclosed systems and methods will be set forth in part in the description which follows, and in part will be obvious from the description. The advantages of the disclosed systems and methods will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### DESCRIPTION OF FIGURES

The accompanying figures, which are incorporated in and constitute a part of this specification, illustrate several aspects of the disclosure, and together with the description, serve to explain the principles of the disclosure.

FIG. 1 is a schematic cross-sectional plan view of an example system 100 comprising a first stage 120 as disclosed herein according to one implementation.

FIG. 2 is a schematic cross-sectional plan view of an example first stage 120 as disclosed herein according to one implementation.

FIG. 3 is a schematic cross-sectional plan view of an example first feedwater layer 200 as disclosed herein according to one implementation.

FIG. 4 is a schematic cross-sectional plan view of an example first distillate layer 220 as disclosed herein according to one implementation.

FIG. 5 is a schematic cross-sectional plan view of an example system comprising a first stage 120 as disclosed herein according to one implementation.

FIG. 6 is a schematic cross-sectional plan view of an example system comprising a first stage 120 as disclosed herein according to one implementation.

FIG. 7 is a schematic cross-sectional plan view of an example system comprising a first stage 120 as disclosed herein according to one implementation.

FIG. 8 is a schematic cross-sectional plan view of an example system comprising a first stage 120 as disclosed herein according to one implementation.

FIG. 9 is a schematic cross-sectional plan view of an example terminal feedwater layer 600 as disclosed herein according to one implementation.

FIG. 10 is a schematic cross-sectional plan view of an example system comprising a first stage 120 as disclosed herein according to one implementation.

FIG. 11 is a schematic cross-sectional plan view of an example system comprising a first stage 120 as disclosed herein according to one implementation.

FIG. 12 is a schematic cross-sectional plan view of an example system 100 comprising a first stage 120 and a second stage 130 as disclosed herein according to one implementation.

FIG. 13 is a schematic cross-sectional plan view of an example second stage 130 as disclosed herein according to one implementation.

FIG. 14 is a schematic cross-sectional plan view of an example second feedwater layer 300 as disclosed herein according to one implementation.

FIG. 15 is a schematic cross-sectional plan view of an example second distillate layer 320 as disclosed herein according to one implementation.

FIG. 16 is a schematic cross-sectional plan view of an example system comprising a first stage 120 and a second stage 130 as disclosed herein according to one implementation.

FIG. 17 is a schematic cross-sectional plan view of an example system comprising a first stage 120 and a second stage 130 as disclosed herein according to one implementation.

FIG. 18 is a schematic cross-sectional plan view of an example system comprising a first stage 120 and a second stage 130 as disclosed herein according to one implementation.

FIG. 19 is a schematic cross-sectional plan view of an example system comprising a first stage 120 and a second stage 130 as disclosed herein according to one implementation.

FIG. 20 is a schematic cross-sectional plan view of an example system comprising a first stage 120 and a second stage 130 as disclosed herein according to one implementation.

FIG. 21 is a schematic cross-sectional plan view of an example system comprising a first stage 120 and a second stage 130 as disclosed herein according to one implementation.

FIG. 22 is a schematic cross-sectional plan view of an example system 100 comprising a first stage 120, a second stage 130, and a third stage 3120 as disclosed herein according to one implementation.

FIG. 23 is a schematic cross-sectional plan view of an example third stage 3120 as disclosed herein according to one implementation.

FIG. 24 is a schematic cross-sectional plan view of an example third feedwater layer 3200 as disclosed herein according to one implementation.

FIG. 25 is a schematic cross-sectional plan view of an example third distillate layer 3220 as disclosed herein according to one implementation.

FIG. 26 is a schematic cross-sectional plan view of an example system 100 comprising a first stage 120, a second stage 130, and a third stage 3120 as disclosed herein according to one implementation.

FIG. 27 is a schematic cross-sectional plan view of an example system 100 comprising a first stage 120, a second stage 130, and a third stage 3120 as disclosed herein according to one implementation.

FIG. 28 is a schematic cross-sectional plan view of an example system 100 comprising a first stage 120, a second stage 130, and a third stage 3120 as disclosed herein according to one implementation.

FIG. 29 is a schematic cross-sectional plan view of an example system 100 comprising a first stage 120, a second stage 130, and a third stage 3120 as disclosed herein according to one implementation.

FIG. 30 is a schematic cross-sectional plan view of an example system 100 comprising a first stage 120, a second stage 130, and a third stage 3120 as disclosed herein according to one implementation.

FIG. 31 is a schematic cross-sectional plan view of an example system 100 comprising a first stage 120, a second stage 130, and a third stage 3120 as disclosed herein according to one implementation.

FIG. 32 is a schematic cross-sectional plan view of an example system 100 comprising a first stage 120, a second stage 130, an additional stage 1120, and a final stage 1130 as disclosed herein according to one implementation.

FIG. 33 is a schematic cross-sectional plan view of an example system 100 comprising a first stage 120, a second stage 130, a plurality of additional stages 1120, and a final stage 1130 as disclosed herein according to one implementation.

FIG. 34 is a schematic cross-sectional plan view of an example additional stage 1120 as disclosed herein according to one implementation.

FIG. 35 is a schematic cross-sectional plan view of an example additional feedwater layer 1200 as disclosed herein according to one implementation.

FIG. 36 is a schematic cross-sectional plan view of an example additional distillate layer 1220 as disclosed herein according to one implementation.

FIG. 37 is a schematic cross-sectional plan view of an example final stage 1130 as disclosed herein according to one implementation.

FIG. 38 is a schematic cross-sectional plan view of an example final feedwater layer 1300 as disclosed herein according to one implementation.

FIG. 39 is a schematic cross-sectional plan view of an example final distillate layer 1320 as disclosed herein according to one implementation.

FIG. 40 is a schematic cross-sectional plan view of an example system 100 comprising a first stage 120, a second stage 130, an additional stage 1120, and a final stage 1130 as disclosed herein according to one implementation.

FIG. 41 is a schematic cross-sectional plan view of an example system 100 comprising a first stage 120, a second stage 130, an additional stage 1120, and a final stage 1130 as disclosed herein according to one implementation.

FIG. 42 is a schematic cross-sectional plan view of an example system 100 comprising a first stage 120, a second stage 130, a plurality of additional stages 1120, and a final stage 1130 as disclosed herein according to one implementation.

FIG. 43 is a schematic cross-sectional plan view of an example system 100 comprising a first stage 120, a second stage 130, a plurality of additional stages 1120, and a final stage 1130 as disclosed herein according to one implementation.

FIG. 44 is a schematic cross-sectional plan view of an example system 100 comprising a first stage 120, a second stage 130, an additional stage 1120, and a final stage 1130 as disclosed herein according to one implementation.

FIG. 45 is a schematic cross-sectional plan view of an example system 100 comprising a first stage 120, a second stage 130, a plurality of additional stages 1120, and a final stage 1130 as disclosed herein according to one implementation.

FIG. 46 is a schematic cross-sectional plan view of an example system 100 comprising a first stage 120, a second stage 130, an additional stage 1120, and a final stage 1130 as disclosed herein according to one implementation.

FIG. 47 is a schematic cross-sectional plan view of an example system 100 comprising a first stage 120, a second stage 130, a plurality of additional stages 1120, and a final stage 1130 as disclosed herein according to one implementation.

FIG. 48 is a schematic cross-sectional plan view of an example system 100 comprising a first stage 120, a second stage 130, an additional stage 1120, and a final stage 1130 as disclosed herein according to one implementation.

FIG. 49 is a schematic cross-sectional plan view of an example system 100 comprising a first stage 120, a second stage 130, a plurality of additional stages 1120, and a final stage 1130 as disclosed herein according to one implementation.

FIG. 50 is a schematic cross-sectional plan view of an example system 100 comprising a first stage 120, a second stage 130, an additional stage 1120, and a final stage 1130 as disclosed herein according to one implementation.

FIG. 51 is a schematic cross-sectional plan view of an example system 100 comprising a first stage 120, a second stage 130, a plurality of additional stages 1120, and a final stage 1130 as disclosed herein according to one implementation.

FIG. 52 is a schematic cross-sectional plan view of an example system 2100 comprising a first stage 2120 as disclosed herein according to one implementation.

FIG. 53 is a schematic cross-sectional plan view of an example first stage 2120 as disclosed herein according to one implementation.

FIG. 54 is a schematic cross-sectional plan view of an example first feedwater layer 2200 as disclosed herein according to one implementation.

FIG. 55 is a schematic cross-sectional plan view of an example first distillate layer 2220 as disclosed herein according to one implementation.

FIG. 56 is a schematic cross-sectional plan view of an example system 2100 comprising a first stage 2120 as disclosed herein according to one implementation.

FIG. 57 is a schematic cross-sectional plan view of an example system 2100 comprising a first stage 2120 as disclosed herein according to one implementation.

FIG. 58 is a schematic cross-sectional plan view of an example system 2100 comprising a first stage 2120 as disclosed herein according to one implementation.

FIG. 59 is a schematic cross-sectional plan view of an example system 2100 comprising a first stage 2120 as disclosed herein according to one implementation.

FIG. 60 is a schematic cross-sectional plan view of an example terminal feedwater layer 2600 as disclosed herein according to one implementation.

FIG. 61 is a schematic cross-sectional plan view of an example system 2100 comprising a first stage 2120 as disclosed herein according to one implementation.

FIG. 62 is a schematic cross-sectional plan view of an example system 2100 comprising a first stage 2120 as disclosed herein according to one implementation.

FIG. 63 is a schematic cross-sectional plan view of an example system 2100 comprising a first stage 2120 and a second stage 2130 as disclosed herein according to one implementation.

FIG. 64 is a schematic cross-sectional plan view of an example second stage 2130 as disclosed herein according to one implementation.

FIG. 65 is a schematic cross-sectional plan view of an example second feedwater layer 2300 as disclosed herein according to one implementation.

FIG. 66 is a schematic cross-sectional plan view of an example second distillate layer 2320 as disclosed herein according to one implementation.

FIG. 67 is a schematic cross-sectional plan view of an example system 2100 comprising a first stage 2120 and a second stage 2130 as disclosed herein according to one implementation.

FIG. 68 is a schematic cross-sectional plan view of an example system 2100 comprising a first stage 2120 and a second stage 2130 as disclosed herein according to one implementation.

FIG. 69 is a schematic cross-sectional plan view of an example system 2100 comprising a first stage 2120 and a second stage 2130 as disclosed herein according to one implementation.

FIG. 70 is a schematic cross-sectional plan view of an example system 2100 comprising a first stage 2120 and a second stage 2130 as disclosed herein according to one implementation.

FIG. 71 is a schematic cross-sectional plan view of an example system 2100 comprising a first stage 2120 and a second stage 2130 as disclosed herein according to one implementation.

FIG. 72 is a schematic cross-sectional plan view of an example system 2100 comprising a first stage 2120 and a second stage 2130 as disclosed herein according to one implementation.

FIG. 73 is a schematic cross-sectional plan view of an example system 2100 comprising a first stage 2120, a second stage 2130, and a third stage 4120 as disclosed herein according to one implementation.

FIG. 74 is a schematic cross-sectional plan view of an example third stage 4120 as disclosed herein according to one implementation.

FIG. 75 is a schematic cross-sectional plan view of an example third feedwater layer 4200 as disclosed herein according to one implementation.

FIG. 76 is a schematic cross-sectional plan view of an example third distillate layer 4220 as disclosed herein according to one implementation.

FIG. 77 is a schematic cross-sectional plan view of an example system 2100 comprising a first stage 2120, a second stage 2130, and a third stage 4120 as disclosed herein according to one implementation.

FIG. 78 is a schematic cross-sectional plan view of an example system 2100 comprising a first stage 2120, a second stage 2130, and a third stage 4120 as disclosed herein according to one implementation.

FIG. 79 is a schematic cross-sectional plan view of an example system 2100 comprising a first stage 2120, a second stage 2130, and a third stage 4120 as disclosed herein according to one implementation.

FIG. 80 is a schematic cross-sectional plan view of an example system 2100 comprising a first stage 2120, a second stage 2130, and a third stage 4120 as disclosed herein according to one implementation.

FIG. 81 is a schematic cross-sectional plan view of an example system 2100 comprising a first stage 2120, a second stage 2130, and a third stage 4120 as disclosed herein according to one implementation.

FIG. 82 is a schematic cross-sectional plan view of an example system 2100 comprising a first stage 2120, a second stage 2130, and a third stage 4120 as disclosed herein according to one implementation.

FIG. 83 is a schematic cross-sectional plan view of an example system 2100 comprising a first stage 2120, a second stage 2130, an additional stage 5120, and a final stage 5130 as disclosed herein according to one implementation.

FIG. 84 is a schematic cross-sectional plan view of an example system 2100 comprising a first stage 2120, a second stage 2130, a plurality of additional stages 5120, and a final stage 5130 as disclosed herein according to one implementation.

FIG. 85 is a schematic cross-sectional plan view of an example additional stage 5120 as disclosed herein according to one implementation.

FIG. 86 is a schematic cross-sectional plan view of an example additional feedwater layer 5200 as disclosed herein according to one implementation.

FIG. 87 is a schematic cross-sectional plan view of an example additional distillate layer 5220 as disclosed herein according to one implementation.

FIG. 88 is a schematic cross-sectional plan view of an example final stage 5130 as disclosed herein according to one implementation FIG. 89 is a schematic cross-sectional plan view of an example final feedwater layer 5300 as disclosed herein according to one implementation.

FIG. 90 is a schematic cross-sectional plan view of an example final distillate layer 5320 as disclosed herein according to one implementation.

FIG. 91 is a schematic cross-sectional plan view of an example system 2100 comprising a first stage 2120, a second stage 2130, an additional stage 5120, and a final stage 5130 as disclosed herein according to one implementation.

FIG. 92 is a schematic cross-sectional plan view of an example system 2100 comprising a first stage 2120, a second stage 2130, an additional stage 5120, and a final stage 5130 as disclosed herein according to one implementation.

FIG. 93 is a schematic cross-sectional plan view of an example system 2100 comprising a first stage 2120, a second stage 2130, a plurality of additional stages 5120, and a final stage 5130 as disclosed herein according to one implementation.

FIG. 94 is a schematic cross-sectional plan view of an example system 2100 comprising a first stage 2120, a second stage 2130, a plurality of additional stages 5120, and a final stage 5130 as disclosed herein according to one implementation.

FIG. 95 is a schematic cross-sectional plan view of an example system 2100 comprising a first stage 2120, a second stage 2130, an additional stage 5120, and a final stage 5130 as disclosed herein according to one implementation.

FIG. 96 is a schematic cross-sectional plan view of an example system 2100 comprising a first stage 2120, a second stage 2130, a plurality of additional stages 5120, and a final stage 5130 as disclosed herein according to one implementation.

FIG. 97 is a schematic cross-sectional plan view of an example system 2100 comprising a first stage 2120, a second stage 2130, an additional stage 5120, and a final stage 5130 as disclosed herein according to one implementation.

FIG. 98 is a schematic cross-sectional plan view of an example system 2100 comprising a first stage 2120, a second stage 2130, a plurality of additional stages 5120, and a final stage 5130 as disclosed herein according to one implementation.

FIG. 99 is a schematic cross-sectional plan view of an example system 2100 comprising a first stage 2120, a second stage 2130, an additional stage 5120, and a final stage 5130 as disclosed herein according to one implementation.

FIG. 100 is a schematic cross-sectional plan view of an example system 2100 comprising a first stage 2120, a second stage 2130, a plurality of additional stages 5120, and a final stage 5130 as disclosed herein according to one implementation.

FIG. 101 is a schematic cross-sectional plan view of an example system 2100 comprising a first stage 2120, a second stage 2130, an additional stage 5120, and a final stage 5130 as disclosed herein according to one implementation.

FIG. 102 is a schematic cross-sectional plan view of an example system 2100 comprising a first stage 2120, a second stage 2130, a plurality of additional stages 5120, and a final stage 5130 as disclosed herein according to one implementation.

FIG. 103. Schematic diagram of an “n”-stage solar thermal membrane distillation (MD) system. A black solar thermal absorber collects the heat from the sun which conducts to the first stage feed stream. The water in that stream is hotter relative to the first stage distillate stream and water vapor passes from the feed to distillate stream. As the heat from the sun is used to evaporate water in the feed stream, it is recaptured in the distillate stream as that vapor condenses. Because the first stage is directly connected to the second stage via conductive material, the heat of condensation is transferred to the feed stream of the second stage. This process repeats for “n” number of stages, after which the unused, or waste heat, is transferred to a heat sink.

FIG. 104. Diagram of a mat-like, multi-stage, passive solar MD system in its deployed state (left) and storage state (right). The system is fabricated such that it floats on top of the source water, whether it is offshore, or inland as on an evaporation pond. The device will be fabricated as an integrated mat without any solid housing. It would thus be light, rollable, highly portable, and easy to deploy.

FIG. 105. The governing equation for quantifying the performance of an STD in terms of SWP. Specifically, E represents solar irradiance (kW m⁻²), L is the latent heat (kWh m⁻³), a is the solar absorptivity (dimensionless, <1), ηₜ is the thermal efficiency (dimensionless, <1), and GOR is the gained output ratio (dimensionless, can be higher than 1).

FIG. 106. The impacts of GOR and αηₜ on SWP (solar irradiance is assumed to be 1 kWh m⁻² for the calculation). The dash curves are the iso-productivity curves, along which SWP is constant. Material innovation and optimizing thermal management can improve αηₜ (blue arrow) but the return is limited because αηₜ is capped at 1. In contrast, increasing GOR has a much larger room for enhancing the overall SWP.

FIG. 107. Diagram of an example N-stage solar MD system. Red and blue flaps represent the feed and distillate wicks to be connected to the saline feed water and distillate reservoir, respectively. Heat from condensation conducts from one stage to the next through a thermally conductive layer separating the previous stage's distillate wick and the subsequent stage's feed wick.

FIG. 108. Diagram of an example N-stage solar MD system.

### DETAILED DESCRIPTION

The systems and methods described herein may be understood more readily by reference to the following detailed description of specific aspects of the disclosed subject matter and the Examples included therein.

Before the present systems and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Values can be expressed herein as an “average” value. “Average” generally refers to the statistical mean value.

By “substantially” is meant within 5%, e.g., within 4%, 3%, 2%, or 1%.

“Exemplary” means “an example of” and is not intended to convey an indication of a preferred or ideal embodiment. “Such as” is not used in a restrictive sense, but for explanatory purposes.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Disclosed herein are systems and methods for purifying contaminated aqueous solutions to form purified aqueous solutions. For example, described herein are flexible membrane distillation systems for purifying a contaminated aqueous solution to form a purified aqueous solution for collection in a receptacle.

Systems 100 Comprising a First Stage 120

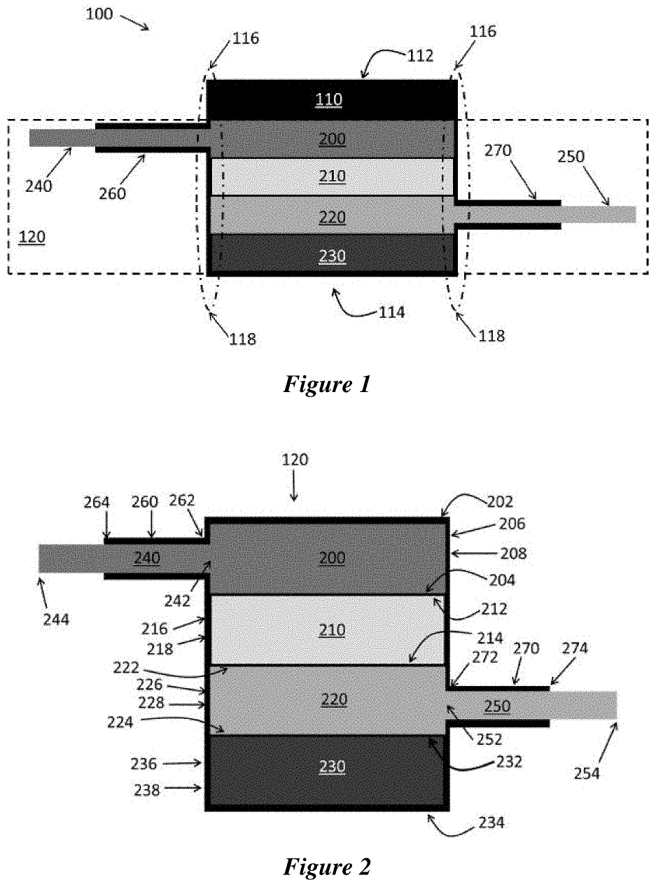

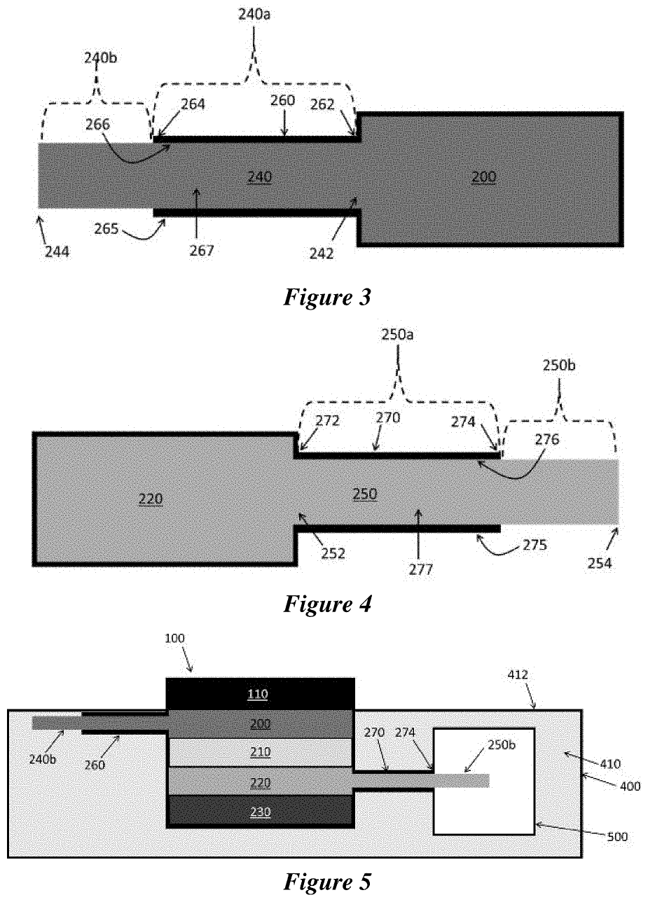

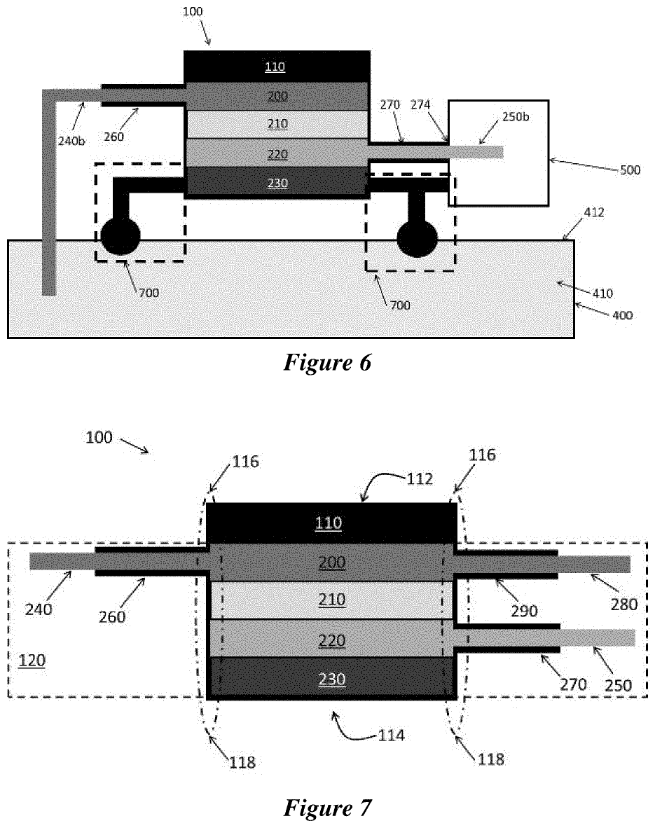

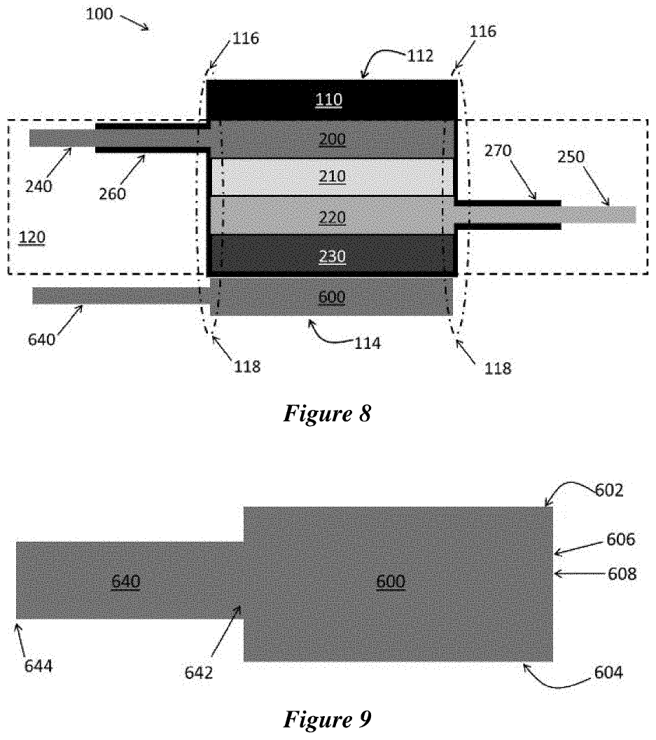

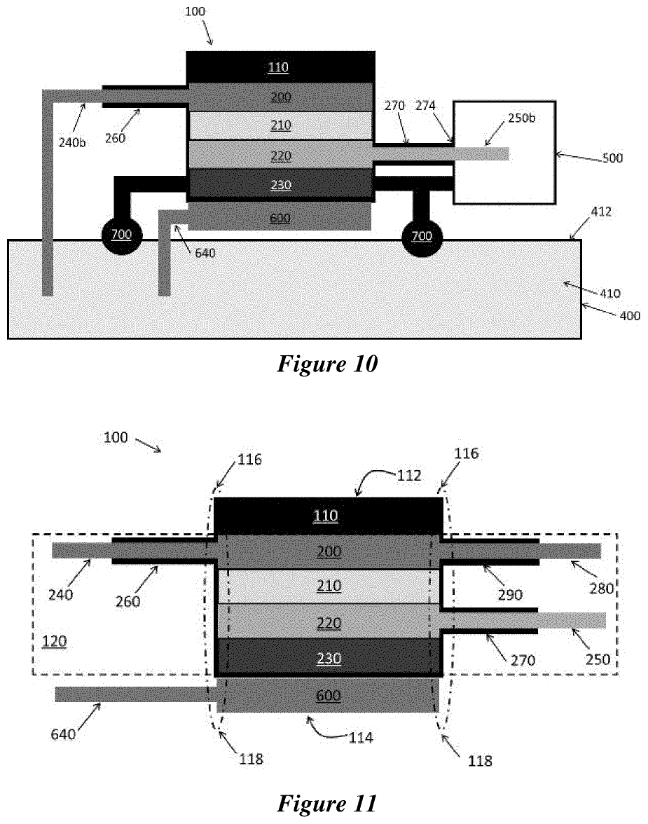

Referring now to FIG. 1-FIG. 11, disclosed herein are flexible membrane distillation systems 100 for purifying a contaminated aqueous solution to form a purified aqueous solution for collection in a receptacle 500; wherein the system 100 comprises a solar absorber layer 110 and a first stage 120.

The first stage 120 comprises: a first feedwater layer 200; a first membrane distillation layer 210; a first distillate layer 220; and a first thermally conductive layer 230; wherein the first feedwater layer 200 is disposed on top of and in physical and fluid contact with the first membrane distillation layer 210; the first membrane distillation layer 210 is disposed on top of and in physical and fluid contact with the first distillate layer 220 (e.g., such that the first membrane distillation layer 210 is sandwiched between the first feedwater layer 200 and the first distillate layer 220); and the first distillate layer 220 is disposed on top of and in physical and thermal contact with the first thermally conductive layer 230 (e.g., such that the first distillate layer 220 is sandwiched between the first membrane distillation layer 210 and the first thermally conductive layer 230).

The first feedwater layer 200 has a top surface 202, a bottom surface 204 opposite and spaced apart from the top surface 202, and a perimeter 206 defined by an edge 208. In some examples, the top surface and the bottom surface of the layer are substantially parallel to each other. The layer can have an average thickness, the average thickness being the average dimension from the top surface to the bottom surface.

The top surface 202 and the bottom surface 204 of the first feedwater layer 200 can, independently, be any shape. In some examples, the top surface 202 and the bottom surface 204 of the first feedwater layer 200 can, independently, be substantially circular, ovate, ovoid, elliptic, triangular, rectangular, polygonal, etc. In some examples, the top surface 202 and the bottom surface 204 of the first feedwater layer 200 can be substantially the same shape. In some examples, the top surface 202 and the bottom surface 204 of the first feedwater layer 200 can be substantially rectangular.

The first membrane distillation layer 210 has a top surface 212, a bottom surface 214 opposite and spaced apart from the top surface 212, and a perimeter 216 defined by an edge 218. In some examples, the top surface 212 and the bottom surface 214 of the first membrane distillation layer 210 are substantially parallel to each other. The top surface 212 and the bottom surface 214 of the first membrane distillation layer 210 can, independently, be any shape. In some examples, the top surface 212 and the bottom surface 214 of the first membrane distillation layer 210 can, independently, be substantially circular, ovate, ovoid, elliptic, triangular, rectangular, polygonal, etc. In some examples, the top surface 212 and the bottom surface 214 of the first membrane distillation layer 210 can be substantially the same shape. In some examples, the top surface 212 and the bottom surface 214 of the first membrane distillation layer 210 can be substantially rectangular.

The first distillate layer 220 has a top surface 222, a bottom surface 224 opposite and spaced apart from the top surface 222, and a perimeter 226 defined by an edge 228. In some examples, the top surface 222 and the bottom surface 224 of the first distillate layer 220 are substantially parallel to each other. The top surface 222 and the bottom surface 224 of the first distillate layer 220 can, independently, be any shape. In some examples, the top surface 222 and the bottom surface 224 of the first distillate layer 220 can, independently, be substantially circular, ovate, ovoid, elliptic, triangular, rectangular, polygonal, etc. In some examples, the top surface 222 and the bottom surface 224 of the first distillate layer 220 can be substantially the same shape. In some examples, the top surface 222 and the bottom surface 224 of the first distillate layer 220 can be substantially rectangular.

The first thermally conductive layer 230 has a top surface 232, a bottom surface 234 opposite and spaced apart from the top surface 232, and a perimeter 236 defined by an edge 238. In some examples, the top surface 232 and the bottom surface 234 of the first thermally conductive layer 230 are substantially parallel to each other. The top surface 232 and the bottom surface 234 of the first thermally conductive layer 230 can, independently, be any shape. In some examples, top surface 232 and the bottom surface 234 of the first thermally conductive layer 230 can, independently, be substantially circular, ovate, ovoid, elliptic, triangular, rectangular, polygonal, etc. In some examples, the top surface 232 and the bottom surface 234 of the first thermally conductive layer 230 can be substantially the same shape. In some examples, the top surface 232 and the bottom surface 234 of the first thermally conductive layer 230 can be substantially rectangular.

In the system 100, the solar absorber layer 110 is disposed on top of and in physical and thermal contact with the first feedwater layer 200.

In some examples, the solar absorber layer 110 and the first thermally conductive layer 230 are each substantially impermeable (e.g., to ions, solutions, and/or liquids). In some examples, the solar absorber layer 110 and the first thermally conductive layer 230 are each substantially watertight.

The system 100 further comprises: a first protrusion 240 (e.g., one or more first protrusions 240) and a second protrusion 250 (e.g., one or more second protrusions 250).

The first protrusion 240 extends from a portion of the edge 208 of the first feedwater layer 200 from a proximal end 242 to a distal end 244 opposite and spaced apart from the proximal end 242, the first protrusion 240 being fluidly connected to the first feedwater layer 200 from which it extends. In some examples, the system 100 comprises a plurality of first protrusions 240, wherein each of the plurality of first protrusions extends from a portion of the edge 208 of the first feedwater layer 200 from a proximal end 242 to a distal end 244 opposite and spaced apart from the proximal end 242, each of the plurality of first protrusions 240 being fluidly connected to the first feedwater layer 200 from which it extends. In some examples, at least a portion of the first protrusion 240 (e.g., at least the first portion 240a) is integrally formed with the first feedwater layer 200 from which it extends. In some examples, at least a portion of each of the plurality of first protrusions 240 (e.g., at least the first portion 240a) is integrally formed with the first feedwater layer 200 from which it extends.

The second protrusion 250 extends from a portion of the edge 228 of the first distillate layer 220 from a proximal end 252 to a distal end 254 opposite and spaced apart from the proximal end 252, the second protrusion 250 being fluidly connected to the first distillate layer 220 from which it extends. In some examples, the system 100 comprises a plurality of second protrusions 250, wherein each of the plurality of second protrusions 250 extends from a portion of the edge 228 of the first distillate layer 220 from a proximal end 252 to a distal end 254 opposite and spaced apart from the proximal end 252, each of the plurality of second protrusions 250 being fluidly connected to the first distillate layer 220 from which it extends. In some examples, at least a portion of the second protrusion 250 (e.g., at least the first portion 250a) is integrally formed with the first distillate layer 220 from which it extends. In some examples, at least a portion of each of the plurality of second protrusions 250 (e.g., at least the first portion 250a) is integrally formed with the first distillate layer 220 from which it extends.

The system 100 further comprises: a first conduit 260 (e.g. one or more first conduits 260) and a second conduit 270 (e.g., one or more second conduits 270); wherein the perimeter 116 of the system is perforated by the first conduit 260 (e.g., each of the one or more first conduits 260) and the second conduit 270 (e.g., each of the one or more second conduits 270).

The first conduit 260 (e.g., each of the one or more first conduits 260) extends from the perimeter 116 of the system from a proximal end 262 to a distal end 264. The first conduit 260 (e.g., each of the one or more first conduits 260) has an exterior surface 265 that is substantially impermeable (e.g., watertight) and an interior surface 266 that defines a lumen 267. The lumen 267 of the first conduit 260 contains a first portion 240a of the first protrusion 240 and a second portion 240b of the first protrusion 240 extends beyond the distal end 264 of the first conduit 260. For example, the lumen 267 of each of the one or more first conduits 260 contains a first portion 240a of each of the one or more first protrusions 240, and a second portion 240b of each of the one or more first protrusions 240 extends beyond the distal end 264 of each of the one or more first conduits 260.

The second conduit 270 (e.g., each of the one or more second conduits 270) extends from the perimeter 116 of the system from a proximal end 272 to a distal end 274. The second conduit 270 (e.g., each of the one or more second conduits 270) has an exterior surface 275 that is substantially impermeable (e.g., watertight) and an interior surface 276 that defines a lumen 277. The lumen 277 of the second conduit 270 contains a first portion 250a of the second protrusion 250 and a second portion 250b of the second protrusion 250 extends beyond the distal end 274 of the second conduit 270. For example, the lumen 277 of each of the one or more second conduits 270 contains a first portion 250a of each of the one or more second protrusions 250, and a second portion 250b of each of the one or more second protrusions 250 extends beyond the distal end 274 of each of the one or more second conduits 270.

In some examples, the second portion 240b of each of the one or more first protrusions 240 is fluidly connected to the first portion 240a. The second portion 240b of each of the one or more first protrusions 240 can be fluidly connected to the first portion 240a using any suitable means, such as those known in the art. For example, the second portion 240b of each of the one or more first protrusions 240 can be fluidly connected to the first portion 240a using an adhesive, solvent welding, heat, pressure, etc., or a combination thereof. In some examples, the second portion 240b of each of the one or more first protrusions 240 is removably attached to the first portion 240a, for example such that the second portion 240b can be removed and replaced. For example, the second portion 240b of each of the one or more first protrusions 240 can be interchangeable.

In some examples, the second portion 240b of each of the one or more first protrusions 240 can further comprise one or more treatment components, e.g. one or more treatment components can be impregnated in the second portion 240b of each of the one or more first protrusions 240. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 250b of each of the one or more second protrusions 250 is fluidly connected to the first portion 250a. The second portion 250b of each of the one or more second protrusions 250 can be fluidly connected to the first portion 250a using any suitable means, such as those known in the art. For example, the second portion 250b of each of the one or more second protrusions 250 can be fluidly connected to the first portion 250a using an adhesive, solvent welding, heat, pressure, etc., or a combination thereof. In some examples, the second portion 250b of each of the one or more second protrusions 250 can be removably attached to the first portion 250a, for example such that the second portion 250b can be removed and replaced. For example, the second portion 250b of each of the one or more second protrusions 250 can be interchangeable.

In some examples, the second portion 250b of each of the one or more second protrusions 250 can further comprise one or more treatment components, e.g. one or more treatment components can be impregnated in the second portion 250b of each of the one or more second protrusions 250. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, referring now to FIG. 7, the first feedwater layer 200 can further comprise a first outflow protrusion 280 (e.g., one or more first outflow protrusions 280), the first outflow protrusion 280 (e.g., each of the one or more first outflow protrusions 280) extends from a portion of the edge of the first feedwater layer 200 from a proximal end to a distal end opposite and spaced apart from the proximal end, the first outflow protrusion 280 (e.g., each of the one or more first outflow protrusions 280) being fluidly connected to the first feedwater layer 200 from which it extends. In some examples, at least a portion of the first outflow protrusion 280 (e.g., at least a portion of each of the one or more first outflow protrusions 280) is integrally formed with the first feedwater layer 280 from which it extends.

In certain examples, the system further comprises an outflow conduit 290 (e.g. one or more outflow conduits 290), wherein the perimeter 116 of the system is perforated by the outflow conduit 290 (e.g., each of the one or more outflow conduits 290). The outflow conduit 290 (e.g., each of the one or more outflow conduits 290) extends from the perimeter 116 of the system from a proximal end to a distal end. The outflow conduit 290 (e.g., each of the one or more outflow conduits 290) has an exterior surface that is substantially impermeable (e.g., watertight) and an interior surface that defines a lumen. The lumen of the outflow conduit 290 contains a first portion of the outflow protrusion 280 and a second portion of the outflow protrusion 280 extends beyond the distal end of the outflow conduit 290. For example, the lumen of each of the one or more outflow conduits 290 contains a first portion of each of the one or more outflow protrusions 280, and a second portion of each of the one or more outflow protrusions 280 extends beyond the distal end of each of the one or more outflow conduits 290.

For example, the system can be configured such that there is a driving force to produce update of a liquid and/or solution by the feedwater protrusion(s), from the feedwater protrusion(s) across the feedwater layer to the outflow protrusion(s), and out the outflow protrusion(s). The driving force can, for example, be gravity based (e.g., the feedwater protrusion(s) are elevated above the outflow protrusions(s)), capillary based (e.g., increasing capillary force from the feedwater protrusions(s) to the outlet protrusion(s), etc.

The system 100 further comprises: a top surface 112; a bottom surface 114 opposite and spaced apart from the top surface 112; a perimeter 116 defined by an edge 118. In some examples, the top surface 112 and the bottom surface 114 of are substantially parallel to each other.

In some examples, the top surface 112 and the perimeter 116 of the system 100 are each substantially impermeable (e.g., to ions, solutions, and/or liquids). In some examples, the top surface 112 and the perimeter 116 of the system 100 are each substantially watertight. In some examples, the top surface 112 comprises the solar absorber layer 110.

In some examples, the bottom surface 114 is substantially impermeable (e.g., to ions, solutions, and/or liquids). In some examples, the bottom surface 114 is substantially watertight. In some examples, the bottom surface 114 comprises the first thermally conductive layer 230 (e.g., as shown in FIG. 1).

In some examples, the system further comprises a terminal feedwater layer 600, wherein the first stage 120 is stacked on top of the terminal feedwater layer 600, such that the first thermally conductive layer 230 is disposed on top of an in physical and thermal contact with the terminal feedwater layer 600. In some examples, the bottom surface 114 comprises the terminal feedwater layer 600.

The terminal feedwater layer 600 has a top surface 602, a bottom surface 604 opposite and spaced apart from the top surface 602, and a perimeter 606 defined by an edge 608. In some examples, the top surface and the bottom surface of the terminal feedwater layer are substantially parallel to each other. The layer can have an average thickness, the average thickness being the average dimension from the top surface to the bottom surface.

The top surface 602 and the bottom surface 604 of the terminal feedwater layer 600 can, independently, be any shape. In some examples, the top surface 602 and the bottom surface 604 of the terminal feedwater layer 600 can, independently, be substantially circular, ovate, ovoid, elliptic, triangular, rectangular, polygonal, etc. In some examples, the top surface 602 and the bottom surface 604 of the terminal feedwater layer 600 can be substantially the same shape. In some examples, the top surface 602 and the bottom surface 604 of the terminal feedwater layer 600 can be substantially rectangular.

In some examples, the terminal feedwater layer 600 can further comprise an terminal feedwater protrusion 640 (e.g., one or more terminal feedwater protrusions 640), wherein the terminal feedwater protrusion 640 (e.g., each of the one or more terminal feedwater protrusions 640) extends from a portion of the edge 608 of the terminal feedwater layer 600 from a proximal end 642 to a distal end 644 opposite and spaced apart from the proximal end 642, the terminal feedwater protrusion 640 (e.g., each of the one or more terminal feedwater protrusions 640) being fluidly connected to the terminal feedwater layer 600 from which it extends. In some examples, at least a portion of the terminal feedwater protrusion 640 (e.g., at least a portion of each of the one or more terminal feedwater protrusions 640) is integrally formed with the terminal feedwater layer 600 from which it extends.

The system 100 is configured to be flexible. For example, the system 100 is flexible such that the system 100 can be rolled and/or folded when being stored (e.g., to be more spatially compact) and then unrolled and/or unfolded when deployed. In some examples, the system 100 is further configured to be lightweight, such that the system can be easily transported.

In some examples, the system 100 is configured to be deployed in reservoir 400 containing a contaminated aqueous solution 410, the contaminated aqueous solution 410 having a surface 412.

In some examples, the system is configured to be deployed on land or on a vehicle, wherein the system is deployed proximate a contaminated aqueous solution 410, e.g. proximate a reservoir containing a contaminated aqueous solution 410.

In some examples, the system 100 is configured to be buoyant, such that the system 100 floats in the contaminated aqueous solution 410 when deployed therein, such that at least the solar absorber layer 110 is disposed above the surface 412 of the contaminated aqueous solution 410.

In some examples, the system 100 further comprises a buoyant frame 700 that is configured to be coupled to the system 100 and/or the receptacle 500 such that the system 100 and/or the receptacle 500 is buoyant. In some examples, the buoyant frame 700 comprises external floats or buoys coupled to a frame, said frame itself being buoyant or non-buoyant.

In certain examples, at least a portion of the system 100 is disposed above the surface 412 of the contaminated aqueous solution 410. In certain examples, the system 100 is disposed above the surface 412 of the contaminated aqueous solution 410, for example such that the bottom surface 114 is disposed above the surface 412 of the contaminated aqueous solution 410, e.g. such that there is an air gap between the bottom surface 114 of the device and the surface 412 of the contaminated aqueous solution 410.

In certain examples, wherein the system 100 includes the a terminal feedwater layer 600, the system 100 is configured to be buoyant such that the terminal feedwater layer 600 is disposed above the surface 412 of the contaminated aqueous solution 410, e.g. such that there is an air gap between the bottom surface 604 of the terminal feedwater layer 600 and the surface 412 of the contaminated aqueous solution 410.

When the system 100 is deployed, the second portion 240b of the first protrusion 240 (e.g., the second portion 240b of each of the one or more first protrusions 240) is configured to be in contact with the contaminated aqueous solution 410. The first feedwater layer 200 is configured to receive a first portion of the contaminated aqueous solution from the first protrusion 240, said first portion of the contaminated aqueous solution being a first feed solution. The solar absorber layer 110 is configured to collect solar heat and conduct the collected heat to the first feedwater layer 200 to thereby distill at least a portion of the first feed solution through the first membrane distillation layer 210, thereby producing a first distillate in the first distillate layer 220. The first distillate layer 220 is configured to receive the first distillate from the first membrane distillation layer 210 and condense the first distillate to form a first condensate and release a first latent heat of condensation. Distilling said portion of the first feed solution through the first membrane distillation layer 210 purifies said portion of the first feed solution to produce a first purified aqueous solution as the first condensate. The first thermally conductive layer 230 is configured to collect the first latent heat of condensation and conduct the collected first latent heat away from the system. The distal end 274 of the second conduit 270 (e.g., the distal end of each of the one or more second conduits 270) is configured to be fluidly connected to the receptacle 500, such that the second portion 250b of the second protrusion 250 (e.g., the second portion 250b of each of the one or more second protrusions 250) is configured to be disposed within the receptacle 500, such that the receptacle 500 is configured to receive and collect the first purified aqueous solution from the first distillate layer 220 via the second protrusion 250 (e.g., via each of the one or more second protrusions 250). In some examples, the distal end 274 of the second conduit 270 (e.g., the distal end of each of the one or more second conduits 270) forms a watertight and/or an impermeable seal with the receptacle 500.

Systems 100 Further Comprising a Second Stage 130

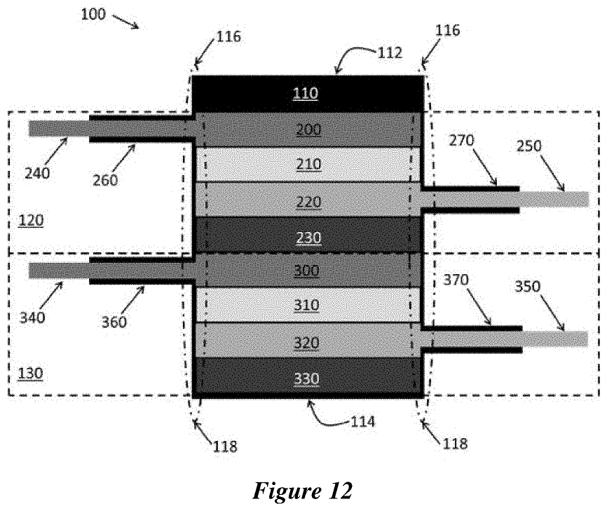

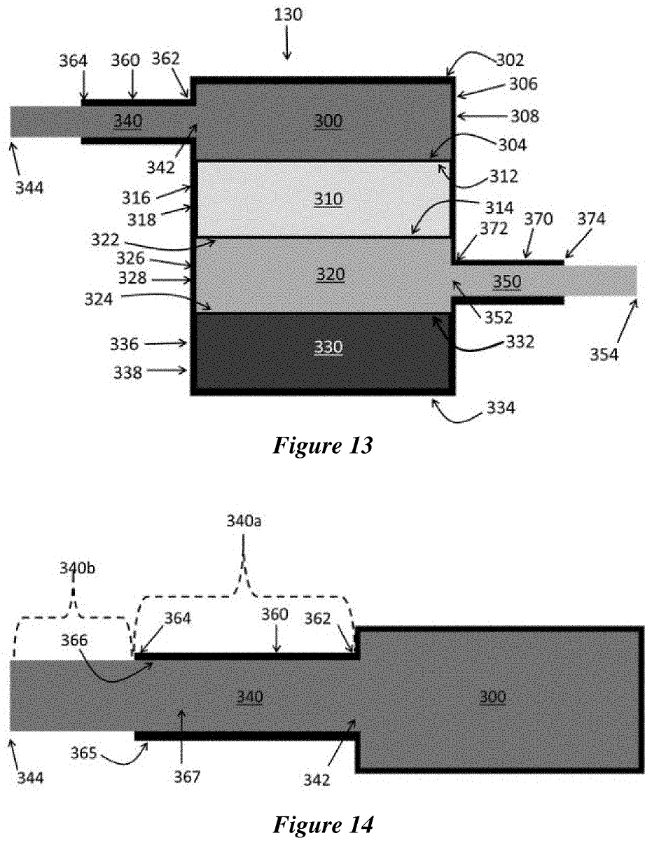

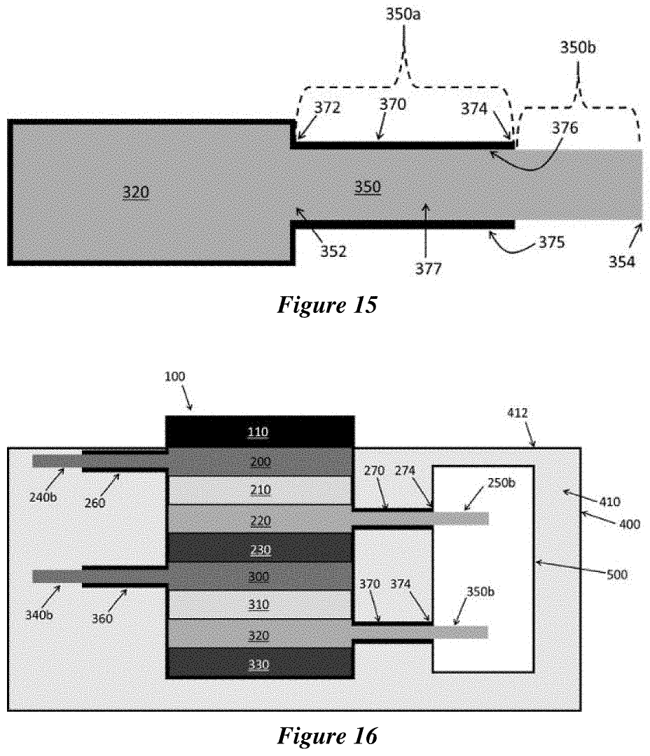

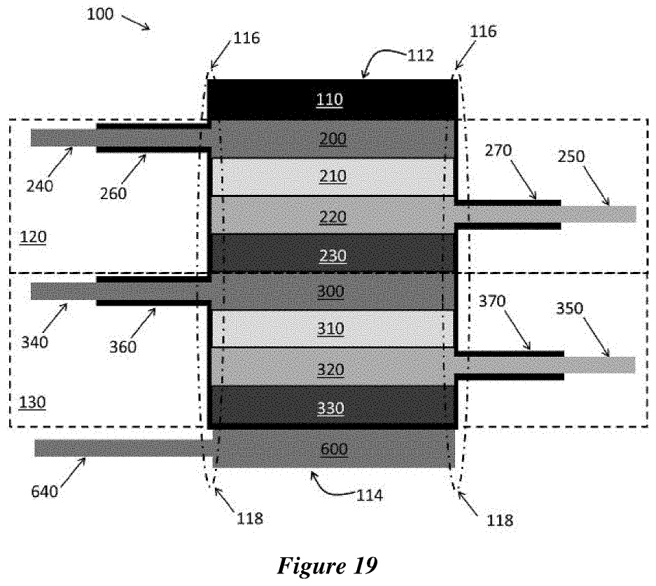

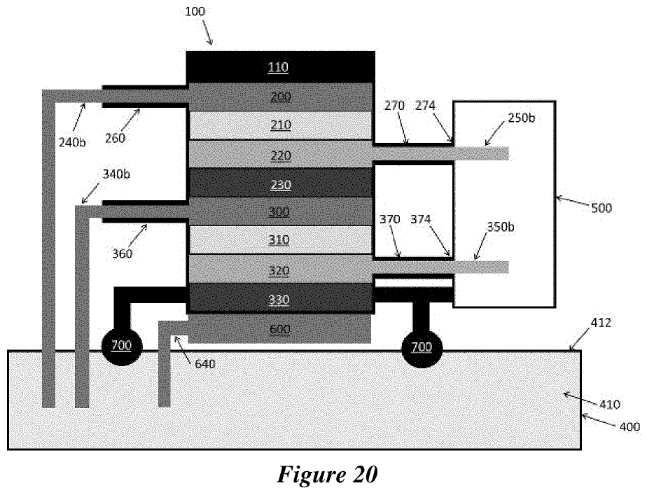

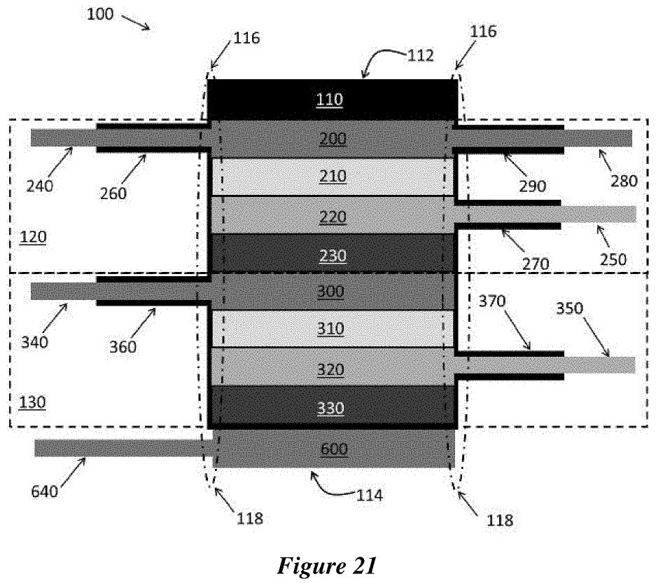

Referring now to FIG. 12-FIG. 21, in some examples the system 100 further comprises a second stage 130. The second stage 130 comprises: a second feedwater layer 300; a second membrane distillation layer 310; a second distillate layer 320; and a second thermally conductive layer 330; wherein the second feedwater layer 300 is disposed on top of and in physical and fluid contact with the second membrane distillation layer 310; the second membrane distillation layer 310 is disposed on top of and in physical and fluid contact with the second distillate layer 320 (e.g., such that the second membrane distillation layer 310 is sandwiched between the second feedwater layer 300 and the second distillate layer 320); and the second distillate layer 320 is disposed on top of and in physical and thermal contact with the second thermally conductive layer 330 (e.g., such that the second distillate layer 320 is sandwiched between the second membrane distillation layer 310 and the second thermally conductive layer 330). In the system 100, the first stage 120 is stacked on top of the second stage 130, such that the first thermally conductive layer 230 is disposed on top of and in physical and thermal contact with the second feedwater layer 300.

The second feedwater layer 300 has a top surface 302, a bottom surface 304 opposite and spaced apart from the top surface 302, and a perimeter 306 defined by an edge 308. In some examples, the top surface 302 and the bottom surface 304 of the second feedwater layer 300 are substantially parallel to each other. The top surface 302 and the bottom surface 304 of the second feedwater layer 300 can, independently, be any shape. In some examples, the top surface 302 and the bottom surface 304 of the second feedwater layer 300 can, independently, be substantially circular, ovate, ovoid, elliptic, triangular, rectangular, polygonal, etc. In some examples, the top surface 302 and the bottom surface 304 of the second feedwater layer 300 can be substantially the same shape. In some examples, the top surface 302 and the bottom surface 304 of the second feedwater layer 300 can be substantially rectangular.

The second membrane distillation layer 310 has a top surface 312, a bottom surface 314 opposite and spaced apart from the top surface 312, and a perimeter 316 defined by an edge 318. In some examples, the top surface 312 and the bottom surface 314 of the second membrane distillation layer 310 are substantially parallel to each other. The top surface 312 and the bottom surface 314 of the second membrane distillation layer 310 can, independently, be any shape. In some examples, the top surface 312 and the bottom surface 314 of the second membrane distillation layer 310 can, independently, be substantially circular, ovate, ovoid, elliptic, triangular, rectangular, polygonal, etc. In some examples, the top surface 312 and the bottom surface 314 of the second membrane distillation layer 310 can be substantially the same shape. In some examples, the top surface 312 and the bottom surface 314 of the second membrane distillation layer 310 can be substantially rectangular.

The second distillate layer 320 has a top surface 322, a bottom surface 324 opposite and spaced apart from the top surface 322, and a perimeter 326 defined by an edge 328. In some examples, the top surface 322 and the bottom surface 324 of the second distillate layer 320 are substantially parallel to each other. The top surface 322 and the bottom surface 324 of the second distillate layer 320 can, independently, be any shape. In some examples, the top surface 322 and the bottom surface 324 of the second distillate layer 320 can, independently, be substantially circular, ovate, ovoid, elliptic, triangular, rectangular, polygonal, etc. In some examples, top surface 322 and the bottom surface 324 of the second distillate layer 320 can be substantially the same shape. In some examples, the top surface 322 and the bottom surface 324 of the second distillate layer 320 can be substantially rectangular.

The second thermally conductive layer 330 has a top surface 332, a bottom surface 334 opposite and spaced apart from the top surface 332, and a perimeter 336 defined by an edge 338. In some examples, the top surface 332 and the bottom surface 334 of the second thermally conductive layer 330 are substantially parallel to each other. The top surface 332 and the bottom surface 334 of the second thermally conductive layer 330 can, independently, be any shape. In some examples, the top surface 332 and the bottom surface 334 of the second thermally conductive layer 330 can, independently, be substantially circular, ovate, ovoid, elliptic, triangular, rectangular, polygonal, etc. In some examples, the top surface 332 and the bottom surface 334 of the second thermally conductive layer 330 can be substantially the same shape. In some examples, the top surface 332 and the bottom surface 334 of the second thermally conductive layer 330 can be substantially rectangular.

In some examples, the second thermally conductive layer 330 is substantially impermeable (e.g., to ions, solutions, and/or liquids). In some examples, the second thermally conductive layer 330 is substantially watertight.

In certain examples, the system 100 further comprises a third protrusion 340 (e.g., one or more third protrusions 340); and a fourth protrusion 350 (e.g., one or more fourth protrusions 350).

The third protrusion 340 extends from a portion of the edge 308 of the second feedwater layer 300 from a proximal end 342 to a distal end 344 opposite and spaced apart from the proximal end 342, the third protrusion 340 being fluidly connected to the second feedwater layer 300 from which it extends. In some examples, the system 100 comprises a plurality of third protrusions 340, wherein each of the plurality of third protrusions 340 extends from a portion of the edge 308 of the second feedwater layer 300 from a proximal end 342 to a distal end 344 opposite and spaced apart from the proximal end 342, each of the plurality of third protrusions 340 being fluidly connected to the second feedwater layer 300 from which it extends. In some examples, at least a portion of the third protrusion 340 (e.g., at least the first portion 340a) is integrally formed with the second feedwater layer 300 from which it extends. In some examples, at least a portion of each of the plurality of third protrusions 340 (e.g., at least the first portion 340a) is integrally formed with the second feedwater layer 300 from which it extends.

The fourth protrusion 350 extends from a portion of the edge 328 of the second distillate layer 320 from a proximal end 352 to a distal 354 end opposite and spaced apart from the proximal end 352, the fourth protrusion 350 being fluidly connected to the second distillate layer 320 from which it extends. In some examples, the system 100 comprises a plurality of fourth protrusions 350, wherein each of the plurality of fourth protrusions 350 extends from a portion of the edge 328 of the second distillate layer 320 from a proximal end 352 to a distal 354 end opposite and spaced apart from the proximal end 352, each of the plurality of fourth protrusions 350 being fluidly connected to the second distillate layer 320 from which it extends. In some examples, at least a portion of the fourth protrusion 350 (e.g., at least the first portion 350a) is integrally formed with the second distillate layer 320 from which it extends. In some examples, at least a portion of each of the plurality of fourth protrusions 350 (e.g., at least the first portion 350a) is integrally formed with the second distillate layer 320 from which it extends.

In some examples, the system 100 further comprises: a third conduit 360 (e.g., one or more third conduits 360); and a fourth conduit 370 (e.g., one or more fourth conduits 370); wherein the perimeter 116 of the system is perforated by the third conduit 360 (e.g., each of the one or more third conduits 360), and the fourth conduit 370 (e.g., each of the one or more fourth conduits 370).

The third conduit 360 (e.g., each of the one or more third conduits) extends from the perimeter 116 of the system from a proximal end 362 to a distal end 364. The third conduit 360 (e.g., each of the one or more third conduits 360) has an exterior surface 365 that is substantially impermeable (e.g., watertight) and an interior surface 366 that defines a lumen 367. The lumen 367 of the third conduit 360 contains a first portion 340a of the third protrusion 340 and a second portion 340b of the third protrusion 340 extends beyond the distal end 364 of the third conduit 360. For example, the lumen 367 of each of the one or more third conduits 360 contains a first portion 340a of each of the one or more third protrusions 340, and a second portion 340b of each of the one or more third protrusions 340 extends beyond the distal end 364 of each of the one or more third conduits 360.

The fourth conduit 370 (e.g., each of the one or more fourth conduits 370) extends from the perimeter 116 of the system from a proximal end 372 to a distal end 374. The fourth conduit 370 (e.g., each of the one or more fourth conduits 370) has an exterior surface 375 that is substantially impermeable (e.g., watertight) and an interior surface 376 that defines a lumen 377. The lumen 377 of the fourth conduit 370 contains a first portion 350a of the fourth protrusion 350 and a second portion 350b of the fourth protrusion 350 extends beyond the distal end 374 of the fourth conduit 370. For example, the lumen 377 of each of the one or more fourth conduits 370 contains a first portion 350a of each of the one or more fourth protrusions 350, and a second portion 350b of each of the one or more fourth protrusions 350 extends beyond the distal end 374 of each of the one or more fourth conduits 370.

In some examples, the second portion 340b of each of the one or more third protrusions 340 is fluidly connected to the first portion 340a. The second portion 340b of each of the one or more third protrusions 340 can be fluidly connected to the first portion 340a using any suitable means, such as those known in the art. For example, the second portion 340b of each of the one or more third protrusions 340 can be fluidly connected to the first portion 340a using an adhesive, solvent welding, heat, pressure, etc., or a combination thereof. In some examples, the second portion 340b of each of the one or more third protrusions 340 can be removably attached to the first portion 340a, for example such that the second portion 340b can be removed and replaced. For example, the second portion 340b of each of the one or more third protrusions 340 can be interchangeable.

In some examples, the second portion 340b of each of the one or more third protrusions 340 can further comprise one or more treatment components, e.g. one or more treatment components can be impregnated in the second portion 340b of each of the one or more third protrusions 340. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 350b of each of the one or more fourth protrusions 350 is fluidly connected to the first portion 350a. The second portion 350b of each of the one or more fourth protrusions 350 can be fluidly connected to the first portion 350a using any suitable means, such as those known in the art. For example, the second portion 350b of each of the one or more fourth protrusions 350 can be fluidly connected to the first portion 350a using an adhesive, solvent welding, heat, pressure, etc., or a combination thereof. In some examples, the second portion 350b of each of the one or more fourth protrusions 350 can be removable attached to the first portion 350a, for example such that the second portion 350b can be removed and replaced. For example, the second portion 350b of each of the one or more fourth protrusions 350 can be interchangeable.

In some examples, the second portion 350b of each of the one or more fourth protrusions 350 can further comprise one or more treatment components, e.g. one or more treatment components can be impregnated in the second portion 350b of each of the one or more fourth protrusions 350. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, each of the feedwater layers of the system can further comprise an outflow protrusion (e.g. one or more outflow protrusions), wherein the outflow protrusion (e.g., each of the one or more outflow protrusions) extends from a portion of the edge of said feedwater layer from a proximal end to a distal end opposite and spaced apart from the proximal end, the outflow protrusion (e.g., each of the one or more outflow protrusions) being fluidly connected to the feedwater layer from which it extends. In some examples, at least a portion of the outflow protrusion (e.g., at least a portion of each of the one or more outflow protrusions) is integrally formed with the feedwater layer from which it extends.

In certain examples, the system further comprises an outflow conduit (e.g. one or more outflow conduits), wherein the perimeter of the system is perforated by the outflow conduit (e.g., each of the one or more outflow conduits). The outflow conduit (e.g., each of the one or more outflow conduits) extends from the perimeter of the system from a proximal end to a distal end. The outflow conduit (e.g., each of the one or more outflow conduits) has an exterior surface that is substantially impermeable (e.g., watertight) and an interior surface that defines a lumen. The lumen of the outflow conduit contains a first portion of the outflow protrusion and a second portion of the outflow protrusion extends beyond the distal end of the outflow conduit. For example, the lumen of each of the one or more outflow conduits contains a first portion of each of the one or more outflow protrusions, and a second portion of each of the one or more outflow protrusions extends beyond the distal end of each of the one or more outflow conduits.

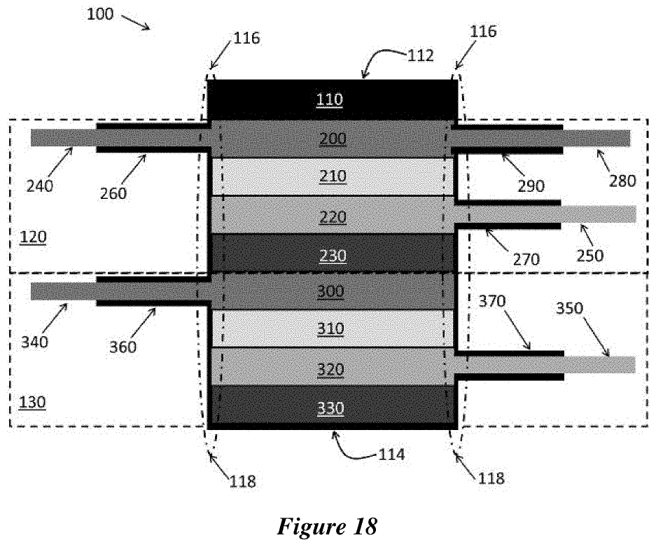

For example, referring now to FIG. 18, the first feedwater layer 200 can further comprise a first outflow protrusion 280 (e.g., one or more first outflow protrusions 280), the first outflow protrusion 280 (e.g., each of the one or more first outflow protrusions 280) extends from a portion of the edge of the first feedwater layer 200 from a proximal end to a distal end opposite and spaced apart from the proximal end, the first outflow protrusion 280 (e.g., each of the one or more first outflow protrusions 280) being fluidly connected to the first feedwater layer 200 from which it extends. In some examples, at least a portion of the first outflow protrusion 280 (e.g., at least a portion of each of the one or more first outflow protrusions 280) is integrally formed with the first feedwater layer 280 from which it extends.

In certain examples, the system further comprises an outflow conduit 290 (e.g. one or more outflow conduits 290), wherein the perimeter 116 of the system is perforated by the outflow conduit 290 (e.g., each of the one or more outflow conduits 290). The outflow conduit 290 (e.g., each of the one or more outflow conduits 290) extends from the perimeter 116 of the system from a proximal end to a distal end. The outflow conduit 290 (e.g., each of the one or more outflow conduits 290) has an exterior surface that is substantially impermeable (e.g., watertight) and an interior surface that defines a lumen. The lumen of the outflow conduit 290 contains a first portion of the outflow protrusion 280 and a second portion of the outflow protrusion 280 extends beyond the distal end of the outflow conduit 290. For example, the lumen of each of the one or more outflow conduits 290 contains a first portion of each of the one or more outflow protrusions 280, and a second portion of each of the one or more outflow protrusions 280 extends beyond the distal end of each of the one or more outflow conduits 290.

For example, the system can be configured such that there is a driving force to produce update of a liquid and/or solution by the feedwater protrusion(s), from the feedwater protrusion(s) across the feedwater layer to the outflow protrusion(s), and out the outflow protrusion(s). The driving force can, for example, be gravity based (e.g., the feedwater protrusion(s) are elevated above the outflow protrusions(s)), capillary based (e.g., increasing capillary force from the feedwater protrusions(s) to the outlet protrusion(s), etc.

The system 100 further comprises: a top surface 112; a bottom surface 114 opposite and spaced apart from the top surface 112; a perimeter 116 defined by an edge 118. In some examples, the top surface 112 and the bottom surface 114 of are substantially parallel to each other.

In some examples, the top surface 112 and the perimeter 116 of the system 100 are each substantially impermeable (e.g., to ions, solutions, and/or liquids). In some examples, the top surface 112 and the perimeter 116 of the system 100 are each substantially watertight. In some examples, the top surface 112 comprises the solar absorber layer 110.

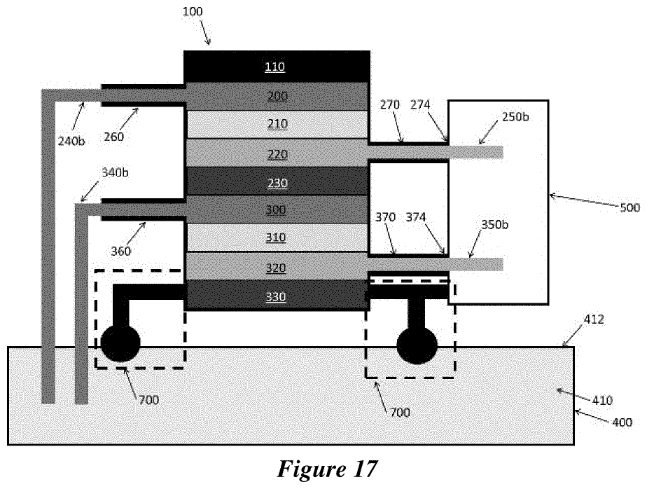

In some examples, the bottom surface 114 is substantially impermeable (e.g., to ions, solutions, and/or liquids). In some examples, the bottom surface 114 is substantially watertight. In some examples, the bottom surface 114 comprises the second thermally conductive layer 330 (e.g., as shown in FIG. 12, FIG. 16, FIG. 17, and FIG. 18).

In some examples, the system further comprises a terminal feedwater layer 600, wherein the second stage 130 is stacked on top of the terminal feedwater layer 600, such that the second thermally conductive layer 330 is disposed on top of an in physical and thermal contact with the terminal feedwater layer 600. In some examples, the bottom surface 114 comprises the terminal feedwater layer 600.

The terminal feedwater layer 600 has a top surface 602, a bottom surface 604 opposite and spaced apart from the top surface 602, and a perimeter 606 defined by an edge 608. In some examples, the top surface and the bottom surface of the terminal feedwater layer are substantially parallel to each other. The layer can have an average thickness, the average thickness being the average dimension from the top surface to the bottom surface.

The top surface 602 and the bottom surface 604 of the terminal feedwater layer 600 can, independently, be any shape. In some examples, the top surface 602 and the bottom surface 604 of the terminal feedwater layer 600 can, independently, be substantially circular, ovate, ovoid, elliptic, triangular, rectangular, polygonal, etc. In some examples, the top surface 602 and the bottom surface 604 of the terminal feedwater layer 600 can be substantially the same shape. In some examples, the top surface 602 and the bottom surface 604 of the terminal feedwater layer 600 can be substantially rectangular.

In some examples, the terminal feedwater layer 600 can further comprise an terminal feedwater protrusion 640 (e.g., one or more terminal feedwater protrusions 640), wherein the terminal feedwater protrusion 640 (e.g., each of the one or more terminal feedwater protrusions 640) extends from a portion of the edge 608 of the terminal feedwater layer 600 from a proximal end 642 to a distal end 644 opposite and spaced apart from the proximal end 642, the terminal feedwater protrusion 640 (e.g., each of the one or more terminal feedwater protrusions 640) being fluidly connected to the terminal feedwater layer 600 from which it extends. In some examples, at least a portion of the terminal feedwater protrusion 640 (e.g., at least a portion of each of the one or more terminal feedwater protrusions 640) is integrally formed with the terminal feedwater layer 600 from which it extends.

The system 100 is configured to be flexible. For example, the system 100 is flexible such that the system 100 can be rolled and/or folded when being stored (e.g., to be more spatially compact) and then unrolled and/or unfolded when deployed. In some examples, the system 100 is further configured to be lightweight, such that the system can be easily transported.

In some examples, the system 100 is configured to be deployed in reservoir 400 containing a contaminated aqueous solution 410, the contaminated aqueous solution 410 having a surface 412.

In some examples, the system is configured to be deployed on land or on a vehicle, wherein the system is deployed proximate a contaminated aqueous solution 410, e.g. proximate a reservoir containing a contaminated aqueous solution 410.

In some examples, the system 100 is configured to be buoyant, such that the system 100 floats in the contaminated aqueous solution 410 when deployed therein, such that at least the solar absorber layer 110 is disposed above the surface 412 of the contaminated aqueous solution 410.

In some examples, the system 100 further comprises a buoyant frame 700 that is configured to be coupled to the system 100 and/or the receptacle 500 such that the system 100 and/or the receptacle 500 is buoyant. In some examples, the buoyant frame 700 comprises external floats or buoys coupled to a frame, said frame itself being buoyant or non-buoyant.

In certain examples, at least a portion of the system 100 is disposed above the surface 412 of the contaminated aqueous solution 410. In certain examples, the system 100 is disposed above the surface 412 of the contaminated aqueous solution 410, for example such that the bottom surface 114 is disposed above the surface 412 of the contaminated aqueous solution 410, e.g. such that there is an air gap between the bottom surface 114 of the device and the surface 412 of the contaminated aqueous solution 410.

In certain examples, wherein the system 100 includes the a terminal feedwater layer 600, the system 100 is configured to be buoyant such that the terminal feedwater layer 600 is disposed above the surface 412 of the contaminated aqueous solution 410, e.g. such that there is an air gap between the bottom surface 604 of the terminal feedwater layer 600 and the surface 412 of the contaminated aqueous solution 410.

When the system 100 is deployed, the second portion 240b of the first protrusion 240 (e.g., the second portion 240b of each of the one or more first protrusions 240) and the second portion 340b of the third protrusion 340 (e.g., the second portion 340b of each of the one or more third protrusions) are each independently configured to be in contact with the contaminated aqueous solution 410. The first feedwater layer 200 is configured to receive a first portion of the contaminated aqueous solution from the first protrusion 240, said first portion of the contaminated aqueous solution being a first feed solution. The second feedwater layer 300 is configured to receive a second portion of the contaminated aqueous solution from the third protrusion 340, said second portion of the contaminated aqueous solution being a second feed solution. The solar absorber layer 110 is configured to collect solar heat and conduct the collected heat to the first feedwater layer 200 to thereby distill at least a portion of the first feed solution through the first membrane distillation layer 210, thereby producing a first distillate in the first distillate layer 220. The first distillate layer 220 is configured to receive the first distillate from the first membrane distillation layer 210 and condense the first distillate to form a first condensate and release a first latent heat of condensation. Distilling said portion of the first feed solution through the first membrane distillation layer 210 purifies said portion of the first feed solution to produce a first purified aqueous solution as the first condensate. The first thermally conductive layer 230 is configured to collect the first latent heat of condensation and conduct the collected first latent heat of condensation to the second feedwater layer 300 to thereby distill at least a portion of the second feed solution through the second membrane distillation layer 310, thereby producing a second distillate in the second distillate layer 320. The second distillate layer 320 is configured to receive the second distillate from the second membrane distillation layer 310 and condense the second distillate to form a second condensate and release a second latent heat of condensation. Distilling said portion of the second feed solution through the second membrane distillation layer 310 purifies said portion of the second feed solution to produce a second purified aqueous solution as the second condensate. The distal end 274 of the second conduit 270 (e.g., the distal end of each of the one or more second conduits 270) and the distal end 374 of the fourth conduit 370 (e.g., the distal end of each of the one or more fourth conduits 370) are each independently configured to be fluidly connected to the receptacle 500, such that the second portion 250b of the second protrusion 250 (e.g., the second portion 250b of each of the one or more second protrusions 250) and the second portion 350b of the fourth protrusion 350 (e.g., the second portion 350b of each of the one or more fourth protrusions) are each independently configured to be disposed within the receptacle 500, such that the receptacle 500 is configured to receive and collect: the first purified aqueous solution from the first distillate layer 220 via the second protrusion 250 (e.g., via each of the one or more second protrusions 250) and the second purified aqueous solution from the second distillate layer 320 via the fourth protrusion 350 (e.g., via each of the one or more fourth protrusions 350). In some examples, the distal end 274 of the second conduit 270 (e.g., the distal end of each of the one or more second conduits 270) and the distal end 374 of the fourth conduit 370 (e.g., the distal end of each of the one or more fourth conduits 370) each independently form a watertight and/or an impermeable seal with the receptacle 500.

Systems 100 Further Comprising a Third Stage 3120

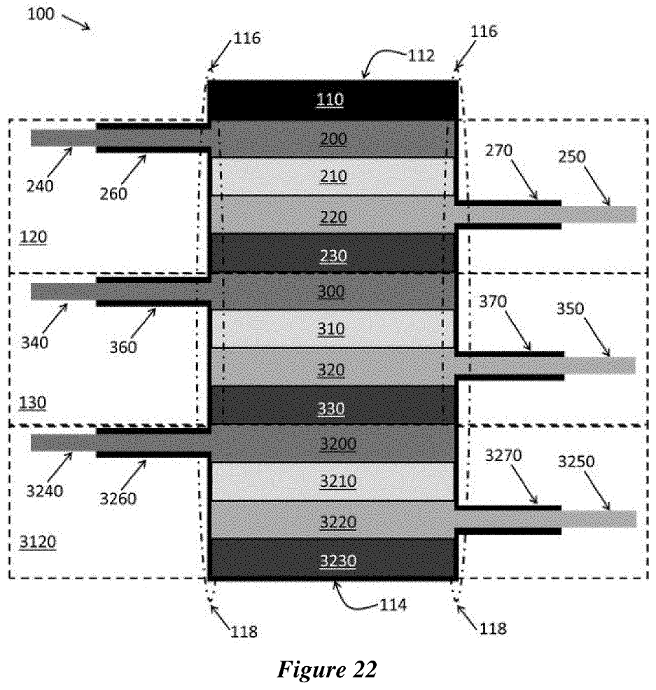

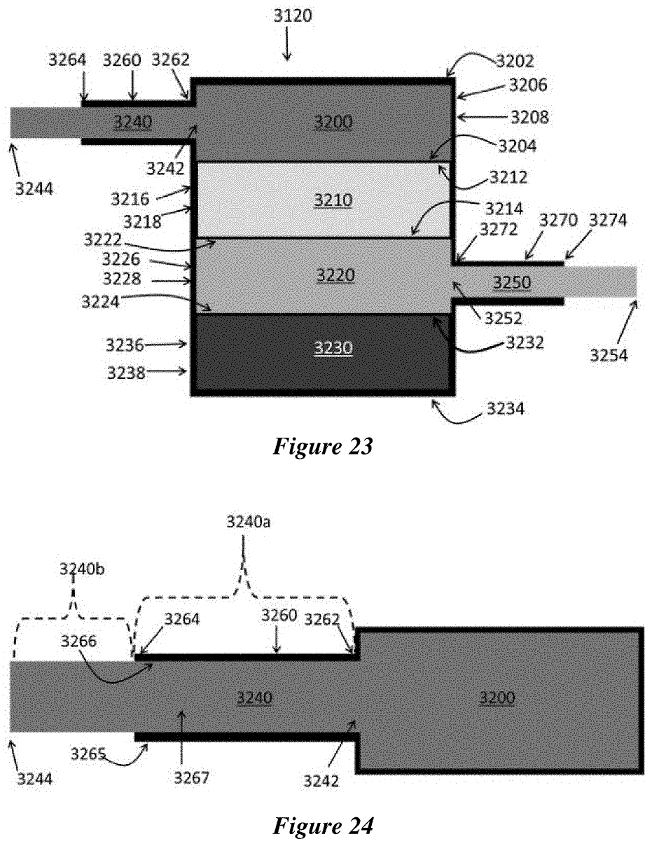

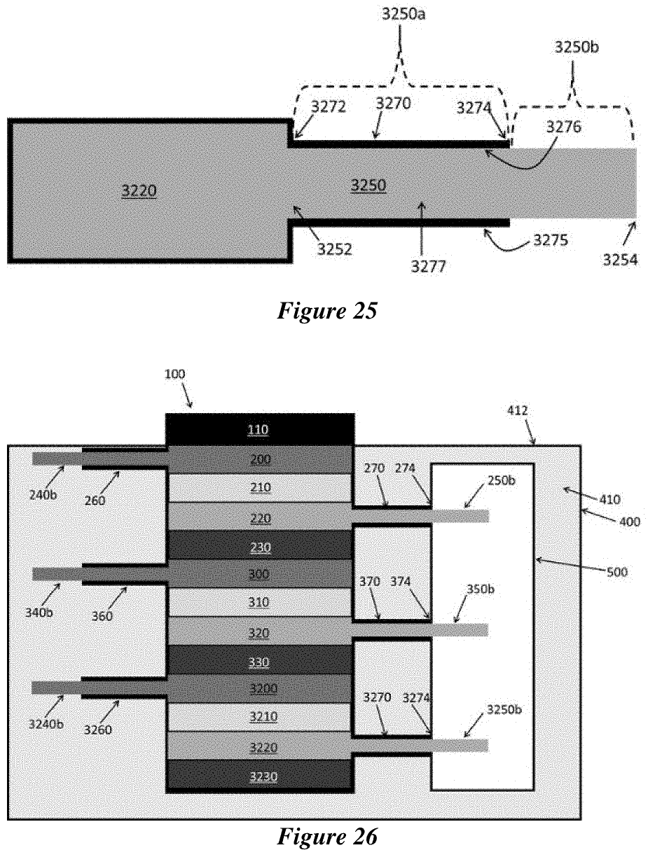

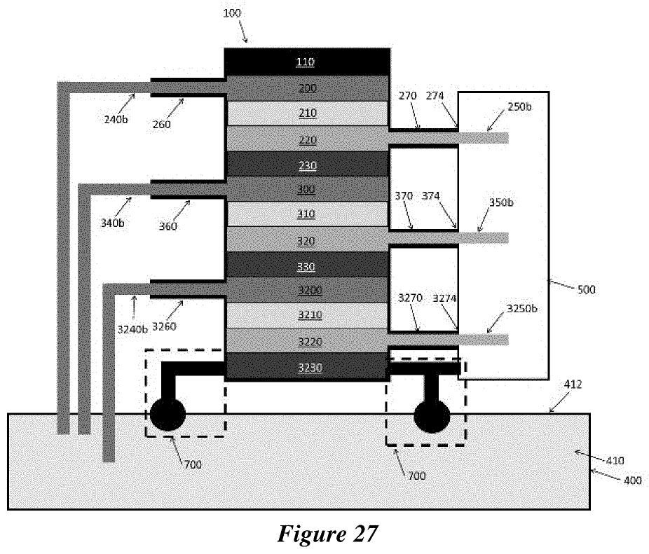

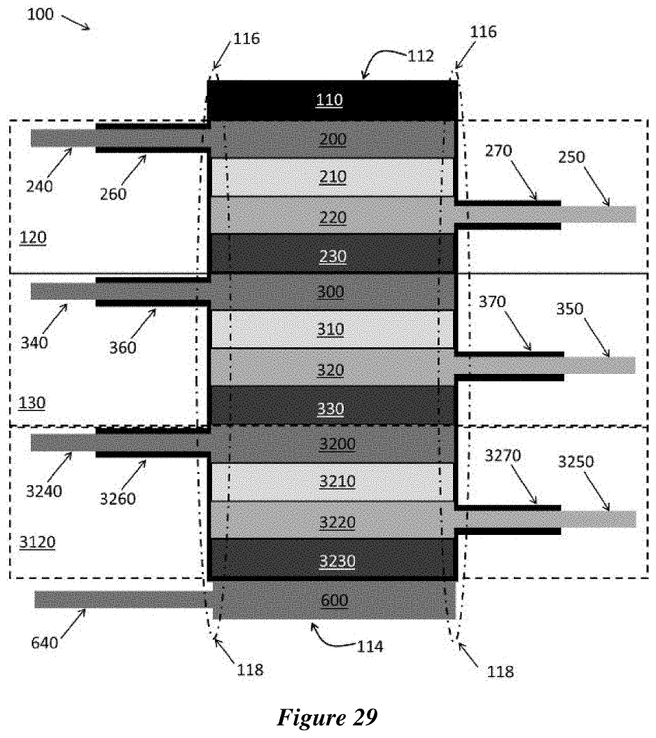

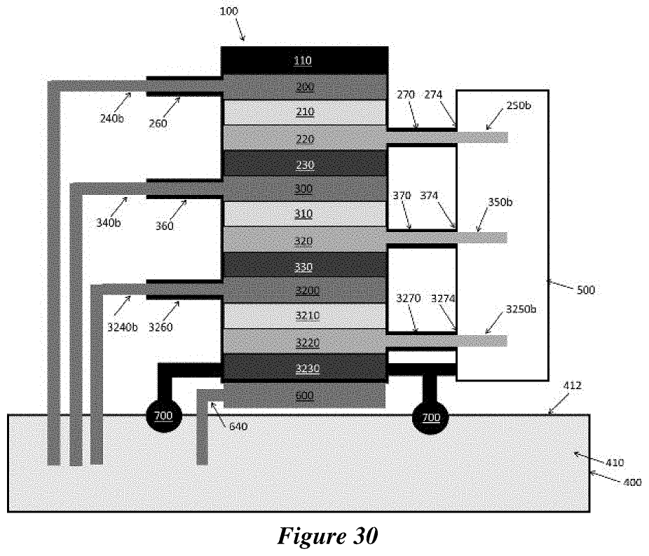

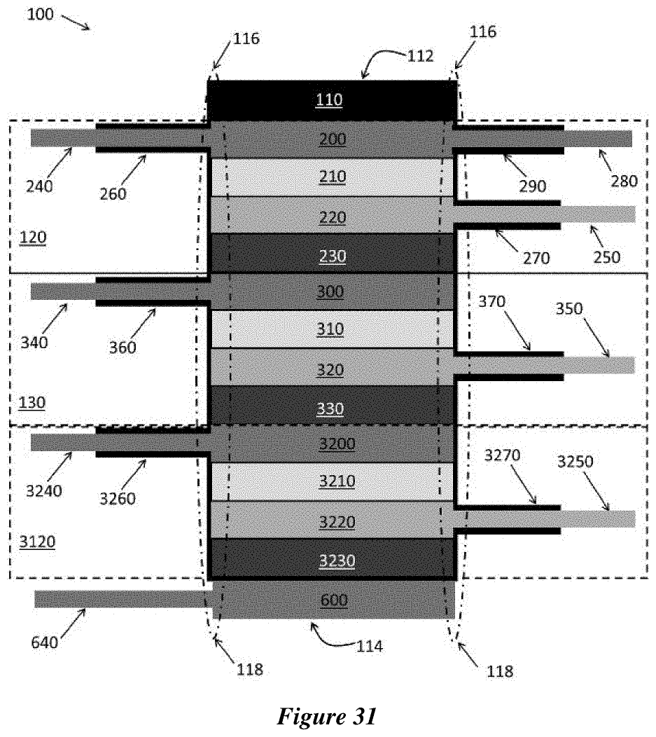

Referring now to FIG. 22-FIG. 31, in some examples the system 100 further comprises a third stage 3120. The third stage 3120 comprises: a third feedwater layer 3200; a third membrane distillation layer 3210; a third distillate layer 3220; and a third thermally conductive layer 3230. The third feedwater layer 3200 is disposed on top of and in physical and fluid contact with the third membrane distillation layer 3210; the third membrane distillation layer 3210 is disposed on top of and in physical and fluid contact with the third distillate layer 3220 (e.g., such that the third membrane distillation layer 3210 is sandwiched between the third feedwater layer 3200 and the third distillate layer 3220); and the third distillate layer 3220 is disposed on top of and in physical and thermal contact with the third thermally conductive layer 3230 (e.g., such that the third distillate layer 3220 is sandwiched between the third membrane distillation layer 3210 and the third thermally conductive layer 3230). The second stage 130 is stacked on top of the third stage 3120, such that the second thermally conductive layer 330 is disposed on top of and in physical and thermal contact with the third feedwater layer 3200. In some examples, the third thermally conductive layer 3230 is substantially impermeable (e.g., watertight).

The third feedwater layer 3200 has a top surface 3202, a bottom surface 3204 opposite and spaced apart from the top surface 3202, and a perimeter 3206 defined by an edge 3208. In some examples, the top surface 3202 and the bottom surface 3204 of the third feedwater layer 3200 are substantially parallel to each other. The top surface 3202 and the bottom surface 3204 of the third feedwater layer 3200 can, independently, be any shape. In some examples, the top surface 3202 and the bottom surface 3204 of the third feedwater layer 3200 can, independently, be substantially circular, ovate, ovoid, elliptic, triangular, rectangular, polygonal, etc. In some examples, the top surface 3202 and the bottom surface 3204 of the third feedwater layer 3200 can be substantially the same shape. In some examples, the top surface 3202 and the bottom surface 3204 of the third feedwater layer 3200 can be substantially rectangular.

The third membrane distillation layer 3210 has a top surface 3212, a bottom surface 3214 opposite and spaced apart from the top surface 3212, and a perimeter 3216 defined by an edge 3218. In some examples, the top surface 3212 and the bottom surface 3214 of the third membrane distillation layer 3210 are substantially parallel to each other. The top surface 3212 and the bottom surface 3214 of the third membrane distillation layer 3210 can, independently, be any shape. In some examples, the top surface 3212 and the bottom surface 3214 of the third membrane distillation layer 3210 can, independently, be substantially circular, ovate, ovoid, elliptic, triangular, rectangular, polygonal, etc. In some examples, the top surface 3212 and the bottom surface 3214 of the third membrane distillation layer 3210 can be substantially the same shape. In some examples, the top surface 3212 and the bottom surface 3214 of the third membrane distillation layer 3210 can be substantially rectangular.

The third distillate layer 3220 has a top surface 3222, a bottom surface 3224 opposite and spaced apart from the top surface 3222, and a perimeter 3226 defined by an edge 3228. In some examples, the top surface 3222 and the bottom surface 3224 of the third distillate layer 3220 are substantially parallel to each other. The top surface 3222 and the bottom surface 3224 of the third distillate layer 3220 can, independently, be any shape. In some examples, the top surface 3222 and the bottom surface 3224 of the third distillate layer 3220 can, independently, be substantially circular, ovate, ovoid, elliptic, triangular, rectangular, polygonal, etc. In some examples, the top surface 3222 and the bottom surface 3224 of the third distillate layer 3220 can be substantially the same shape. In some examples, the top surface 3222 and the bottom surface 3224 of the third distillate layer 3220 can be substantially rectangular.

The third thermally conductive layer 3230 has a top surface 3232, a bottom surface 3234 opposite and spaced apart from the top surface 3232, and a perimeter 3236 defined by an edge 3238. In some examples, the top surface 3232 and the bottom surface 3234 of the third thermally conductive layer 3230 are substantially parallel to each other. The top surface 3232 and the bottom surface 3234 of the third thermally conductive layer 3230 can, independently, be any shape. In some examples, the top surface 3232 and the bottom surface 3234 of the third thermally conductive layer 3230 can, independently, be substantially circular, ovate, ovoid, elliptic, triangular, rectangular, polygonal, etc. In some examples, the top surface 3232 and the bottom surface 3234 of the third thermally conductive layer 3230 can be substantially the same shape. In some examples, the top surface 3232 and the bottom surface 3234 of the third thermally conductive layer 3230 can be substantially rectangular.

In certain examples, the system 100 can further comprise: a sixth protrusion 3240 (e.g., one or more sixth protrusions 3240) and a seventh protrusion 3250 (e.g., one or more seventh protrusions 3250).

The sixth protrusion 3240 extends from a portion of the edge 3208 of the third feedwater layer 3200 from a proximal end 3242 to a distal end 3244 opposite and spaced apart from the proximal end 3242, the sixth protrusion 3240 being fluidly connected to the fourth feedwater layer 3200 from which it extends. In some examples, the system 100 comprises a plurality of sixth protrusions 3240, wherein each of the plurality of sixth protrusions 3240 extends from a portion of the edge 3208 of the third feedwater layer 3200 from a proximal end 3242 to a distal end 3244 opposite and spaced apart from the proximal end 3242, the sixth protrusion 3240 being fluidly connected to the fourth feedwater layer 3200 from which it extends. In some examples, at least a portion of the sixth protrusion 3240 (e.g., at least the first portion 3240a) is integrally formed with the fourth feedwater layer 3200 from which it extends. In some examples, at least a portion of each of the plurality of sixth protrusions 3240 (e.g., at least the first portion 3240a) is integrally formed with the fourth feedwater layer 3200 from which it extends.

The seventh protrusion 3250 extends from a portion of the edge 3228 of the third distillate layer 3220 from a proximal end 3252 to a distal end 3254 opposite and spaced apart from the proximal end 3252, the seventh protrusion 3250 being fluidly connected to the third distillate layer 3220 from which it extends. In some examples, the system comprises a plurality of seventh protrusions 3250, wherein each of the plurality of seventh protrusions 3250 extends from a portion of the edge 3228 of the third distillate layer 3220 from a proximal end 3252 to a distal end 3254 opposite and spaced apart from the proximal end 3252, the seventh protrusion 3250 being fluidly connected to the third distillate layer 3220 from which it extends. In some examples, at least a portion of the seventh protrusion 3250 (e.g., at least the first portion 3250a) is integrally formed with the third distillate layer 3220 from which it extends. In some examples, at least a portion of each of the plurality of seventh protrusions 3250 (e.g., at least the first portion 3250a) is integrally formed with the third distillate layer 3220 from which it extends.

In certain examples, the system further comprises: a sixth conduit 3260 (e.g., one or more sixth conduits 3260); and a seventh conduit 3270 (e.g., one or more seventh conduits 3270); wherein the perimeter 116 of the system is perforated by the sixth conduit 3260 (e.g., each of the one or more sixth conduits 3260) and the seventh conduit 3270 (e.g., each of the one or more seventh conduits 3270).

The sixth conduit 3260 (e.g., each of the one or more sixth conduits 3260) extends from the perimeter 116 of the system from a proximal end 3262 to a distal end 3264. The sixth conduit 3260 (e.g., each of the one or more sixth conduits 3260) has an exterior surface 3265 that is substantially impermeable (e.g., watertight) and an interior surface 3266 that defines a lumen 3267. The lumen 3267 of the sixth conduit 3260 contains a first portion 3240a of the sixth protrusion 3240 and a second portion 3240b of the sixth protrusion 3240 extends beyond the distal end 3264 of the sixth conduit 3260. For example, the lumen 3267 of each of the one or more sixth conduits 3260 contains a first portion 3240a of each of the one or more sixth protrusions 3240, and a second portion 3240b of each of the one or more sixth protrusions 3240 extends beyond the distal end 3264 of each of the one or more sixth conduits 3260.

The seventh conduit 3270 (e.g., each of the one or more seventh conduits 3270) extends from the perimeter 116 of the system from a proximal end 3272 to a distal end 3274. The seventh conduit 3270 (e.g., each of the one or more seventh conduits 3270) has an exterior surface 3275 that is substantially impermeable (e.g., watertight) and an interior surface 3276 that defines a lumen 3277. The lumen 3277 of the seventh conduit 3270 contains a first portion 3250a of the seventh protrusion 3250 and a second portion 3250b of the seventh protrusion 3250 extends beyond the distal end 3274 of the second conduit 3270. For example, the lumen 3277 of each of the one or more seventh conduits 3270 contains a first portion 3250a of each of the one or more seventh protrusions 3250, and a second portion 3250b of each of the one or more seventh protrusions 3250 extends beyond the distal end 3274 of each of the one or more second conduits 3270.

In some examples, the second portion 3240b of each of the one or more sixth protrusions 3240 is fluidly connected to the first portion 3240a. The second portion 3240b of each of the one or more sixth protrusions 3240 can be fluidly connected to the first portion 3240a using any suitable means, such as those known in the art. For example, the second portion 3240b of each of the one or more sixth protrusions 3240 can be fluidly connected to the first portion 3240a using an adhesive, solvent welding, heat, pressure, etc., or a combination thereof. In some examples, the second portion 3240b of each of the one or more sixth protrusions 3240 can be removably attached to the first portion 3240a, for example such that the second portion 3240b can be removed and replaced. For example, the second portion 3240b of each of the one or more sixth protrusions 3240 can be interchangeable.

In some examples, the second portion 3240b of each of the one or more sixth protrusions 3240 can further comprise one or more treatment components, e.g. one or more treatment components can be impregnated in the second portion 3240b of each of the one or more sixth protrusions 3240. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 3250b of each of the one or more seventh protrusions 3250 is fluidly connected to the first portion 3250a. The second portion 3250b of each of the one or more seventh protrusions 3250 can be fluidly connected to the first portion 3250a using any suitable means, such as those known in the art. For example, the second portion 3250b of each of the one or more seventh protrusions 3250 can be fluidly connected to the first portion 3250a using an adhesive, solvent welding, heat, pressure, etc., or a combination thereof. In some examples, the second portion 3250b of each of the one or more seventh protrusions 3250 can be removably attached to the first portion 3250a, for example such that the second portion 3250b can be removed and replaced. For example, the second portion 3250b of each of the one or more seventh protrusions 3250 can be interchangeable.

In some examples, the second portion 3250b of each of the one or more seventh protrusions 3250 can further comprise one or more treatment components, e.g. one or more treatment components can be impregnated in the second portion 3250b of each of the one or more seventh protrusions 3250. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, each of the feedwater layers of the system can further comprise an outflow protrusion (e.g. one or more outflow protrusions), wherein the outflow protrusion (e.g., each of the one or more outflow protrusions) extends from a portion of the edge of said feedwater layer from a proximal end to a distal end opposite and spaced apart from the proximal end, the outflow protrusion (e.g., each of the one or more outflow protrusions) being fluidly connected to the feedwater layer from which it extends. In some examples, at least a portion of the outflow protrusion (e.g., at least a portion of each of the one or more outflow protrusions) is integrally formed with the feedwater layer from which it extends.

In certain examples, the system further comprises an outflow conduit (e.g. one or more outflow conduits), wherein the perimeter of the system is perforated by the outflow conduit (e.g., each of the one or more outflow conduits). The outflow conduit (e.g., each of the one or more outflow conduits) extends from the perimeter of the system from a proximal end to a distal end. The outflow conduit (e.g., each of the one or more outflow conduits) has an exterior surface that is substantially impermeable (e.g., watertight) and an interior surface that defines a lumen. The lumen of the outflow conduit contains a first portion of the outflow protrusion and a second portion of the outflow protrusion extends beyond the distal end of the outflow conduit. For example, the lumen of each of the one or more outflow conduits contains a first portion of each of the one or more outflow protrusions, and a second portion of each of the one or more outflow protrusions extends beyond the distal end of each of the one or more outflow conduits.

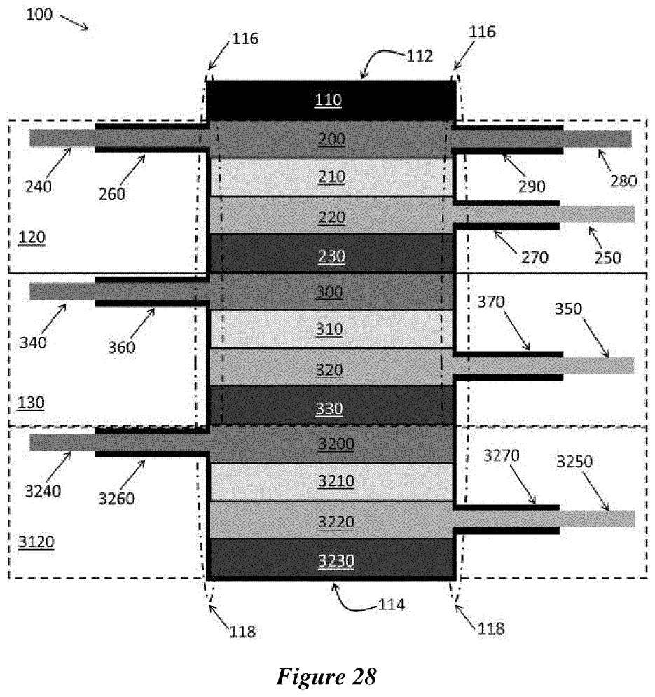

For example, referring now to FIG. 28, the first feedwater layer 200 can further comprise a first outflow protrusion 280 (e.g., one or more first outflow protrusions 280), the first outflow protrusion 280 (e.g., each of the one or more first outflow protrusions 280) extends from a portion of the edge of the first feedwater layer 200 from a proximal end to a distal end opposite and spaced apart from the proximal end, the first outflow protrusion 280 (e.g., each of the one or more first outflow protrusions 280) being fluidly connected to the first feedwater layer 200 from which it extends. In some examples, at least a portion of the first outflow protrusion 280 (e.g., at least a portion of each of the one or more first outflow protrusions 280) is integrally formed with the first feedwater layer 280 from which it extends.

In certain examples, the system further comprises an outflow conduit 290 (e.g. one or more outflow conduits 290), wherein the perimeter 116 of the system is perforated by the outflow conduit 290 (e.g., each of the one or more outflow conduits 290). The outflow conduit 290 (e.g., each of the one or more outflow conduits 290) extends from the perimeter 116 of the system from a proximal end to a distal end. The outflow conduit 290 (e.g., each of the one or more outflow conduits 290) has an exterior surface that is substantially impermeable (e.g., watertight) and an interior surface that defines a lumen. The lumen of the outflow conduit 290 contains a first portion of the outflow protrusion 280 and a second portion of the outflow protrusion 280 extends beyond the distal end of the outflow conduit 290. For example, the lumen of each of the one or more outflow conduits 290 contains a first portion of each of the one or more outflow protrusions 280, and a second portion of each of the one or more outflow protrusions 280 extends beyond the distal end of each of the one or more outflow conduits 290.

For example, the system can be configured such that there is a driving force to produce update of a liquid and/or solution by the feedwater protrusion(s), from the feedwater protrusion(s) across the feedwater layer to the outflow protrusion(s), and out the outflow protrusion(s). The driving force can, for example, be gravity based (e.g., the feedwater protrusion(s) are elevated above the outflow protrusions(s)), capillary based (e.g., increasing capillary force from the feedwater protrusions(s) to the outlet protrusion(s), etc.

The system 100 further comprises: a top surface 112; a bottom surface 114 opposite and spaced apart from the top surface 112; a perimeter 116 defined by an edge 118. In some examples, the top surface 112 and the bottom surface 114 of are substantially parallel to each other.

In some examples, the top surface 112 and the perimeter 116 of the system 100 are each substantially impermeable (e.g., to ions, solutions, and/or liquids). In some examples, the top surface 112 and the perimeter 116 of the system 100 are each substantially watertight. In some examples, the top surface 112 comprises the solar absorber layer 110.

In some examples, the bottom surface 114 is substantially impermeable (e.g., to ions, solutions, and/or liquids). In some examples, the bottom surface 114 is substantially watertight. In certain examples, the bottom surface 114 of the system comprises the third thermally conductive layer 3230.

In some examples, the system further comprises a terminal feedwater layer 600, wherein the third stage 3120 is stacked on top of the terminal feedwater layer 600, such that the third thermally conductive layer 3230 is disposed on top of an in physical and thermal contact with the terminal feedwater layer 600. In some examples, the bottom surface 114 comprises the terminal feedwater layer 600.

The terminal feedwater layer 600 has a top surface 602, a bottom surface 604 opposite and spaced apart from the top surface 602, and a perimeter 606 defined by an edge 608. In some examples, the top surface and the bottom surface of the terminal feedwater layer are substantially parallel to each other. The layer can have an average thickness, the average thickness being the average dimension from the top surface to the bottom surface.

The top surface 602 and the bottom surface 604 of the terminal feedwater layer 600 can, independently, be any shape. In some examples, the top surface 602 and the bottom surface 604 of the terminal feedwater layer 600 can, independently, be substantially circular, ovate, ovoid, elliptic, triangular, rectangular, polygonal, etc. In some examples, the top surface 602 and the bottom surface 604 of the terminal feedwater layer 600 can be substantially the same shape. In some examples, the top surface 602 and the bottom surface 604 of the terminal feedwater layer 600 can be substantially rectangular.

In some examples, the terminal feedwater layer 600 can further comprise an terminal feedwater protrusion 640 (e.g., one or more terminal feedwater protrusions 640), wherein the terminal feedwater protrusion 640 (e.g., each of the one or more terminal feedwater protrusions 640) extends from a portion of the edge 608 of the terminal feedwater layer 600 from a proximal end 642 to a distal end 644 opposite and spaced apart from the proximal end 642, the terminal feedwater protrusion 640 (e.g., each of the one or more terminal feedwater protrusions 640) being fluidly connected to the terminal feedwater layer 600 from which it extends. In some examples, at least a portion of the terminal feedwater protrusion 640 (e.g., at least a portion of each of the one or more terminal feedwater protrusions 640) is integrally formed with the terminal feedwater layer 600 from which it extends.

The system 100 is configured to be flexible. For example, the system 100 is flexible such that the system 100 can be rolled and/or folded when being stored (e.g., to be more spatially compact) and then unrolled and/or unfolded when deployed. In some examples, the system 100 is further configured to be lightweight, such that the system can be easily transported.

In some examples, the system 100 is configured to be deployed in reservoir 400 containing a contaminated aqueous solution 410, the contaminated aqueous solution 410 having a surface 412.

In some examples, the system is configured to be deployed on land or on a vehicle, wherein the system is deployed proximate a contaminated aqueous solution 410, e.g. proximate a reservoir containing a contaminated aqueous solution 410.

In some examples, the system 100 is configured to be buoyant, such that the system 100 floats in the contaminated aqueous solution 410 when deployed therein, such that at least the solar absorber layer 110 is disposed above the surface 412 of the contaminated aqueous solution 410.

In some examples, the system 100 further comprises a buoyant frame 700 that is configured to be coupled to the system 100 and/or the receptacle 500 such that the system 100 and/or the receptacle 500 is buoyant. In some examples, the buoyant frame 700 comprises external floats or buoys coupled to a frame, said frame itself being buoyant or non-buoyant.

In certain examples, at least a portion of the system 100 is disposed above the surface 412 of the contaminated aqueous solution 410. In certain examples, the system 100 is disposed above the surface 412 of the contaminated aqueous solution 410, for example such that the bottom surface 114 is disposed above the surface 412 of the contaminated aqueous solution 410, e.g. such that there is an air gap between the bottom surface 114 of the device and the surface 412 of the contaminated aqueous solution 410.

In certain examples, wherein the system 100 includes the a terminal feedwater layer 600, the system 100 is configured to be buoyant such that the terminal feedwater layer 600 is disposed above the surface 412 of the contaminated aqueous solution 410, e.g. such that there is an air gap between the bottom surface 604 of the terminal feedwater layer 600 and the surface 412 of the contaminated aqueous solution 410.

When the system is deployed, the second portion 3240b of the sixth protrusion 3240 (e.g., the second portion of each of the one or more sixth protrusions 3240) is configured to be in contact with the contaminated aqueous solution 410. The third feedwater layer 3200 is configured to receive a third portion of the contaminated aqueous solution from the sixth protrusion 3240, said third portion of the contaminated aqueous solution being a third feed solution. The second thermally conductive layer 330 is configured to collect the second latent heat of condensation and conduct the collected second latent heat of condensation to the third feedwater layer 3200 to thereby distill the at least a portion of the third feed solution through the third membrane distillation layer 3210, thereby producing a third distillate in the third distillate layer 3220. The third distillate layer 3220 is configured to receive the third distillate from the third membrane distillation layer 3210 and condense the third distillate to form a third condensate and release a third latent heat of condensation. Distilling said portion of the third feed solution through the third membrane distillation layer 3210 purifies said portion of the third feed solution to produce a third purified aqueous solution as the third condensate. The distal end 3274 of the seventh conduit 3270 (e.g., the distal end 3274 of each of the one or more seventh conduits 3270) is configured to be fluidly connected to the receptacle 500, such that the second portion 3250b of the seventh protrusion 3250 (e.g., the second portion 3250b of each of the one or more seventh protrusions 3250) is configured to be disposed within the receptacle 500, such that the receptacle 500 is configured to receive and collect: the third purified aqueous solution from the third distillate layer 3220 via the seventh protrusion 3250 (e.g., via each of the one or more seventh protrusions 3250). In some examples, the distal end 3274 of the seventh conduit 3270 (e.g., the distal end 3274 of each of the one or more seventh conduits 3270) forms a watertight and/or impermeable seal with the receptacle 500.

Systems 100 Further Comprising One or More Additional Stages 1120 and a Final Stage 1130

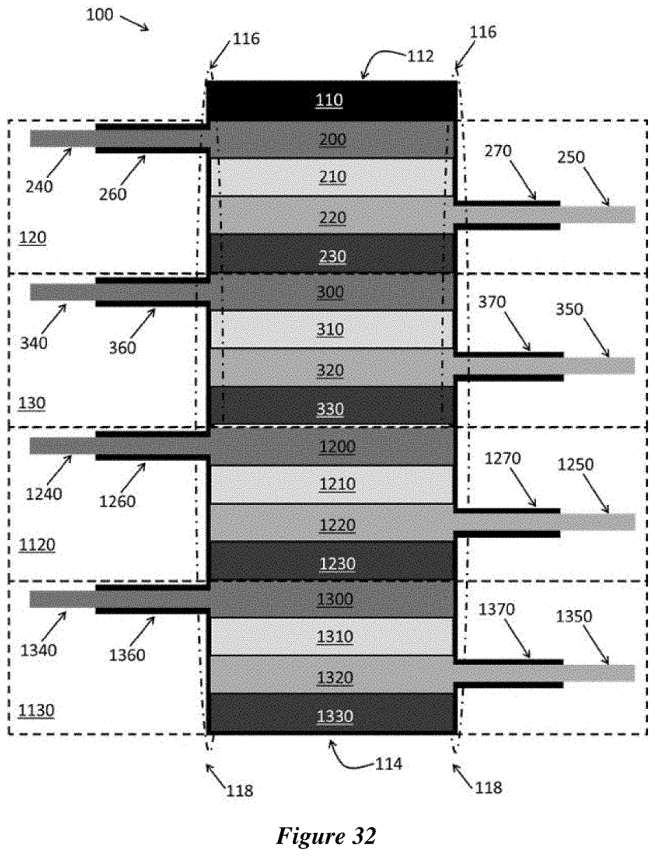

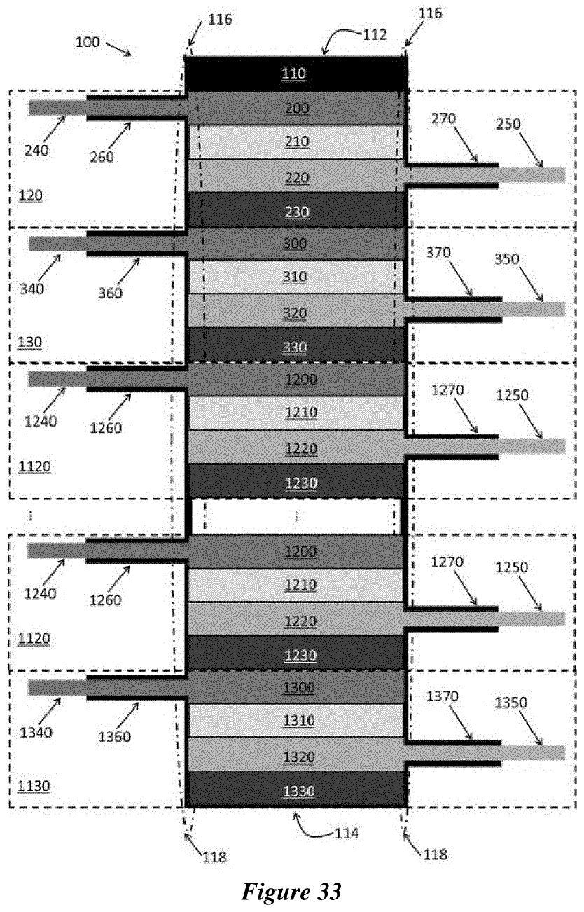

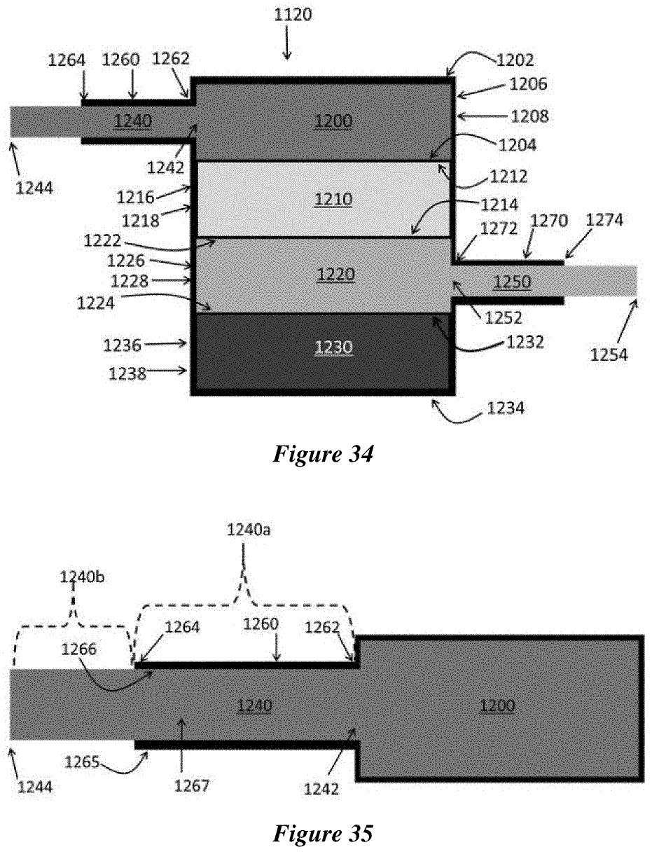

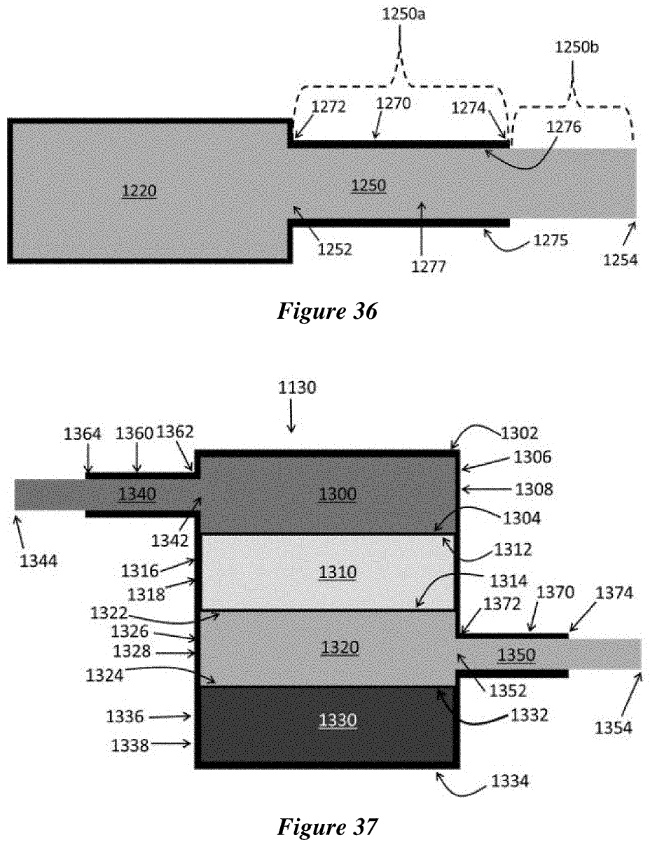

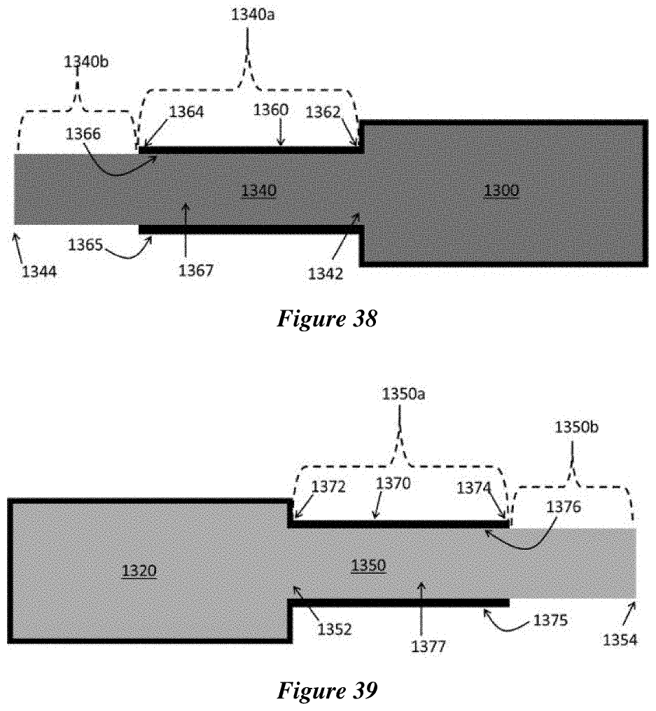

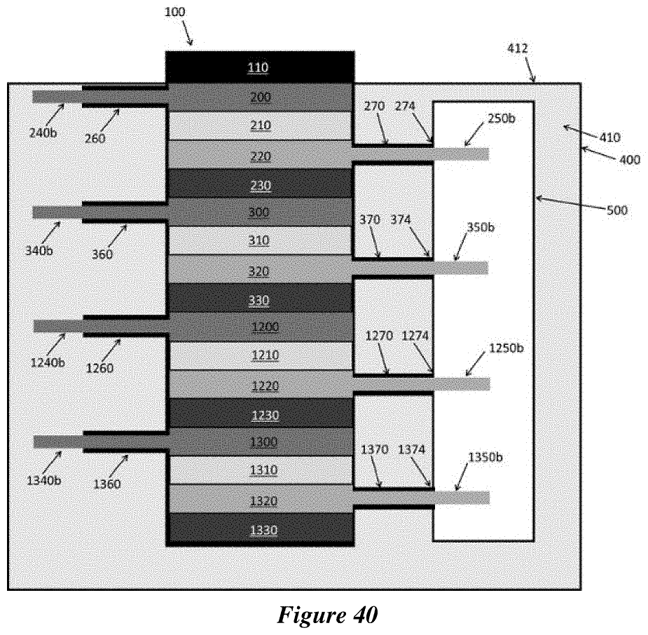

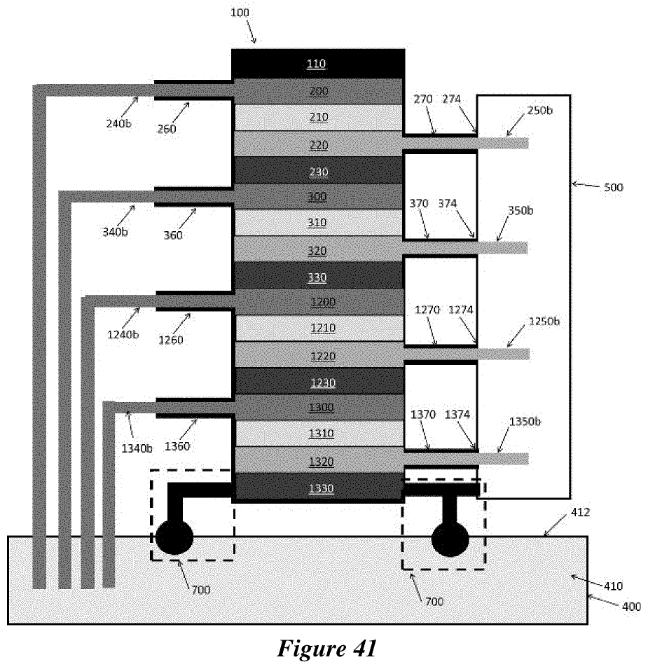

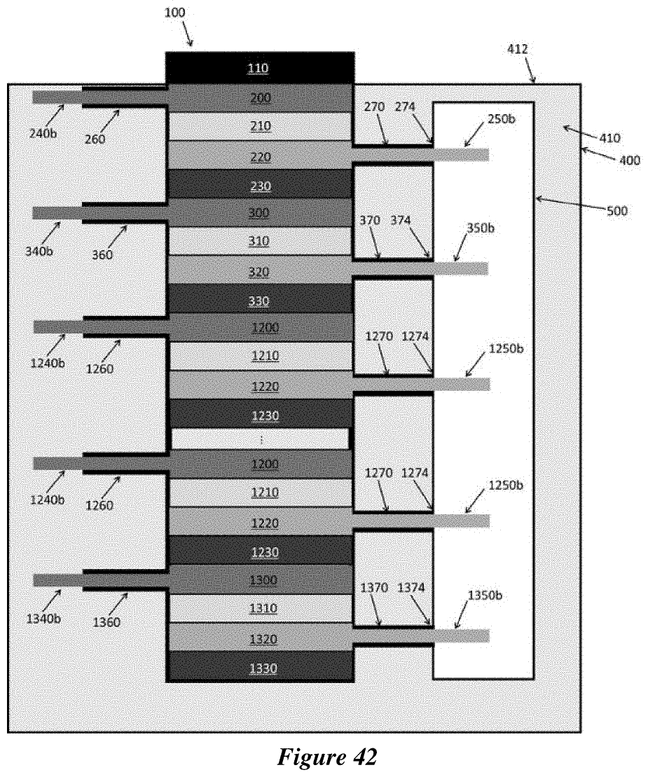

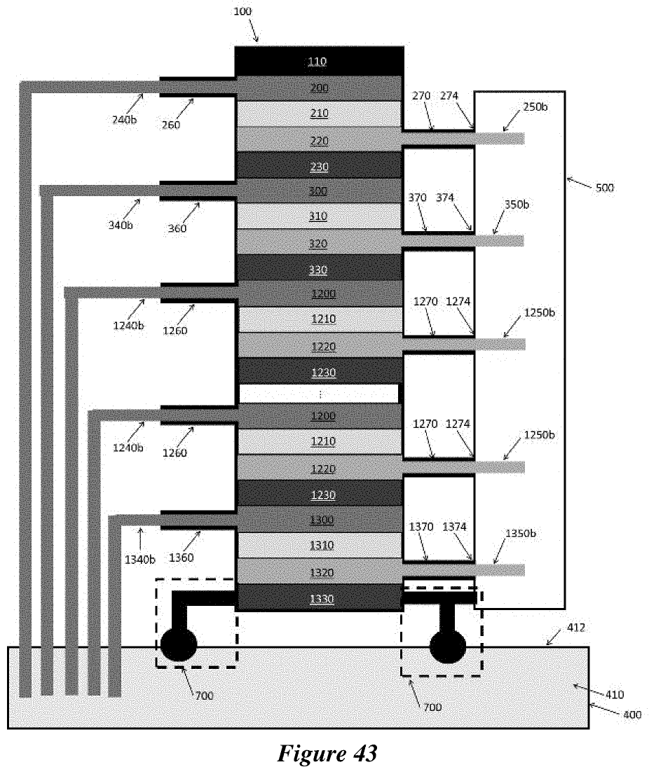

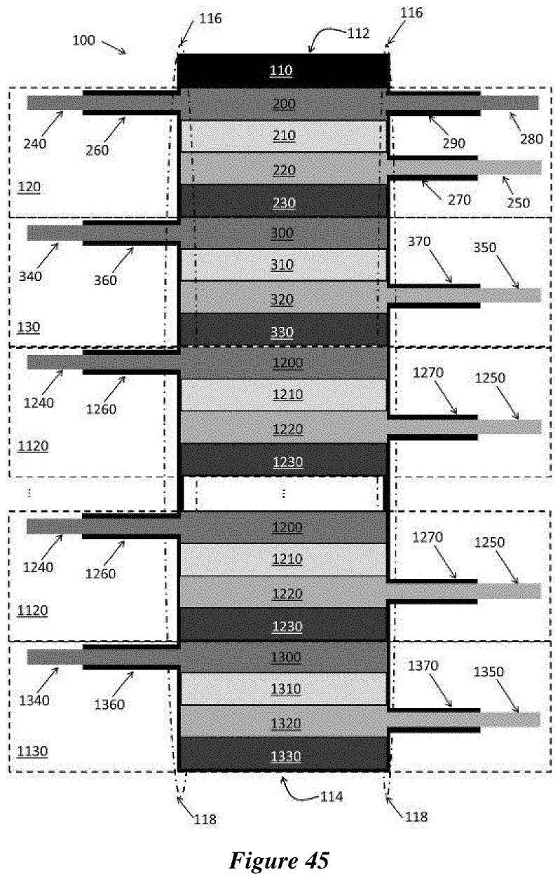

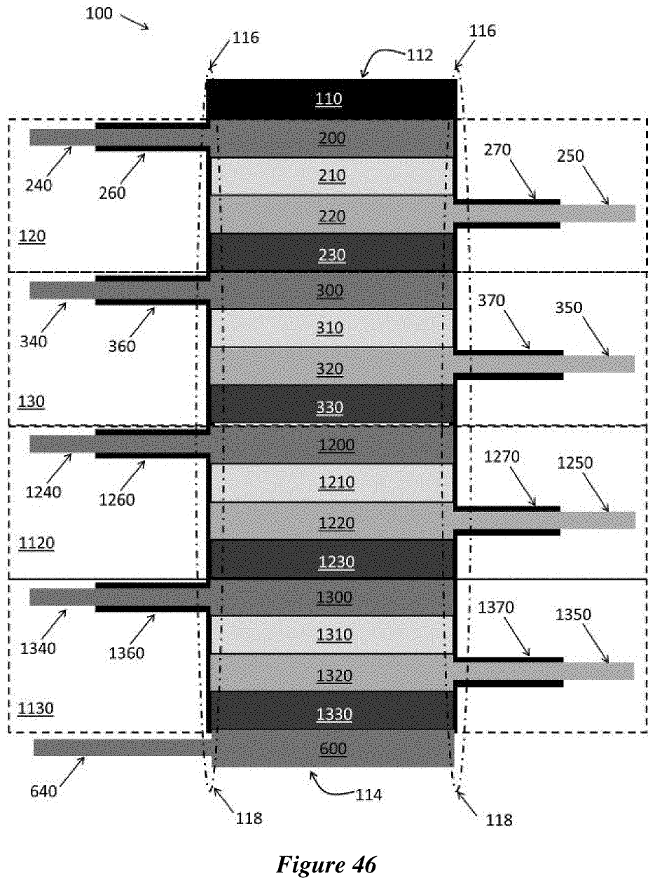

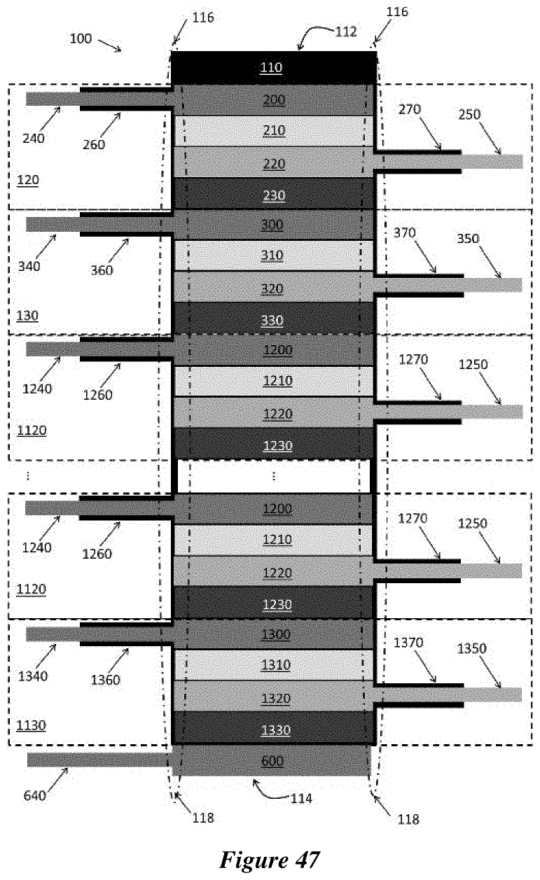

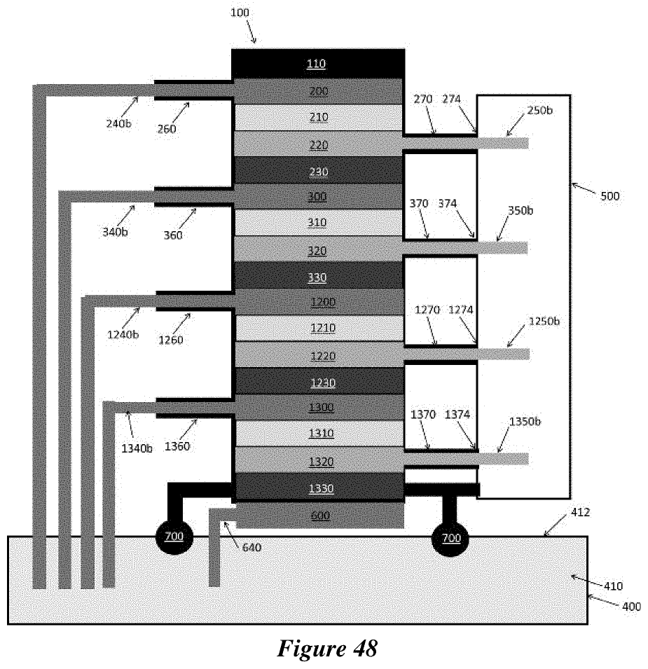

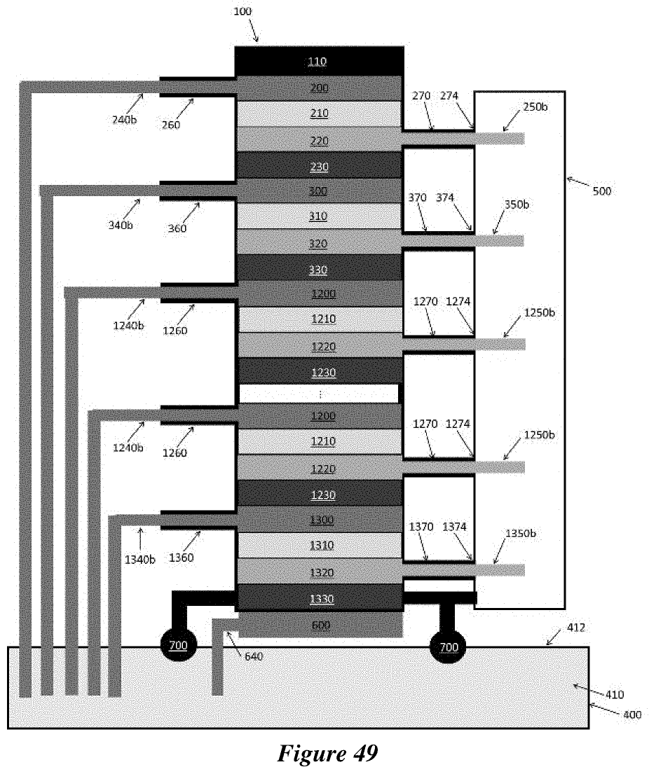

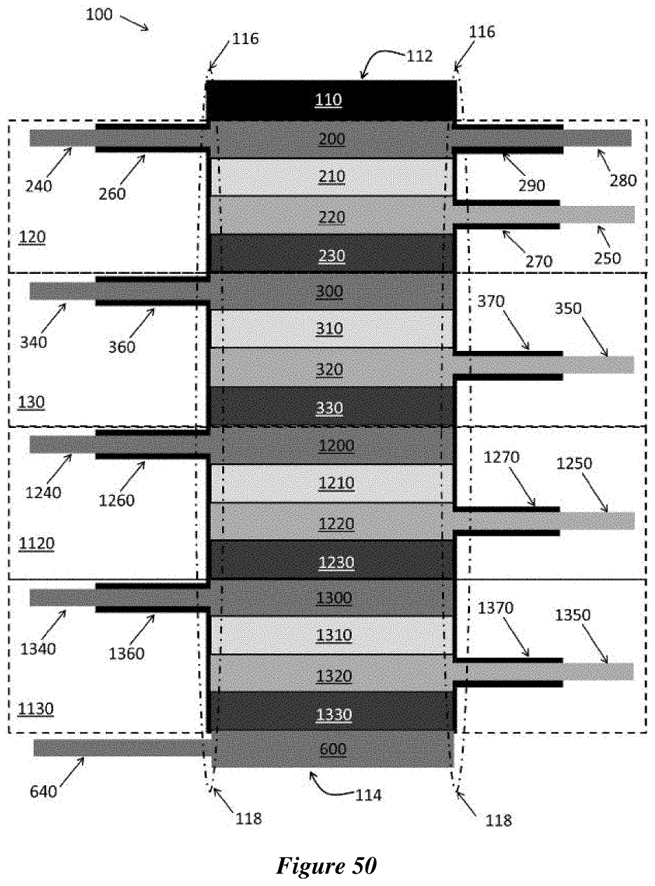

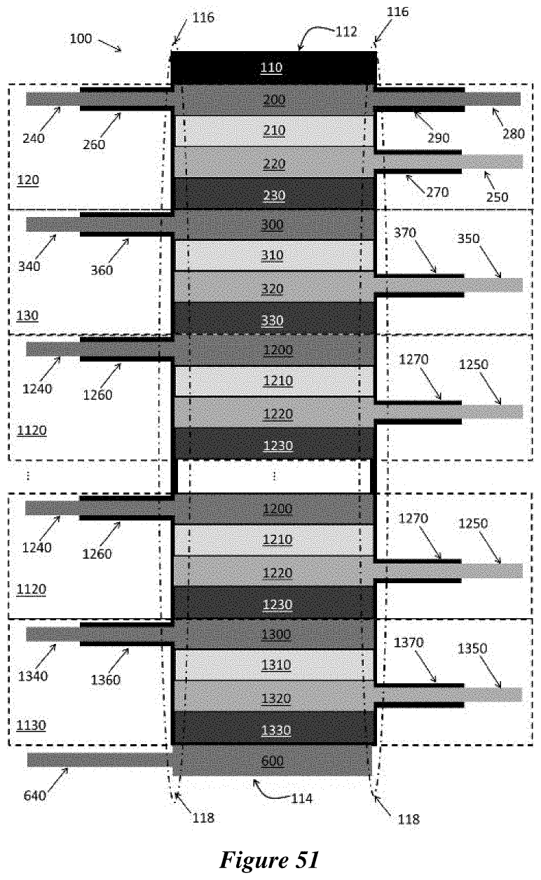

Referring now to FIG. 32-FIG. 51, in some examples the system 100 further comprises: one or more additional stages 1120; and a final stage 1130.

Each of the one or more additional stages 1120 independently comprises: a feedwater layer 1200; a membrane distillation layer 1210; a distillate layer 1220; and a thermally conductive layer 1230. In each of the one or more additional stages independently, the feedwater layer 1200 is disposed on top of and in physical and fluid contact with the membrane distillation layer 1210; the membrane distillation layer 1210 is disposed on top of and in physical and fluid contact with the distillate layer 1220 (e.g., such that the membrane distillation layer 1210 is sandwiched between the feedwater layer 1200 and the distillate layer 1220); and the distillate layer 1220 is disposed on top of and in physical and thermal contact with the thermally conductive layer 1230 (e.g., such that the distillate layer 1220 is sandwiched between the membrane distillation layer 1210 and the thermally conductive layer 1230).

Each of the one or more additional feedwater layers 1200 has a top surface 1202, a bottom surface 1204 opposite and spaced apart from the top surface 1202, and a perimeter 1206 defined by an edge 1208. In some examples, the top surface 1202 and the bottom surface 1204 of each of the one or more additional feedwater layers 1200 are substantially parallel to each other. The top surface 1202 and the bottom surface 1204 of each of the one or more additional feedwater layers 1200 can, independently, be any shape. In some examples, the top surface 1202 and the bottom surface 1204 of each of the one or more additional feedwater layers 1200 can, independently, be substantially circular, ovate, ovoid, elliptic, triangular, rectangular, polygonal, etc. In some examples, the top surface 1202 and the bottom surface 1204 of each of the one or more additional feedwater layers 1200 can be substantially the same shape. In some examples, the top surface 1202 and the bottom surface 1204 of each of the one or more additional feedwater layers 1200 can be substantially rectangular.

Each of the one or more additional membrane distillation layers 1210 has a top surface 1212, a bottom surface 1214 opposite and spaced apart from the top surface 1212, and a perimeter 1216 defined by an edge 1218. In some examples, the top surface 1212 and the bottom surface 1214 of each of the one or more additional membrane distillation layers 1210 are substantially parallel to each other. The top surface 1212 and the bottom surface 1214 of each of the one or more additional membrane distillation layers 1210 can, independently, be any shape. In some examples, the top surface 1212 and the bottom surface 1214 of each of the one or more additional membrane distillation layers 1210 can, independently, be substantially circular, ovate, ovoid, elliptic, triangular, rectangular, polygonal, etc. In some examples, the top surface 1212 and the bottom surface 1214 of each of the one or more additional membrane distillation layers 1210 can be substantially the same shape. In some examples, the top surface 1212 and the bottom surface 1214 of each of the one or more additional membrane distillation layers 1210 can be substantially rectangular.

Each of the one or more additional distillate layers 1220 has a top surface 1222, a bottom surface 1224 opposite and spaced apart from the top surface 1222, and a perimeter 1226 defined by an edge 1228. In some examples, the top surface 1222 and the bottom surface 1224 of each of the one or more additional distillate layers 1220 are substantially parallel to each other. The top surface 1222 and the bottom surface 1224 of each of the one or more additional distillate layers 1220 can, independently, be any shape. In some examples, the top surface 1222 and the bottom surface 1224 of each of the one or more additional distillate layers 1220, independently, be substantially circular, ovate, ovoid, elliptic, triangular, rectangular, polygonal, etc. In some examples, the top surface 1222 and the bottom surface 1224 of each of the one or more additional distillate layers 1220 can be substantially the same shape. In some examples, the top surface 1222 and the bottom surface 1224 of each of the one or more additional distillate layers 1220 can be substantially rectangular.

Each of the one or more additional thermally conductive layers 1230 has a top surface 1232, a bottom surface 1234 opposite and spaced apart from the top surface 1232, and a perimeter 1236 defined by an edge 1238. In some examples, the top surface 1232 and the bottom surface 1234 of each of the one or more additional thermally conductive layers 1230 are substantially parallel to each other. The top surface 1232 and the bottom surface 1234 of each of the one or more additional thermally conductive layers 1230 can, independently, be any shape. In some examples, the top surface 1232 and the bottom surface 1234 of each of the one or more additional thermally conductive layers 1230 can, independently, be substantially circular, ovate, ovoid, elliptic, triangular, rectangular, polygonal, etc. In some examples, the top surface 1232 and the bottom surface 1234 of each of the one or more additional thermally conductive layers 1230 can be substantially the same shape. In some examples, the top surface 1232 and the bottom surface 1234 of each of the one or more additional thermally conductive layers 1230 can be substantially rectangular.

The final stage 1130 comprises: a final feedwater layer 1300; a final membrane distillation layer 1310; a final distillate layer 1320; and a final thermally conductive layer 1330. The final feedwater layer 1300 is disposed on top of and in physical and fluid contact with the final membrane distillation layer 1310; the final membrane distillation layer 1310 is disposed on top of and in physical and fluid contact with the final distillate layer 1320 (e.g., such that the final membrane distillation layer 1310 is sandwiched between the final feedwater layer 1300 and the final distillate layer 1320); and the final distillate layer 1320 is disposed on top of and in physical and thermal contact with the final thermally conductive layer 1330 (e.g., such that the final distillate layer 1320 is sandwiched between the final membrane distillation layer 1310 and the final thermally conductive layer 1330).

The final feedwater layer 1300 has a top surface 1302, a bottom surface 1304 opposite and spaced apart from the top surface 1302, and a perimeter 1306 defined by an edge 1308. In some examples, the top surface 1302 and the bottom surface 1304 of the final feedwater layer 1300 are substantially parallel to each other. The top surface 1302 and the bottom surface 1304 of the final feedwater layer 1300 can, independently, be any shape. In some examples, the top surface 1302 and the bottom surface 1304 of the final feedwater layer 1300 can, independently, be substantially circular, ovate, ovoid, elliptic, triangular, rectangular, polygonal, etc. In some examples, the top surface 1302 and the bottom surface 1304 of the final feedwater layer 1300 can be substantially the same shape. In some examples, the top surface 1302 and the bottom surface 1304 of the final feedwater layer 1300 can be substantially rectangular.

The final membrane distillation layer 1310 has a top surface 1312, a bottom surface 1314 opposite and spaced apart from the top surface 1312, and a perimeter 1316 defined by an edge 1318. In some examples, the top surface 1312 and the bottom surface 1314 of the final membrane distillation layer 1310 are substantially parallel to each other. The top surface 1312 and the bottom surface 1314 of the final membrane distillation layer 1310 can, independently, be any shape. In some examples, the top surface 1312 and the bottom surface 1314 of the final membrane distillation layer 1310 can, independently, be substantially circular, ovate, ovoid, elliptic, triangular, rectangular, polygonal, etc. In some examples, the top surface 1312 and the bottom surface 1314 of the final membrane distillation layer 1310 can be substantially the same shape. In some examples, the top surface 1312 and the bottom surface 1314 of the final membrane distillation layer 1310 can be substantially rectangular.

The final distillate layer 1320 has a top surface 1322, a bottom surface 1324 opposite and spaced apart from the top surface 1322, and a perimeter 1326 defined by an edge 1328. In some examples, the top surface 1322 and the bottom surface 1324 of the final distillate layer 1320 are substantially parallel to each other. The top surface 1322 and the bottom surface 1324 of the final distillate layer 1320 can, independently, be any shape. In some examples, the top surface 1322 and the bottom surface 1324 of the final distillate layer 1320 can, independently, be substantially circular, ovate, ovoid, elliptic, triangular, rectangular, polygonal, etc. In some examples, the top surface 1322 and the bottom surface 1324 of the final distillate layer 1320 can be substantially the same shape. In some examples, the top surface 1322 and the bottom surface 1324 of the final distillate layer 1320 can be substantially rectangular.

The final thermally conductive layer 1330 has a top surface 1332, a bottom surface 1334 opposite and spaced apart from the top surface 1332, and a perimeter 1336 defined by an edge 1338. In some examples, the top surface 1332 and the bottom surface 1334 of the final thermally conductive layer 1330 are substantially parallel to each other. The top surface 1332 and the bottom surface 1334 of the final thermally conductive layer 1330 can, independently, be any shape. In some examples, the top surface 1332 and the bottom surface 1334 of the final thermally conductive layer 1330 can, independently, be substantially circular, ovate, ovoid, elliptic, triangular, rectangular, polygonal, etc. In some examples, the top surface 1332 and the bottom surface 1334 of the final thermally conductive layer 1330 can be substantially the same shape. In some examples, the top surface 1332 and the bottom surface 1334 of the final thermally conductive layer 1330 can be substantially rectangular.

In certain examples, the second stage 130 is stacked on top of the one or more additional stages 1120, which are in turn stacked on top the final stage 1130, such that the thermally conductive layer of a preceding stage is disposed on top of and in physical and thermal contact with the feedwater layer of a subsequent stage. In some examples, each of the one or more additional thermally conductive layers 1230 and the final thermally conductive layer 1330 are each substantially impermeable (e.g., watertight).

In certain examples, each of the one or more additional feedwater layers 1200 further comprises an additional feedwater protrusion 1240 (e.g., one or more additional feedwater protrusions 1240), wherein the additional feedwater protrusion 1240 (e.g., each of the one or more additional feedwater protrusions 1240) extends from a portion of the edge 1208 of said additional feedwater layer 1200 from a proximal end 1242 to a distal end 1244 opposite and spaced apart from the proximal end 1242, the additional feedwater protrusion 1240 (e.g., each of the one or more additional feedwater protrusions 1240) being fluidly connected to the additional feedwater layer 1200 from which it extends. In some examples, at least a portion of the additional feedwater protrusion 1240 (e.g., at least a portion of each of the one or more additional feedwater protrusions 1240), such as at least the first portion 1240, is integrally formed with the additional feedwater layer 1200 from which it extends.

In certain examples, each of the one or more additional distillate layers 1220 further comprises an additional distillate protrusion 1250 (e.g., one or more additional distillate protrusions 1250), wherein the additional distillate protrusion 1250 (e.g., each of the one or more additional distillate protrusions 1250) extends from a portion of the edge 1228 of said additional distillate layer 1220 from a proximal end 1252 to a distal end 1254 opposite and spaced apart from the proximal end 1252, the additional distillate protrusion 1250 (e.g., each of the one or more additional distillate protrusions 1250) being fluidly connected to the additional distillate layer 1220 from which it extends. In some examples, at least a portion of the additional distillate protrusion 1250 (e.g., at least a portion of each of the one or more additional distillate protrusions 1250), such as at least the first portion 1250a, is integrally formed with the additional distillate layer 1220 from which it extends.

In certain examples, the final feedwater layer 1300 further comprises a final feedwater protrusion 1340 (e.g., one or more final feedwater protrusions 1340), wherein the final feedwater protrusion 1340 (e.g., each of the one or more final feedwater protrusions 1340) extends from a portion of the edge 1308 of the final feedwater layer 1300 from a proximal end 1342 to a distal end 1344 opposite and spaced apart from the proximal end 1342, the final feedwater protrusion 1340 (e.g., each of the one or more final feedwater protrusions 1340) being fluidly connected to the final feedwater layer 1300 from which it extends. In some examples, at least a portion of the final feedwater protrusion 1340 (e.g., at least a portion of each of the one or more final feedwater protrusions 1340), such as at least the first portion 1340a, is integrally formed with the final feedwater layer 1300 from which it extends.

In some examples, the final distillate layer 1320 further comprises a final distillate protrusion 1350 (e.g., one or more final distillate protrusions 1350), wherein the final distillate protrusion 1350 (e.g., each of the one or more final distillate protrusions 1350) extends from a portion of the edge 1328 of the final distillate layer 1320 from a proximal end 1352 to a distal 1354 end opposite and spaced apart from the proximal end 1352, the final distillate protrusion 1350 (e.g., each of the one or more final distillate protrusions 1350) being fluidly connected to the final distillate layer 1320 from which it extends. In some examples, at least a portion of the final distillate protrusion 1350 (e.g., at least a portion of each of the one or more final distillate protrusions 1350), such as at least the first portion 1350a, is integrally formed with the final distillate layer 1320 from which it extends.

In certain examples, the system further comprises: one or more additional feedwater conduits 1260; one or more additional distillate conduits 1270; a final feedwater conduit 1360 (e.g., one or more final feedwater conduits 1360); and a final distillate conduit 1370 (e.g., one or more final distillate conduits 1370); wherein the perimeter 116 of the system is perforated by each of the one or more additional feedwater conduits 1260, one or more additional distillate conduits 1270, the final feedwater conduit 1360 (e.g., each of the one or more final feedwater conduits 1360), and the final distillate conduit 1370 (e.g., each of the one or more final distillate conduits 1370).

Each of the one or more additional feedwater conduits 1260 extends from the perimeter 116 of the system from a proximal end 1262 to a distal end 1264. Each of the one or more additional feedwater conduits 1260 has an exterior surface 1265 that is substantially impermeable (e.g., watertight) and an interior surface 1266 that defines a lumen 1267. The lumen 1267 of each of the one or more additional feedwater conduits 1260 contains a first portion 1240a of each of the one of the one or more additional feedwater protrusions 1240 and a second portion 1240b of said feedwater protrusion 1240 extends beyond the distal end 1264 of said feedwater conduit 1260.

Each of the one or more additional distillate conduits 1270 extends from the perimeter 116 of the system from a proximal end 1272 to a distal end 1274. Each of the one or more additional distillate conduits 1270 has an exterior surface 1275 that is substantially impermeable (e.g., watertight) and an interior surface 1276 that defines a lumen 1277. The lumen 1277 of each of the one or more additional distillate conduits 1270 contains a first portion 1250a of each of the one of the one or more additional distillate protrusions 1250 and a second portion 1250b of said distillate protrusion 1250 extends beyond the distal end 1274 of said distillate conduit 1270.

The final feedwater conduit 1360 (e.g., each of the one or more final feedwater conduits 1360) extends from the perimeter 116 of the system from a proximal end 1362 to a distal end 1364. The final feedwater conduit 1360 (e.g., each of the one or more final feedwater conduits 1360) has an exterior surface 1365 that is substantially impermeable (e.g., watertight) and an interior surface 1366 that defines a lumen 1367. The lumen 1367 of the final feedwater conduit 1360 contains a first portion 1340a of the final feedwater protrusion 1340 and a second portion 1340b of the final feedwater protrusion 1340 extends beyond the distal end 1364 of the final feedwater conduit 1360. For example, the lumen 1367 of each of the one or more final feedwater conduits 1360 contains a first portion 1340a of each of the one or more final feedwater protrusion 1340, and a second portion 1340b of each of the one or more final feedwater protrusions 1340 extends beyond the distal end 1364 of each of the one or more final feedwater conduit 1360.

The final distillate conduit 1370 (e.g., each of the one or more final distillate conduits 1370) extends from the perimeter 116 of the system from a proximal end 1372 to a distal end 1374. The final distillate conduit 1370 (e.g., each of the one or more final distillate conduits 1370) has an exterior surface 1375 that is substantially impermeable (e.g., watertight) and an interior surface 1376 that defines a lumen 1377. The lumen 1377 of the final distillate conduit 1370 contains a first portion 1350a of the final distillate protrusion 1350 and a second portion 1350b of the final distillate protrusion 1350 extends beyond the distal end 1374 of the final distillate conduit 1370. For example, the lumen 1377 of each of the one or more final distillate conduits 1370 contains a first portion 1350a of each of the one or more final distillate protrusions 1350, and a second portion 1350b of each of the one or more final distillate protrusions 1350 extends beyond the distal end 1374 of each of the one or more final distillate conduits 1370.

In some examples, the second portion 1240b of each of the one or more additional feedwater protrusions 1240 is fluidly connected to the first portion 1240a. The second portion 1240b of each of the one or more additional feedwater protrusions 1240 can be fluidly connected to the first portion 1240a using any suitable means, such as those known in the art. For example, the second portion 1240b of each of the one or more additional feedwater protrusions 1240 can be fluidly connected to the first portion 1240a using an adhesive, solvent welding, heat, pressure, etc., or a combination thereof. In some examples, the second portion 1240b of each of the one or more additional feedwater protrusions 1240 can be removably attached to the first portion 1240a, for example such that the second portion 1240b can be removed and replaced. For example, the second portion 1240b of each of the one or more additional feedwater protrusions 1240 can be interchangeable.

In some examples, the second portion 1240b of each of the one or more additional feedwater protrusions 1240 can further comprise one or more treatment components, e.g., one or more treatment components can be impregnated in the second portion 1240b of each of the one or more additional feedwater protrusions 1240. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 1250b of each of the one of the one or more additional distillate protrusions 1250 is fluidly connected to the first portion 1250a. The second portion 1250b of each of the one of the one or more additional distillate protrusions 1250 can be fluidly connected to the first portion 1250a using any suitable means, such as those known in the art. For example, the second portion 1250b of each of the one of the one or more additional distillate protrusions 1250 can be fluidly connected to the first portion 1250a using an adhesive, solvent welding, heat, pressure, etc., or a combination thereof. In some examples, the second portion 1250b of each of the one of the one or more additional distillate protrusions 1250 can be removable attached to the first portion 1250a, for example such that the second portion 1250b can be removed and replaced. For example, the second portion 1250b of each of the one of the one or more additional distillate protrusions 1250 can be interchangeable.

In some examples, the second portion 1250b of each of the one of the one or more additional distillate protrusions 1250 can further comprise one or more treatment components, e.g., one or more treatment components can be impregnated in the second portion 1250b of each of the one of the one or more additional distillate protrusions 1250. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 1340b of the one or more final feedwater protrusions 1340 is fluidly connected to the first portion 1340a. The second portion 1340b of the one or more final feedwater protrusions 1340 can be fluidly connected to the first portion 1340a using any suitable means, such as those known in the art. For example, the second portion 1340b of the one or more final feedwater protrusions 1340 can be fluidly connected to the first portion 1340a using an adhesive, solvent welding, heat, pressure, etc., or a combination thereof. In some examples, the second portion 1340b of the one or more final feedwater protrusions 1340 can be removably attached to the first portion 1340a, for example such that the second portion 1340b can be removed and replaced. For example, the second portion 1340b of the one or more final feedwater protrusions 1340 can be interchangeable.

In some examples, the second portion 1340b of the one or more final feedwater protrusions 1340 can further comprise one or more treatment components, e.g., one or more treatment components can be impregnated in the second portion 1340b of the one or more final feedwater protrusions 1340. The one or more treatment components can, for example, be selected to treat the contaminated aqueous solution and/or reduce or prevent biofouling or organic fouling (e.g., reduce or prevent biofilm or organic fouling layer formation) The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 1350b of the final distillate protrusion 1350 is fluidly connected to the first portion 1350a. The second portion 1350b of the final distillate protrusion 1350 can be fluidly connected to the first portion 1350a using any suitable means, such as those known in the art. For example, the second portion 1350b of the final distillate protrusion 1350 can be fluidly connected to the first portion 1350a using an adhesive, solvent welding, heat, pressure, etc., or a combination thereof. In some examples, the second portion 1350b of the final distillate protrusion 1350 can be removably attached to the first portion 1350a, for example such that the second portion 1350b can be removed and replaced. For example, the second portion 1350b of the final distillate protrusion 1350 can be interchangeable.

In some examples, the second portion 1350b of the final distillate protrusion 1350 can further comprise one or more treatment components, e.g., one or more treatment components can be impregnated in the second portion 1350b of the final distillate protrusion 1350. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, each of the feedwater layers of the system can further comprise an outflow protrusion (e.g. one or more outflow protrusions), wherein the outflow protrusion (e.g., each of the one or more outflow protrusions) extends from a portion of the edge of said feedwater layer from a proximal end to a distal end opposite and spaced apart from the proximal end, the outflow protrusion (e.g., each of the one or more outflow protrusions) being fluidly connected to the feedwater layer from which it extends. In some examples, at least a portion of the outflow protrusion (e.g., at least a portion of each of the one or more outflow protrusions) is integrally formed with the feedwater layer from which it extends.

In certain examples, the system further comprises an outflow conduit (e.g. one or more outflow conduits), wherein the perimeter of the system is perforated by the outflow conduit (e.g., each of the one or more outflow conduits). The outflow conduit (e.g., each of the one or more outflow conduits) extends from the perimeter of the system from a proximal end to a distal end. The outflow conduit (e.g., each of the one or more outflow conduits) has an exterior surface that is substantially impermeable (e.g., watertight) and an interior surface that defines a lumen. The lumen of the outflow conduit contains a first portion of the outflow protrusion and a second portion of the outflow protrusion extends beyond the distal end of the outflow conduit. For example, the lumen of each of the one or more outflow conduits contains a first portion of each of the one or more outflow protrusions, and a second portion of each of the one or more outflow protrusions extends beyond the distal end of each of the one or more outflow conduits.

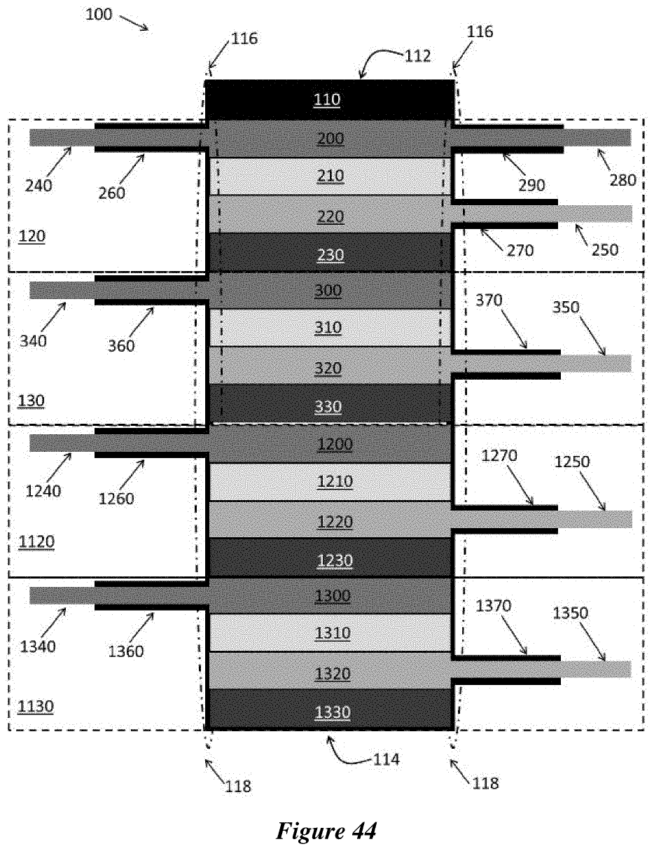

For example, referring now to FIG. 44, the first feedwater layer 200 can further comprise a first outflow protrusion 280 (e.g., one or more first outflow protrusions 280), the first outflow protrusion 280 (e.g., each of the one or more first outflow protrusions 280) extends from a portion of the edge of the first feedwater layer 200 from a proximal end to a distal end opposite and spaced apart from the proximal end, the first outflow protrusion 280 (e.g., each of the one or more first outflow protrusions 280) being fluidly connected to the first feedwater layer 200 from which it extends. In some examples, at least a portion of the first outflow protrusion 280 (e.g., at least a portion of each of the one or more first outflow protrusions 280) is integrally formed with the first feedwater layer 280 from which it extends.

In certain examples, the system further comprises an outflow conduit 290 (e.g. one or more outflow conduits 290), wherein the perimeter 116 of the system is perforated by the outflow conduit 290 (e.g., each of the one or more outflow conduits 290). The outflow conduit 290 (e.g., each of the one or more outflow conduits 290) extends from the perimeter 116 of the system from a proximal end to a distal end. The outflow conduit 290 (e.g., each of the one or more outflow conduits 290) has an exterior surface that is substantially impermeable (e.g., watertight) and an interior surface that defines a lumen. The lumen of the outflow conduit 290 contains a first portion of the outflow protrusion 280 and a second portion of the outflow protrusion 280 extends beyond the distal end of the outflow conduit 290. For example, the lumen of each of the one or more outflow conduits 290 contains a first portion of each of the one or more outflow protrusions 280, and a second portion of each of the one or more outflow protrusions 280 extends beyond the distal end of each of the one or more outflow conduits 290.

For example, the system can be configured such that there is a driving force to produce update of a liquid and/or solution by the feedwater protrusion(s), from the feedwater protrusion(s) across the feedwater layer to the outflow protrusion(s), and out the outflow protrusion(s). The driving force can, for example, be gravity based (e.g., the feedwater protrusion(s) are elevated above the outflow protrusions(s)), capillary based (e.g., increasing capillary force from the feedwater protrusions(s) to the outlet protrusion(s), etc.

The system 100 further comprises: a top surface 112; a bottom surface 114 opposite and spaced apart from the top surface 112; a perimeter 116 defined by an edge 118. In some examples, the top surface 112 and the bottom surface 114 of are substantially parallel to each other.

In some examples, the top surface 112 and the perimeter 116 of the system 100 are each substantially impermeable (e.g., to ions, solutions, and/or liquids). In some examples, the top surface 112 and the perimeter 116 of the system 100 are each substantially watertight. In some examples, the top surface 112 comprises the solar absorber layer 110.

In some examples, the bottom surface 114 is substantially impermeable (e.g., to ions, solutions, and/or liquids). In some examples, the bottom surface 114 is substantially watertight. In certain examples, the bottom surface 114 of the system comprises the final thermally conductive layer 1330.

In some examples, the system further comprises a terminal feedwater layer 600, wherein the final stage 1130 is stacked on top of the terminal feedwater layer 600, such that the final thermally conductive layer 1330 is disposed on top of an in physical and thermal contact with the terminal feedwater layer 600. In some examples, the bottom surface 114 comprises the terminal feedwater layer 600.

The terminal feedwater layer 600 has a top surface 602, a bottom surface 604 opposite and spaced apart from the top surface 602, and a perimeter 606 defined by an edge 608. In some examples, the top surface and the bottom surface of the terminal feedwater layer are substantially parallel to each other. The layer can have an average thickness, the average thickness being the average dimension from the top surface to the bottom surface.

The top surface 602 and the bottom surface 604 of the terminal feedwater layer 600 can, independently, be any shape. In some examples, the top surface 602 and the bottom surface 604 of the terminal feedwater layer 600 can, independently, be substantially circular, ovate, ovoid, elliptic, triangular, rectangular, polygonal, etc. In some examples, the top surface 602 and the bottom surface 604 of the terminal feedwater layer 600 can be substantially the same shape. In some examples, the top surface 602 and the bottom surface 604 of the terminal feedwater layer 600 can be substantially rectangular.

In some examples, the terminal feedwater layer 600 can further comprise an terminal feedwater protrusion 640 (e.g., one or more terminal feedwater protrusions 640), wherein the terminal feedwater protrusion 640 (e.g., each of the one or more terminal feedwater protrusions 640) extends from a portion of the edge 608 of the terminal feedwater layer 600 from a proximal end 642 to a distal end 644 opposite and spaced apart from the proximal end 642, the terminal feedwater protrusion 640 (e.g., each of the one or more terminal feedwater protrusions 640) being fluidly connected to the terminal feedwater layer 600 from which it extends. In some examples, at least a portion of the terminal feedwater protrusion 640 (e.g., at least a portion of each of the one or more terminal feedwater protrusions 640) is integrally formed with the terminal feedwater layer 600 from which it extends.

The system 100 is configured to be flexible. For example, the system 100 is flexible such that the system 100 can be rolled and/or folded when being stored (e.g., to be more spatially compact) and then unrolled and/or unfolded when deployed. In some examples, the system 100 is further configured to be lightweight, such that the system can be easily transported.

In some examples, the system 100 is configured to be deployed in reservoir 400 containing a contaminated aqueous solution 410, the contaminated aqueous solution 410 having a surface 412.

In some examples, the system is configured to be deployed on land or on a vehicle, wherein the system is deployed proximate a contaminated aqueous solution 410, e.g. proximate a reservoir containing a contaminated aqueous solution 410.

In some examples, the system 100 is configured to be buoyant, such that the system 100 floats in the contaminated aqueous solution 410 when deployed therein, such that at least the solar absorber layer 110 is disposed above the surface 412 of the contaminated aqueous solution 410.

In some examples, the system 100 further comprises a buoyant frame 700 that is configured to be coupled to the system 100 and/or the receptacle 500 such that the system 100 and/or the receptacle 500 is buoyant. In some examples, the buoyant frame 700 comprises external floats or buoys coupled to a frame, said frame itself being buoyant or non-buoyant.

In certain examples, at least a portion of the system 100 is disposed above the surface 412 of the contaminated aqueous solution 410. In certain examples, the system 100 is disposed above the surface 412 of the contaminated aqueous solution 410, for example such that the bottom surface 114 is disposed above the surface 412 of the contaminated aqueous solution 410, e.g. such that there is an air gap between the bottom surface 114 of the device and the surface 412 of the contaminated aqueous solution 410.

In certain examples, wherein the system 100 includes the a terminal feedwater layer 600, the system 100 is configured to be buoyant such that the terminal feedwater layer 600 is disposed above the surface 412 of the contaminated aqueous solution 410, e.g. such that there is an air gap between the bottom surface 604 of the terminal feedwater layer 600 and the surface 412 of the contaminated aqueous solution 410.

When the system is deployed, the second portion 1240b of each of the one or more additional feedwater protrusions 1240 and the second portion 1340b of the final feedwater protrusion 1340 (e.g., the second portion 1340b of each of the one or more final feedwater protrusions 1340) are each independently configured to be in contact with the contaminated aqueous solution 410. Each of the one or more additional feedwater layers 1200 is independently configured to receive a portion of the contaminated aqueous solution from its respective feedwater protrusion 1240, said portion of the contaminated aqueous solution being a feed solution. The final feedwater layer 1300 is configured to receive a final portion of the contaminated aqueous solution from the final feedwater protrusion 1340, said final portion of the contaminated aqueous solution being a final feed solution. The thermally conductive layer of a preceding stage is configured to collect the latent heat of condensation released during the formation of the condensate in said preceding stage and conduct the collected latent heat of condensation to the feedwater layer of a subsequent stage to thereby distill at least a portion of the feed solution through the membrane distillation layer of said subsequent stage, thereby producing a distillate in said distillate layer. Said distillate layer is configured to receive said distillate from said membrane distillation layer and condense the distillate to form a condensate and release a latent heat of condensation. Distilling said portion of the feed solution through the membrane distillation layer purifies said portion of the feed solution to produce a purified aqueous solution as the condensate. The distal end 1274 of each of the one or more additional distillate conduits 1270 and the distal end 1374 of the final distillate conduit 1370 (e.g., the distal end 1374 of each of the one or more final distillate conduits 1370) are each independently configured to be fluidly connected to the receptacle 500, such that the second portion 1250b of each of the one or more additional distillate protrusions 1250 and the second portion 1350b of the final distillate protrusion 1350 (e.g., the second portion 1350b of each of the one or more final distillate protrusion 1350) are each independently configured to be disposed within the receptacle 500, such that the receptacle 500 is configured to receive and collect the purified aqueous solution from each of the one or more additional distillate layers 1220 via their respective distillate protrusions 1250 and from the final distillate layer 1320 via the final distillate protrusion 1350 (e.g., via each of the one or more final distillate protrusions 1350). In some examples, the distal end 1274 of each of the one or more additional distillate conduits 1270 and the distal end 1374 of the final distillate conduit 1370 (e.g., the distal end 1374 of each of the one or more final distillate conduits 1370) are each independently configured to form a watertight and/or impermeable seal with the receptacle 500.

Systems 2100 Comprising a First Stage 2120

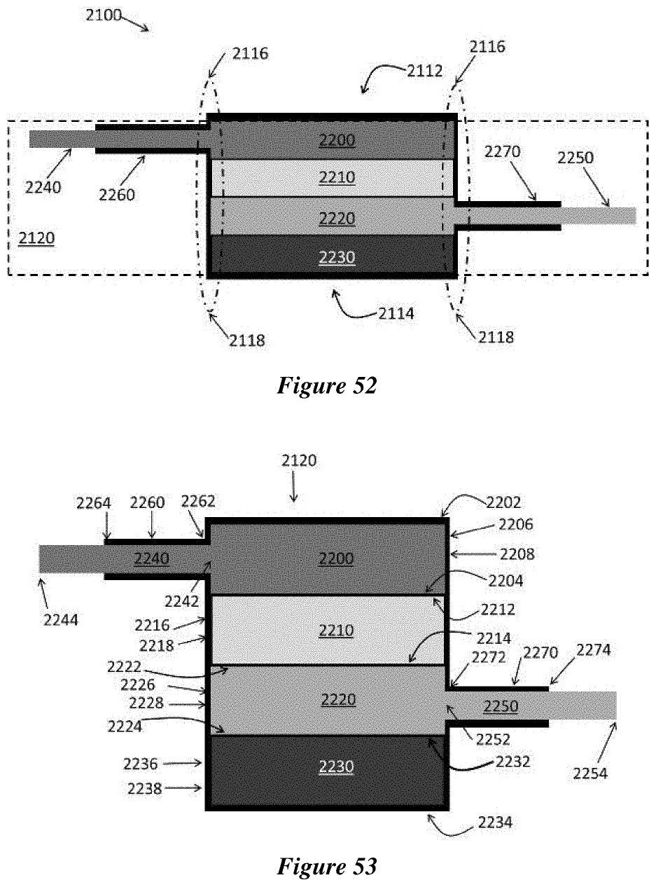

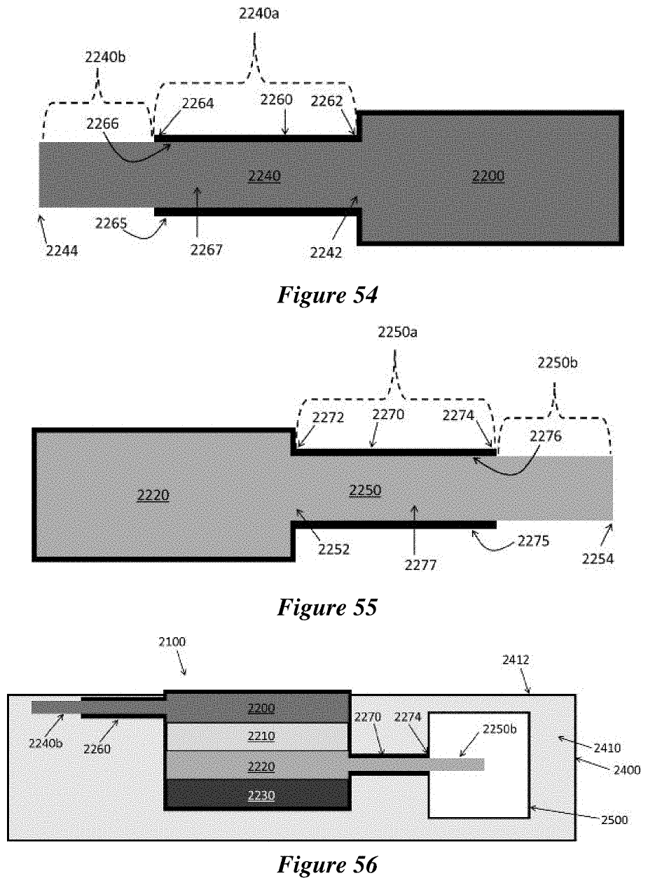

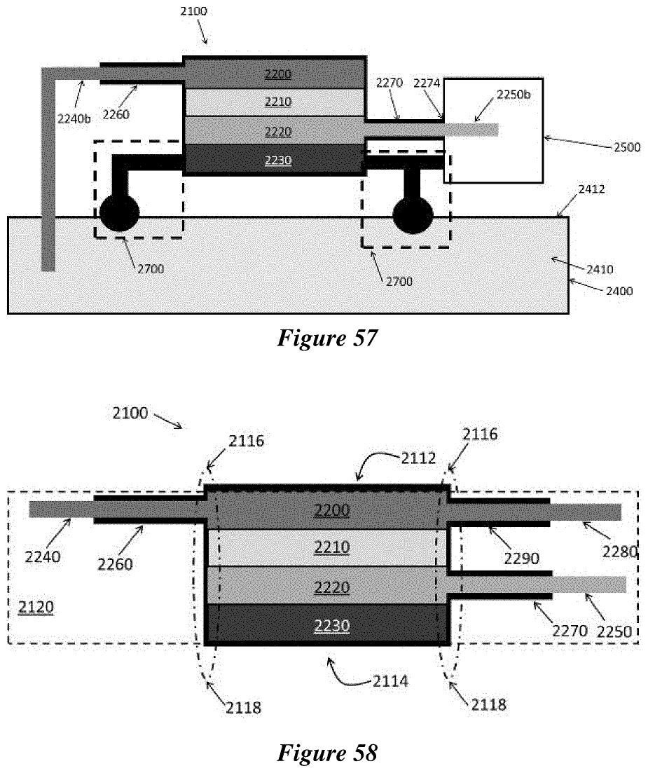

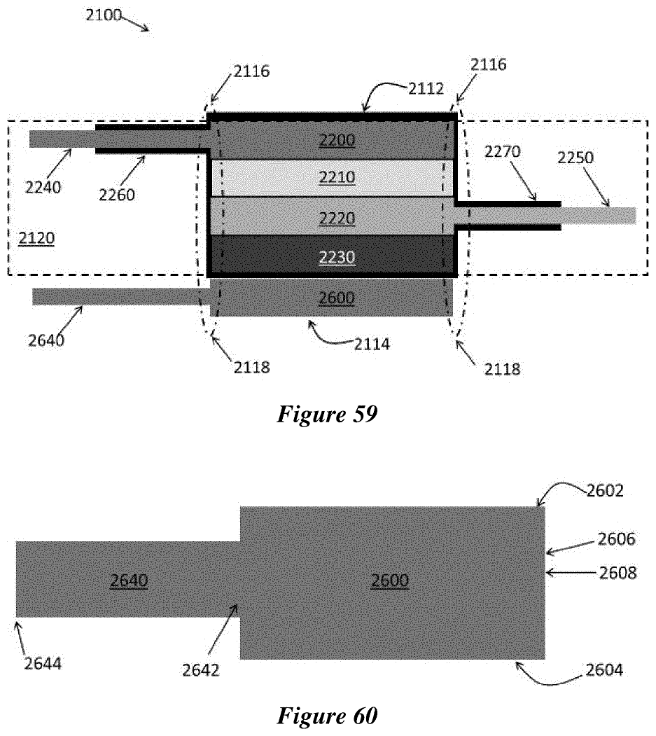

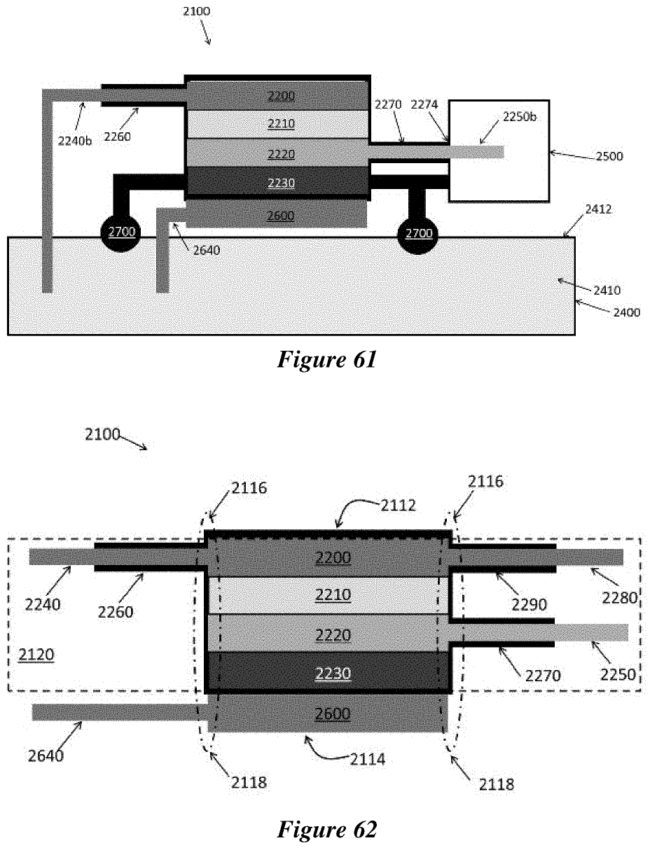

Referring now to FIG. 52-FIG. 62, disclosed herein are flexible membrane distillation systems 2100 for purifying a contaminated aqueous solution to form a purified aqueous solution for collection in a receptacle 2500; wherein the system 2100 comprises a first stage 2120.

The first stage 2120 comprises: a first feedwater layer 2200; a first membrane distillation layer 2210; a first distillate layer 2220; and a first thermally conductive layer 2230; wherein the first feedwater layer 2200 is disposed on top of and in physical and fluid contact with the first membrane distillation layer 2210; the first membrane distillation layer 2210 is disposed on top of and in physical and fluid contact with the first distillate layer 2220 (e.g., such that the first membrane distillation layer 2210 is sandwiched between the first feedwater layer 2200 and the first distillate layer 2220); and the first distillate layer 2220 is disposed on top of and in physical and thermal contact with the first thermally conductive layer 2230 (e.g., such that the first distillate layer 2220 is sandwiched between the first membrane distillation layer 2210 and the first thermally conductive layer 2230).

The first feedwater layer 2200 has a top surface 2202, a bottom surface 2204 opposite and spaced apart from the top surface 2202, and a perimeter 2206 defined by an edge 2208. In some examples, the top surface and the bottom surface of the layer are substantially parallel to each other. The layer can have an average thickness, the average thickness being the average dimension from the top surface to the bottom surface.

The top surface 2202 and the bottom surface 2204 of the first feedwater layer 2200 can, independently, be any shape. In some examples, the top surface 2202 and the bottom surface 2204 of the first feedwater layer 2200 can, independently, be substantially circular, ovate, ovoid, elliptic, triangular, rectangular, polygonal, etc. In some examples, the top surface 2202 and the bottom surface 2204 of the first feedwater layer 2200 can be substantially the same shape. In some examples, the top surface 2202 and the bottom surface 2204 of the first feedwater layer 2200 can be substantially rectangular.

The first membrane distillation layer 2210 has a top surface 2212, a bottom surface 2214 opposite and spaced apart from the top surface 2212, and a perimeter 2216 defined by an edge 2218. In some examples, the top surface 2212 and the bottom surface 2214 of the first membrane distillation layer 2210 are substantially parallel to each other. The top surface 2212 and the bottom surface 2214 of the first membrane distillation layer 2210 can, independently, be any shape. In some examples, the top surface 2212 and the bottom surface 2214 of the first membrane distillation layer 2210 can, independently, be substantially circular, ovate, ovoid, elliptic, triangular, rectangular, polygonal, etc. In some examples, the top surface 2212 and the bottom surface 2214 of the first membrane distillation layer 2210 can be substantially the same shape. In some examples, the top surface 2212 and the bottom surface 2214 of the first membrane distillation layer 2210 can be substantially rectangular.

The first distillate layer 2220 has a top surface 2222, a bottom surface 2224 opposite and spaced apart from the top surface 2222, and a perimeter 2226 defined by an edge 2228. In some examples, the top surface 2222 and the bottom surface 2224 of the first distillate layer 2220 are substantially parallel to each other. The top surface 2222 and the bottom surface 2224 of the first distillate layer 2220 can, independently, be any shape. In some examples, the top surface 2222 and the bottom surface 2224 of the first distillate layer 2220 can, independently, be substantially circular, ovate, ovoid, elliptic, triangular, rectangular, polygonal, etc. In some examples, the top surface 2222 and the bottom surface 2224 of the first distillate layer 2220 can be substantially the same shape. In some examples, the top surface 2222 and the bottom surface 2224 of the first distillate layer 2220 can be substantially rectangular.

The first thermally conductive layer 2230 has a top surface 2232, a bottom surface 2234 opposite and spaced apart from the top surface 2232, and a perimeter 236 defined by an edge 2238. In some examples, the top surface 2232 and the bottom surface 2234 of the first thermally conductive layer 2230 are substantially parallel to each other. The top surface 2232 and the bottom surface 2234 of the first thermally conductive layer 2230 can, independently, be any shape. In some examples, top surface 2232 and the bottom surface 2234 of the first thermally conductive layer 2230 can, independently, be substantially circular, ovate, ovoid, elliptic, triangular, rectangular, polygonal, etc. In some examples, the top surface 2232 and the bottom surface 2234 of the first thermally conductive layer 2230 can be substantially the same shape. In some examples, the top surface 2232 and the bottom surface 2234 of the first thermally conductive layer 2230 can be substantially rectangular.

In some examples, the first thermally conductive layer 2230 is substantially impermeable (e.g., to ions, solutions, and/or liquids). In some examples, the first thermally conductive layer 2230 is substantially watertight.

The system 2100 further comprises: a first protrusion 2240 (e.g., one or more first protrusions 240) and a second protrusion 2250 (e.g., one or more second protrusions 2250).

The first protrusion 2240 extends from a portion of the edge 2208 of the first feedwater layer 2200 from a proximal end 2242 to a distal end 2244 opposite and spaced apart from the proximal end 2242, the first protrusion 2240 being fluidly connected to the first feedwater layer 2200 from which it extends. In some examples, the system 2100 comprises a plurality of first protrusions 2240, wherein each of the plurality of first protrusions extends from a portion of the edge 2208 of the first feedwater layer 2200 from a proximal end 2242 to a distal end 2244 opposite and spaced apart from the proximal end 2242, each of the plurality of first protrusions 2240 being fluidly connected to the first feedwater layer 2200 from which it extends. In some examples, at least a portion of the first protrusion 2240 (e.g., at least the first portion 2240a) is integrally formed with the first feedwater layer 2200 from which it extends. In some examples, at least a portion of each of the plurality of first protrusions 2240 (e.g., at least the first portion 2240a) is integrally formed with the first feedwater layer 2200 from which it extends.

The second protrusion 2250 extends from a portion of the edge 2228 of the first distillate layer 2220 from a proximal end 2252 to a distal end 2254 opposite and spaced apart from the proximal end 2252, the second protrusion 2250 being fluidly connected to the first distillate layer 2220 from which it extends. In some examples, the system 2100 comprises a plurality of second protrusions 2250, wherein each of the plurality of second protrusions 2250 extends from a portion of the edge 2228 of the first distillate layer 2220 from a proximal end 2252 to a distal end 2254 opposite and spaced apart from the proximal end 2252, each of the plurality of second protrusions 2250 being fluidly connected to the first distillate layer 2220 from which it extends. In some examples, at least a portion of the second protrusion 2250 (e.g., at least the first portion 2250a) is integrally formed with the first distillate layer 2220 from which it extends. In some examples, at least a portion of each of the plurality of second protrusions 2250 (e.g., at least the first portion 2250a) is integrally formed with the first distillate layer 2220 from which it extends.

The system 2100 further comprises: a first conduit 2260 (e.g. one or more first conduits 2260) and a second conduit 2270 (e.g., one or more second conduits 2270); wherein the perimeter 2116 of the system is perforated by the first conduit 2260 (e.g., each of the one or more first conduits 2260) and the second conduit 2270 (e.g., each of the one or more second conduits 2270).

The first conduit 2260 (e.g., each of the one or more first conduits 2260) extends from the perimeter 2116 of the system from a proximal end 2262 to a distal end 2264. The first conduit 2260 (e.g., each of the one or more first conduits 2260) has an exterior surface 2265 that is substantially impermeable (e.g., watertight) and an interior surface 2266 that defines a lumen 2267. The lumen 2267 of the first conduit 2260 contains a first portion 2240a of the first protrusion 2240 and a second portion 2240b of the first protrusion 2240 extends beyond the distal end 2264 of the first conduit 2260. For example, the lumen 2267 of each of the one or more first conduits 2260 contains a first portion 2240a of each of the one or more first protrusions 2240, and a second portion 2240b of each of the one or more first protrusions 2240 extends beyond the distal end 2264 of each of the one or more first conduits 2260.

The second conduit 2270 (e.g., each of the one or more second conduits 2270) extends from the perimeter 2116 of the system from a proximal end 2272 to a distal end 2274. The second conduit 2270 (e.g., each of the one or more second conduits 2270) has an exterior surface 2275 that is substantially impermeable (e.g., watertight) and an interior surface 2276 that defines a lumen 2277. The lumen 2277 of the second conduit 2270 contains a first portion 2250a of the second protrusion 2250 and a second portion 2250b of the second protrusion 2250 extends beyond the distal end 2274 of the second conduit 2270. For example, the lumen 2277 of each of the one or more second conduits 2270 contains a first portion 2250a of each of the one or more second protrusions 2250, and a second portion 2250b of each of the one or more second protrusions 2250 extends beyond the distal end 2274 of each of the one or more second conduits 2270.

In some examples, the second portion 2240b of each of the one or more first protrusions 2240 is fluidly connected to the first portion 2240a. The second portion 2240b of each of the one or more first protrusions 2240 can be fluidly connected to the first portion 2240a using any suitable means, such as those known in the art. For example, the second portion 2240b of each of the one or more first protrusions 2240 can be fluidly connected to the first portion 2240a using an adhesive, solvent welding, heat, pressure, etc., or a combination thereof. In some examples, the second portion 2240b of each of the one or more first protrusions 2240 is removably attached to the first portion 2240a, for example such that the second portion 2240b can be removed and replaced. For example, the second portion 2240b of each of the one or more first protrusions 2240 can be interchangeable.

In some examples, the second portion 2240b of each of the one or more first protrusions 2240 can further comprise one or more treatment components, e.g. one or more treatment components can be impregnated in the second portion 2240b of each of the one or more first protrusions 2240. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 2250b of each of the one or more second protrusions 2250 is fluidly connected to the first portion 2250a. The second portion 2250b of each of the one or more second protrusions 2250 can be fluidly connected to the first portion 2250a using any suitable means, such as those known in the art. For example, the second portion 2250b of each of the one or more second protrusions 2250 can be fluidly connected to the first portion 2250a using an adhesive, solvent welding, heat, pressure, etc., or a combination thereof. In some examples, the second portion 2250b of each of the one or more second protrusions 2250 can be removably attached to the first portion 2250a, for example such that the second portion 2250b can be removed and replaced. For example, the second portion 2250b of each of the one or more second protrusions 2250 can be interchangeable.

In some examples, the second portion 2250b of each of the one or more second protrusions 2250 can further comprise one or more treatment components, e.g. one or more treatment components can be impregnated in the second portion 2250b of each of the one or more second protrusions 2250. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, referring now to FIG. 58, the first feedwater layer 2200 can further comprise a first outflow protrusion 2280 (e.g., one or more first outflow protrusions 2280), the first outflow protrusion 2280 (e.g., each of the one or more first outflow protrusions 2280) extends from a portion of the edge of the first feedwater layer 2200 from a proximal end to a distal end opposite and spaced apart from the proximal end, the first outflow protrusion 2280 (e.g., each of the one or more first outflow protrusions 2280) being fluidly connected to the first feedwater layer 2200 from which it extends. In some examples, at least a portion of the first outflow protrusion 2280 (e.g., at least a portion of each of the one or more first outflow protrusions 2280) is integrally formed with the first feedwater layer 2280 from which it extends.

In certain examples, the system further comprises an outflow conduit 2290 (e.g. one or more outflow conduits 2290), wherein the perimeter 2116 of the system is perforated by the outflow conduit 2290 (e.g., each of the one or more outflow conduits 2290). The outflow conduit 2290 (e.g., each of the one or more outflow conduits 2290) extends from the perimeter 2116 of the system from a proximal end to a distal end. The outflow conduit 2290 (e.g., each of the one or more outflow conduits 2290) has an exterior surface that is substantially impermeable (e.g., watertight) and an interior surface that defines a lumen. The lumen of the outflow conduit 2290 contains a first portion of the outflow protrusion 2280 and a second portion of the outflow protrusion 2280 extends beyond the distal end of the outflow conduit 2290. For example, the lumen of each of the one or more outflow conduits 2290 contains a first portion of each of the one or more outflow protrusions 2280, and a second portion of each of the one or more outflow protrusions 2280 extends beyond the distal end of each of the one or more outflow conduits 2290.

For example, the system can be configured such that there is a driving force to produce update of a liquid and/or solution by the feedwater protrusion(s), from the feedwater protrusion(s) across the feedwater layer to the outflow protrusion(s), and out the outflow protrusion(s). The driving force can, for example, be gravity based (e.g., the feedwater protrusion(s) are elevated above the outflow protrusions(s)), capillary based (e.g., increasing capillary force from the feedwater protrusions(s) to the outlet protrusion(s), etc.

The system 2100 further comprises: a top surface 2112; a bottom surface 2114 opposite and spaced apart from the top surface 2112; a perimeter 2116 defined by an edge 2118. In some examples, the top surface 2112 and the bottom surface 2114 of are substantially parallel to each other.

In some examples, the top surface 2112 and the perimeter 2116 of the system 2100 are each substantially impermeable (e.g., to ions, solutions, and/or liquids). In some examples, the top surface 2112 and the perimeter 2116 of the system 2100 are each substantially watertight.

In some examples, the bottom surface 2114 is substantially impermeable (e.g., to ions, solutions, and/or liquids). In some examples, the bottom surface 2114 is substantially watertight. In some examples, the bottom surface 2114 comprises the first thermally conductive layer 2230 (e.g., as shown in FIG. 52).

In some examples, the system further comprises a terminal feedwater layer 2600, wherein the first stage 2120 is stacked on top of the terminal feedwater layer 2600, such that the first thermally conductive layer 2230 is disposed on top of an in physical and thermal contact with the terminal feedwater layer 2600. In some examples, the bottom surface 2114 comprises the terminal feedwater layer 2600.

The terminal feedwater layer 2600 has a top surface 2602, a bottom surface 2604 opposite and spaced apart from the top surface 2602, and a perimeter 2606 defined by an edge 2608. In some examples, the top surface and the bottom surface of the terminal feedwater layer are substantially parallel to each other. The layer can have an average thickness, the average thickness being the average dimension from the top surface to the bottom surface.

The top surface 2602 and the bottom surface 2604 of the terminal feedwater layer 2600 can, independently, be any shape. In some examples, the top surface 2602 and the bottom surface 2604 of the terminal feedwater layer 2600 can, independently, be substantially circular, ovate, ovoid, elliptic, triangular, rectangular, polygonal, etc. In some examples, the top surface 2602 and the bottom surface 2604 of the terminal feedwater layer 2600 can be substantially the same shape. In some examples, the top surface 2602 and the bottom surface 2604 of the terminal feedwater layer 2600 can be substantially rectangular.

In some examples, the terminal feedwater layer 2600 can further comprise an terminal feedwater protrusion 2640 (e.g., one or more terminal feedwater protrusions 2640), wherein the terminal feedwater protrusion 2640 (e.g., each of the one or more terminal feedwater protrusions 2640) extends from a portion of the edge 2608 of the terminal feedwater layer 2600 from a proximal end 2642 to a distal end 2644 opposite and spaced apart from the proximal end 2642, the terminal feedwater protrusion 2640 (e.g., each of the one or more terminal feedwater protrusions 2640) being fluidly connected to the terminal feedwater layer 2600 from which it extends. In some examples, at least a portion of the terminal feedwater protrusion 2640 (e.g., at least a portion of each of the one or more terminal feedwater protrusions 2640) is integrally formed with the terminal feedwater layer 2600 from which it extends.

The system 2100 is configured to be flexible. For example, the system 2100 is flexible such that the system 2100 can be rolled and/or folded when being stored (e.g., to be more spatially compact) and then unrolled and/or unfolded when deployed. In some examples, the system 2100 is further configured to be lightweight, such that the system can be easily transported.

In some examples, the system 2100 is configured to be deployed in reservoir 2400 containing a contaminated aqueous solution 2410, the contaminated aqueous solution 2410 having a surface 2412.

In some examples, the system is configured to be deployed on land or on a vehicle, wherein the system is deployed proximate a contaminated aqueous solution 2410, e.g. proximate a reservoir containing a contaminated aqueous solution 2410.

In some examples, the system 2100 is configured to be buoyant, such that the system 2100 floats in the contaminated aqueous solution 2410 when deployed therein.

In some examples, the system 2100 further comprises a buoyant frame 2700 that is configured to be coupled to the system 2100 and/or the receptacle 2500 such that the system 2100 and/or the receptacle 2500 is buoyant. In some examples, the buoyant frame 2700 comprises external floats or buoys coupled to a frame, said frame itself being buoyant or non-buoyant.

In certain examples, at least a portion of the system 2100 is disposed above the surface 2412 of the contaminated aqueous solution 2410. In certain examples, the system 2100 is disposed above the surface 2412 of the contaminated aqueous solution 2410, for example such that the bottom surface 2114 is disposed above the surface 2412 of the contaminated aqueous solution 2410, e.g. such that there is an air gap between the bottom surface 2114 of the device and the surface 2412 of the contaminated aqueous solution 2410.

In certain examples, wherein the system 2100 includes the a terminal feedwater layer 2600, the system 2100 is configured to be buoyant such that the terminal feedwater layer 2600 is disposed above the surface 2412 of the contaminated aqueous solution 2410, e.g. such that there is an air gap between the bottom surface 2604 of the terminal feedwater layer 2600 and the surface 2412 of the contaminated aqueous solution 2410.

When the system 2100 is deployed, the second portion 2240b of the first protrusion 2240 (e.g., the second portion 2240b of each of the one or more first protrusions 2240) is configured to be in contact with the contaminated aqueous solution 2410. The first feedwater layer 2200 is configured to receive a first portion of the contaminated aqueous solution from the first protrusion 2240, said first portion of the contaminated aqueous solution being a first feed solution. In some examples, the first feedwater layer 2200 further comprises a solar absorber material, the system is coupled to an external heat source (e.g., a hot contaminated aqueous source, a heat exchanger, a heater, etc.), or a combination thereof. The system 2100 is configured to conduct the heat provided by the external heat source and/or heat collected by the solar absorber material to the first feedwater layer 2200 to thereby distill at least a portion of the first feed solution through the first membrane distillation layer 2210, thereby producing a first distillate in the first distillate layer 2220. The first distillate layer 2220 is configured to receive the first distillate from the first membrane distillation layer 2210 and condense the first distillate to form a first condensate and release a first latent heat of condensation. Distilling said portion of the first feed solution through the first membrane distillation layer 2210 purifies said portion of the first feed solution to produce a first purified aqueous solution as the first condensate. The first thermally conductive layer 2230 is configured to collect the first latent heat of condensation and conduct the collected first latent heat away from the system. The distal end 2274 of the second conduit 2270 (e.g., the distal end of each of the one or more second conduits 2270) is configured to be fluidly connected to the receptacle 2500, such that the second portion 2250b of the second protrusion 2250 (e.g., the second portion 2250b of each of the one or more second protrusions 2250) is configured to be disposed within the receptacle 2500, such that the receptacle 2500 is configured to receive and collect the first purified aqueous solution from the first distillate layer 2220 via the second protrusion 2250 (e.g., via each of the one or more second protrusions 2250). In some examples, the distal end 2274 of the second conduit 2270 (e.g., the distal end of each of the one or more second conduits 2270) forms a watertight and/or an impermeable seal with the receptacle 2500.

Systems 2100 Further Comprising a Second Stage 2130

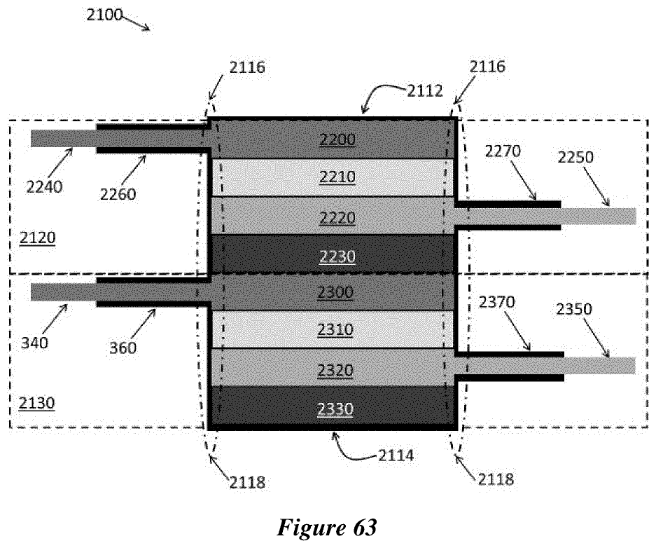

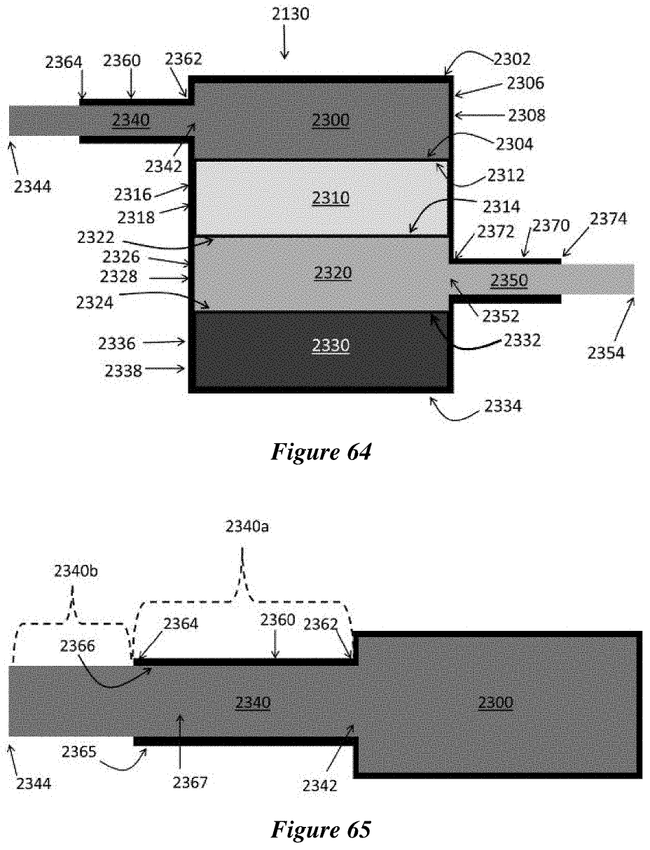

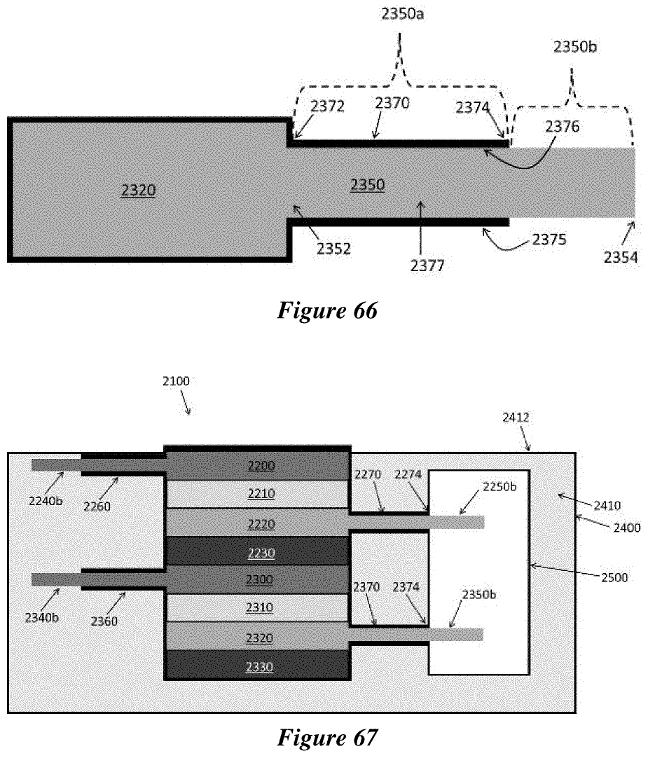

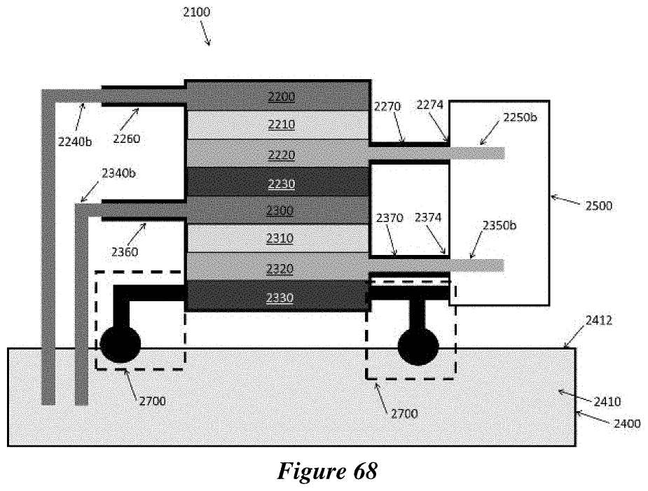

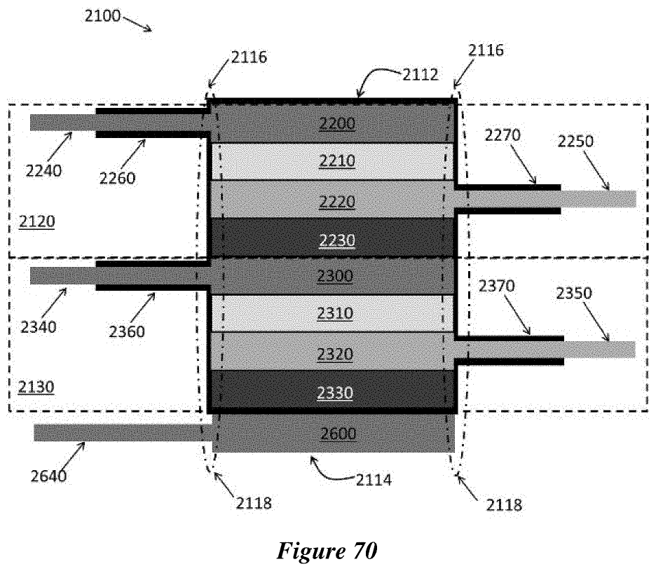

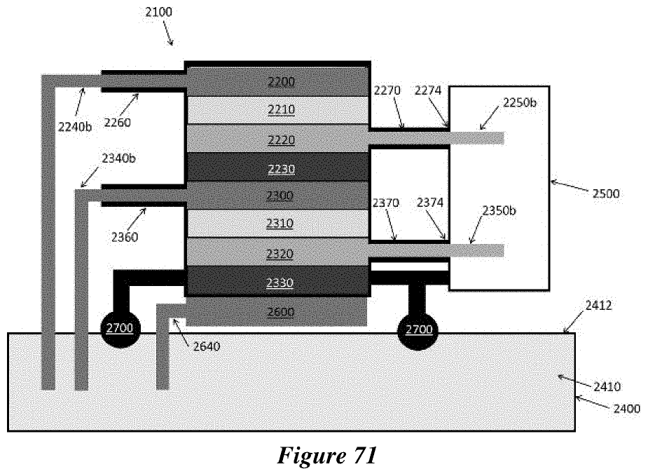

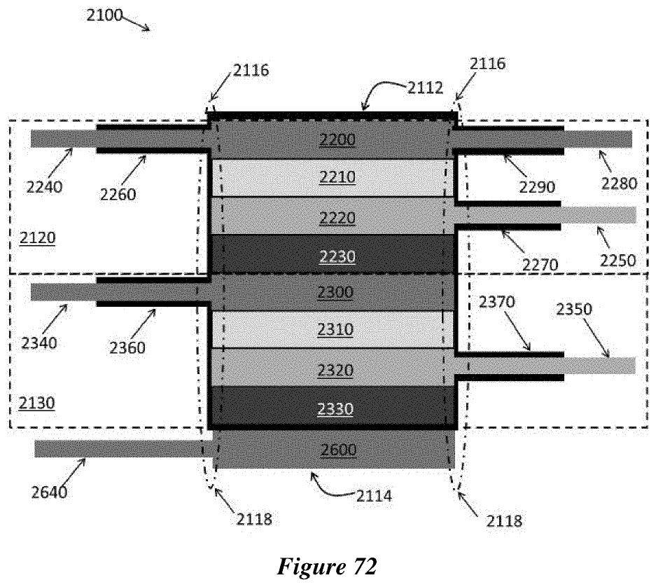

Referring now to FIG. 63-FIG. 72, in some examples the system 2100 further comprises a second stage 2130. The second stage 2130 comprises: a second feedwater layer 2300; a second membrane distillation layer 2310; a second distillate layer 2320; and a second thermally conductive layer 2330; wherein the second feedwater layer 2300 is disposed on top of and in physical and fluid contact with the second membrane distillation layer 2310; the second membrane distillation layer 2310 is disposed on top of and in physical and fluid contact with the second distillate layer 2320 (e.g., such that the second membrane distillation layer 2310 is sandwiched between the second feedwater layer 2300 and the second distillate layer 2320); and the second distillate layer 2320 is disposed on top of and in physical and thermal contact with the second thermally conductive layer 2330 (e.g., such that the second distillate layer 2320 is sandwiched between the second membrane distillation layer 2310 and the second thermally conductive layer 2330). In the system 2100, the first stage 2120 is stacked on top of the second stage 2130, such that the first thermally conductive layer 2230 is disposed on top of and in physical and thermal contact with the second feedwater layer 2300.

The second feedwater layer 2300 has a top surface 2302, a bottom surface 2304 opposite and spaced apart from the top surface 2302, and a perimeter 2306 defined by an edge 2308. In some examples, the top surface 2302 and the bottom surface 2304 of the second feedwater layer 2300 are substantially parallel to each other. The top surface 2302 and the bottom surface 2304 of the second feedwater layer 2300 can, independently, be any shape. In some examples, the top surface 2302 and the bottom surface 2304 of the second feedwater layer 2300 can, independently, be substantially circular, ovate, ovoid, elliptic, triangular, rectangular, polygonal, etc. In some examples, the top surface 2302 and the bottom surface 2304 of the second feedwater layer 2300 can be substantially the same shape. In some examples, the top surface 2302 and the bottom surface 2304 of the second feedwater layer 2300 can be substantially rectangular.

The second membrane distillation layer 2310 has a top surface 2312, a bottom surface 2314 opposite and spaced apart from the top surface 2312, and a perimeter 2316 defined by an edge 2318. In some examples, the top surface 2312 and the bottom surface 2314 of the second membrane distillation layer 2310 are substantially parallel to each other. The top surface 2312 and the bottom surface 2314 of the second membrane distillation layer 2310 can, independently, be any shape. In some examples, the top surface 2312 and the bottom surface 2314 of the second membrane distillation layer 2310 can, independently, be substantially circular, ovate, ovoid, elliptic, triangular, rectangular, polygonal, etc. In some examples, the top surface 2312 and the bottom surface 2314 of the second membrane distillation layer 2310 can be substantially the same shape. In some examples, the top surface 2312 and the bottom surface 2314 of the second membrane distillation layer 2310 can be substantially rectangular.

The second distillate layer 2320 has a top surface 2322, a bottom surface 2324 opposite and spaced apart from the top surface 2322, and a perimeter 2326 defined by an edge 2328. In some examples, the top surface 2322 and the bottom surface 2324 of the second distillate layer 2320 are substantially parallel to each other. The top surface 2322 and the bottom surface 2324 of the second distillate layer 2320 can, independently, be any shape. In some examples, the top surface 2322 and the bottom surface 2324 of the second distillate layer 2320 can, independently, be substantially circular, ovate, ovoid, elliptic, triangular, rectangular, polygonal, etc. In some examples, top surface 2322 and the bottom surface 2324 of the second distillate layer 2320 can be substantially the same shape. In some examples, the top surface 2322 and the bottom surface 2324 of the second distillate layer 2320 can be substantially rectangular.

The second thermally conductive layer 2330 has a top surface 2332, a bottom surface 2334 opposite and spaced apart from the top surface 2332, and a perimeter 2336 defined by an edge 2338. In some examples, the top surface 2332 and the bottom surface 2334 of the second thermally conductive layer 2330 are substantially parallel to each other. The top surface 2332 and the bottom surface 2334 of the second thermally conductive layer 2330 can, independently, be any shape. In some examples, the top surface 2332 and the bottom surface 2334 of the second thermally conductive layer 2330 can, independently, be substantially circular, ovate, ovoid, elliptic, triangular, rectangular, polygonal, etc. In some examples, the top surface 2332 and the bottom surface 2334 of the second thermally conductive layer 2330 can be substantially the same shape. In some examples, the top surface 2332 and the bottom surface 2334 of the second thermally conductive layer 2330 can be substantially rectangular.

In some examples, the second thermally conductive layer 2330 is substantially impermeable (e.g., to ions, solutions, and/or liquids). In some examples, the second thermally conductive layer 2330 is substantially watertight.

In certain examples, the system 2100 further comprises a third protrusion 2340 (e.g., one or more third protrusions 2340); and a fourth protrusion 2350 (e.g., one or more fourth protrusions 2350).

The third protrusion 2340 extends from a portion of the edge 2308 of the second feedwater layer 2300 from a proximal end 2342 to a distal end 2344 opposite and spaced apart from the proximal end 2342, the third protrusion 2340 being fluidly connected to the second feedwater layer 2300 from which it extends. In some examples, the system 2100 comprises a plurality of third protrusions 2340, wherein each of the plurality of third protrusions 2340 extends from a portion of the edge 2308 of the second feedwater layer 2300 from a proximal end 2342 to a distal end 2344 opposite and spaced apart from the proximal end 2342, each of the plurality of third protrusions 2340 being fluidly connected to the second feedwater layer 2300 from which it extends. In some examples, at least a portion of the third protrusion 2340 (e.g., at least the first portion 2340a) is integrally formed with the second feedwater layer 2300 from which it extends. In some examples, at least a portion of each of the plurality of third protrusions 2340 (e.g., at least the first portion 2340a) is integrally formed with the second feedwater layer 2300 from which it extends.

The fourth protrusion 2350 extends from a portion of the edge 2328 of the second distillate layer 2320 from a proximal end 2352 to a distal 2354 end opposite and spaced apart from the proximal end 2352, the fourth protrusion 2350 being fluidly connected to the second distillate layer 2320 from which it extends. In some examples, the system 2100 comprises a plurality of fourth protrusions 2350, wherein each of the plurality of fourth protrusions 2350 extends from a portion of the edge 2328 of the second distillate layer 2320 from a proximal end 2352 to a distal 2354 end opposite and spaced apart from the proximal end 2352, each of the plurality of fourth protrusions 2350 being fluidly connected to the second distillate layer 2320 from which it extends. In some examples, at least a portion of the fourth protrusion 2350 (e.g., at least the first portion 2350a) is integrally formed with the second distillate layer 2320 from which it extends. In some examples, at least a portion of each of the plurality of fourth protrusions 2350 (e.g., at least the first portion 2350a) is integrally formed with the second distillate layer 320 from which it extends.

In some examples, the system 2100 further comprises: a third conduit 2360 (e.g., one or more third conduits 2360); and a fourth conduit 2370 (e.g., one or more fourth conduits 2370); wherein the perimeter 2116 of the system is perforated by the third conduit 2360 (e.g., each of the one or more third conduits 2360), and the fourth conduit 2370 (e.g., each of the one or more fourth conduits 2370).

The third conduit 2360 (e.g., each of the one or more third conduits) extends from the perimeter 2116 of the system from a proximal end 2362 to a distal end 2364. The third conduit 2360 (e.g., each of the one or more third conduits 2360) has an exterior surface 2365 that is substantially impermeable (e.g., watertight) and an interior surface 2366 that defines a lumen 2367. The lumen 2367 of the third conduit 2360 contains a first portion 2340a of the third protrusion 2340 and a second portion 2340b of the third protrusion 2340 extends beyond the distal end 2364 of the third conduit 2360. For example, the lumen 2367 of each of the one or more third conduits 2360 contains a first portion 2340a of each of the one or more third protrusions 2340, and a second portion 2340b of each of the one or more third protrusions 2340 extends beyond the distal end 2364 of each of the one or more third conduits 2360.

The fourth conduit 2370 (e.g., each of the one or more fourth conduits 2370) extends from the perimeter 2116 of the system from a proximal end 2372 to a distal end 2374. The fourth conduit 2370 (e.g., each of the one or more fourth conduits 2370) has an exterior surface 2375 that is substantially impermeable (e.g., watertight) and an interior surface 2376 that defines a lumen 2377. The lumen 2377 of the fourth conduit 2370 contains a first portion 2350a of the fourth protrusion 2350 and a second portion 2350b of the fourth protrusion 2350 extends beyond the distal end 2374 of the fourth conduit 2370. For example, the lumen 2377 of each of the one or more fourth conduits 2370 contains a first portion 2350a of each of the one or more fourth protrusions 2350, and a second portion 2350b of each of the one or more fourth protrusions 2350 extends beyond the distal end 2374 of each of the one or more fourth conduits 2370.

In some examples, the second portion 2340b of each of the one or more third protrusions 2340 is fluidly connected to the first portion 2340a. The second portion 2340b of each of the one or more third protrusions 2340 can be fluidly connected to the first portion 2340a using any suitable means, such as those known in the art. For example, the second portion 2340b of each of the one or more third protrusions 2340 can be fluidly connected to the first portion 2340a using an adhesive, solvent welding, heat, pressure, etc., or a combination thereof. In some examples, the second portion 2340b of each of the one or more third protrusions 2340 can be removably attached to the first portion 2340a, for example such that the second portion 2340b can be removed and replaced. For example, the second portion 2340b of each of the one or more third protrusions 2340 can be interchangeable.

In some examples, the second portion 2340b of each of the one or more third protrusions 2340 can further comprise one or more treatment components, e.g. one or more treatment components can be impregnated in the second portion 2340b of each of the one or more third protrusions 2340. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 2350b of each of the one or more fourth protrusions 2350 is fluidly connected to the first portion 2350a. The second portion 2350b of each of the one or more fourth protrusions 2350 can be fluidly connected to the first portion 2350a using any suitable means, such as those known in the art. For example, the second portion 2350b of each of the one or more fourth protrusions 2350 can be fluidly connected to the first portion 2350a using an adhesive, solvent welding, heat, pressure, etc., or a combination thereof. In some examples, the second portion 2350b of each of the one or more fourth protrusions 2350 can be removable attached to the first portion 2350a, for example such that the second portion 2350b can be removed and replaced. For example, the second portion 2350b of each of the one or more fourth protrusions 2350 can be interchangeable.

In some examples, the second portion 2350b of each of the one or more fourth protrusions 2350 can further comprise one or more treatment components, e.g. one or more treatment components can be impregnated in the second portion 2350b of each of the one or more fourth protrusions 2350. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, each of the feedwater layers of the system can further comprise an outflow protrusion (e.g. one or more outflow protrusions), wherein the outflow protrusion (e.g., each of the one or more outflow protrusions) extends from a portion of the edge of said feedwater layer from a proximal end to a distal end opposite and spaced apart from the proximal end, the outflow protrusion (e.g., each of the one or more outflow protrusions) being fluidly connected to the feedwater layer from which it extends. In some examples, at least a portion of the outflow protrusion (e.g., at least a portion of each of the one or more outflow protrusions) is integrally formed with the feedwater layer from which it extends.

In certain examples, the system further comprises an outflow conduit (e.g. one or more outflow conduits), wherein the perimeter of the system is perforated by the outflow conduit (e.g., each of the one or more outflow conduits). The outflow conduit (e.g., each of the one or more outflow conduits) extends from the perimeter of the system from a proximal end to a distal end. The outflow conduit (e.g., each of the one or more outflow conduits) has an exterior surface that is substantially impermeable (e.g., watertight) and an interior surface that defines a lumen. The lumen of the outflow conduit contains a first portion of the outflow protrusion and a second portion of the outflow protrusion extends beyond the distal end of the outflow conduit. For example, the lumen of each of the one or more outflow conduits contains a first portion of each of the one or more outflow protrusions, and a second portion of each of the one or more outflow protrusions extends beyond the distal end of each of the one or more outflow conduits.

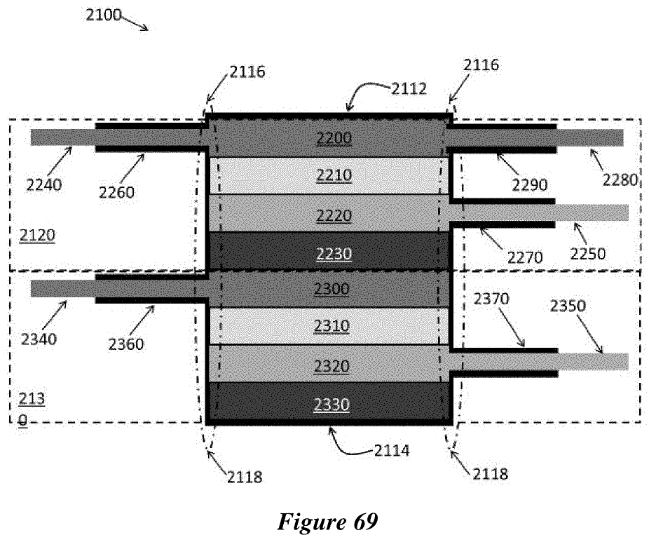

For example, referring now to FIG. 69, the first feedwater layer 2200 can further comprise a first outflow protrusion 2280 (e.g., one or more first outflow protrusions 2280), the first outflow protrusion 2280 (e.g., each of the one or more first outflow protrusions 2280) extends from a portion of the edge of the first feedwater layer 2200 from a proximal end to a distal end opposite and spaced apart from the proximal end, the first outflow protrusion 2280 (e.g., each of the one or more first outflow protrusions 2280) being fluidly connected to the first feedwater layer 2200 from which it extends. In some examples, at least a portion of the first outflow protrusion 2280 (e.g., at least a portion of each of the one or more first outflow protrusions 2280) is integrally formed with the first feedwater layer 2280 from which it extends.

In certain examples, the system further comprises an outflow conduit 2290 (e.g. one or more outflow conduits 2290), wherein the perimeter 2116 of the system is perforated by the outflow conduit 2290 (e.g., each of the one or more outflow conduits 2290). The outflow conduit 2290 (e.g., each of the one or more outflow conduits 2290) extends from the perimeter 2116 of the system from a proximal end to a distal end. The outflow conduit 2290 (e.g., each of the one or more outflow conduits 2290) has an exterior surface that is substantially impermeable (e.g., watertight) and an interior surface that defines a lumen. The lumen of the outflow conduit 2290 contains a first portion of the outflow protrusion 2280 and a second portion of the outflow protrusion 2280 extends beyond the distal end of the outflow conduit 2290. For example, the lumen of each of the one or more outflow conduits 2290 contains a first portion of each of the one or more outflow protrusions 2280, and a second portion of each of the one or more outflow protrusions 2280 extends beyond the distal end of each of the one or more outflow conduits 2290.

For example, the system can be configured such that there is a driving force to produce update of a liquid and/or solution by the feedwater protrusion(s), from the feedwater protrusion(s) across the feedwater layer to the outflow protrusion(s), and out the outflow protrusion(s). The driving force can, for example, be gravity based (e.g., the feedwater protrusion(s) are elevated above the outflow protrusions(s)), capillary based (e.g., increasing capillary force from the feedwater protrusions(s) to the outlet protrusion(s), etc.

The system 2100 further comprises: a top surface 2112; a bottom surface 2114 opposite and spaced apart from the top surface 2112; a perimeter 2116 defined by an edge 2118. In some examples, the top surface 2112 and the bottom surface 2114 of are substantially parallel to each other.

In some examples, the top surface 2112 and the perimeter 2116 of the system 2100 are each substantially impermeable (e.g., to ions, solutions, and/or liquids). In some examples, the top surface 2112 and the perimeter 2116 of the system 2100 are each substantially watertight.

In some examples, the bottom surface 2114 is substantially impermeable (e.g., to ions, solutions, and/or liquids). In some examples, the bottom surface 2114 is substantially watertight. In some examples, the bottom surface 2114 comprises the second thermally conductive layer 2330.

In some examples, the system further comprises a terminal feedwater layer 2600, wherein the second stage 2130 is stacked on top of the terminal feedwater layer 2600, such that the second thermally conductive layer 2330 is disposed on top of an in physical and thermal contact with the terminal feedwater layer 2600. In some examples, the bottom surface 2114 comprises the terminal feedwater layer 2600.

The terminal feedwater layer 2600 has a top surface 2602, a bottom surface 2604 opposite and spaced apart from the top surface 2602, and a perimeter 2606 defined by an edge 2608. In some examples, the top surface and the bottom surface of the terminal feedwater layer are substantially parallel to each other. The layer can have an average thickness, the average thickness being the average dimension from the top surface to the bottom surface.

The top surface 2602 and the bottom surface 2604 of the terminal feedwater layer 2600 can, independently, be any shape. In some examples, the top surface 2602 and the bottom surface 2604 of the terminal feedwater layer 2600 can, independently, be substantially circular, ovate, ovoid, elliptic, triangular, rectangular, polygonal, etc. In some examples, the top surface 2602 and the bottom surface 2604 of the terminal feedwater layer 2600 can be substantially the same shape. In some examples, the top surface 2602 and the bottom surface 2604 of the terminal feedwater layer 2600 can be substantially rectangular.

In some examples, the terminal feedwater layer 2600 can further comprise an terminal feedwater protrusion 2640 (e.g., one or more terminal feedwater protrusions 2640), wherein the terminal feedwater protrusion 2640 (e.g., each of the one or more terminal feedwater protrusions 2640) extends from a portion of the edge 2608 of the terminal feedwater layer 2600 from a proximal end 2642 to a distal end 2644 opposite and spaced apart from the proximal end 2642, the terminal feedwater protrusion 2640 (e.g., each of the one or more terminal feedwater protrusions 2640) being fluidly connected to the terminal feedwater layer 2600 from which it extends. In some examples, at least a portion of the terminal feedwater protrusion 2640 (e.g., at least a portion of each of the one or more terminal feedwater protrusions 2640) is integrally formed with the terminal feedwater layer 2600 from which it extends.

The system 2100 is configured to be flexible. For example, the system 2100 is flexible such that the system 2100 can be rolled and/or folded when being stored (e.g., to be more spatially compact) and then unrolled and/or unfolded when deployed. In some examples, the system 2100 is further configured to be lightweight, such that the system can be easily transported.

In some examples, the system 2100 is configured to be deployed in reservoir 2400 containing a contaminated aqueous solution 2410, the contaminated aqueous solution 2410 having a surface 2412.

In some examples, the system is configured to be deployed on land or on a vehicle, wherein the system is deployed proximate a contaminated aqueous solution 2410, e.g. proximate a reservoir containing a contaminated aqueous solution 2410.

In some examples, the system 2100 is configured to be buoyant, such that the system 2100 floats in the contaminated aqueous solution 2410 when deployed therein, such that at least the solar absorber layer 2110 is disposed above the surface 2412 of the contaminated aqueous solution 2410.

In some examples, the system 2100 further comprises a buoyant frame 2700 that is configured to be coupled to the system 2100 and/or the receptacle 2500 such that the system 2100 and/or the receptacle 2500 is buoyant. In some examples, the buoyant frame 2700 comprises external floats or buoys coupled to a frame, said frame itself being buoyant or non-buoyant.

In certain examples, at least a portion of the system 2100 is disposed above the surface 2412 of the contaminated aqueous solution 2410. In certain examples, the system 2100 is disposed above the surface 2412 of the contaminated aqueous solution 2410, for example such that the bottom surface 2114 is disposed above the surface 2412 of the contaminated aqueous solution 2410, e.g. such that there is an air gap between the bottom surface 2114 of the device and the surface 2412 of the contaminated aqueous solution 2410.

In certain examples, wherein the system 2100 includes the a terminal feedwater layer 2600, the system 2100 is configured to be buoyant such that the terminal feedwater layer 2600 is disposed above the surface 2412 of the contaminated aqueous solution 2410, e.g. such that there is an air gap between the bottom surface 2604 of the terminal feedwater layer 2600 and the surface 2412 of the contaminated aqueous solution 2410.

When the system 2100 is deployed, the second portion 2240b of the first protrusion 2240 (e.g., the second portion 2240b of each of the one or more first protrusions 2240) and the second portion 2340b of the third protrusion 2340 (e.g., the second portion 2340b of each of the one or more third protrusions) are each independently configured to be in contact with the contaminated aqueous solution 2410. The first feedwater layer 2200 is configured to receive a first portion of the contaminated aqueous solution from the first protrusion 2240, said first portion of the contaminated aqueous solution being a first feed solution. The second feedwater layer 2300 is configured to receive a second portion of the contaminated aqueous solution from the third protrusion 2340, said second portion of the contaminated aqueous solution being a second feed solution. In some examples, the first feedwater layer 2200 further comprises a solar absorber material, the system is coupled to an external heat source (e.g., a hot contaminated aqueous source, a heat exchanger, a heater, etc.), or a combination thereof. The system 2100 is configured to conduct the heat provided by the external heat source and/or heat collected by the solar absorber material to the first feedwater layer 2200 to thereby distill at least a portion of the first feed solution through the first membrane distillation layer 2210, thereby producing a first distillate in the first distillate layer 2220. The first distillate layer 2220 is configured to receive the first distillate from the first membrane distillation layer 2210 and condense the first distillate to form a first condensate and release a first latent heat of condensation. Distilling said portion of the first feed solution through the first membrane distillation layer 2210 purifies said portion of the first feed solution to produce a first purified aqueous solution as the first condensate. The first thermally conductive layer 2230 is configured to collect the first latent heat of condensation and conduct the collected first latent heat of condensation to the second feedwater layer 2300 to thereby distill at least a portion of the second feed solution through the second membrane distillation layer 2310, thereby producing a second distillate in the second distillate layer 2320. The second distillate layer 2320 is configured to receive the second distillate from the second membrane distillation layer 2310 and condense the second distillate to form a second condensate and release a second latent heat of condensation. Distilling said portion of the second feed solution through the second membrane distillation layer 2310 purifies said portion of the second feed solution to produce a second purified aqueous solution as the second condensate. The distal end 2274 of the second conduit 2270 (e.g., the distal end of each of the one or more second conduits 2270) and the distal end 2374 of the fourth conduit 2370 (e.g., the distal end of each of the one or more fourth conduits 2370) are each independently configured to be fluidly connected to the receptacle 2500, such that the second portion 2250b of the second protrusion 2250 (e.g., the second portion 2250b of each of the one or more second protrusions 2250) and the second portion 2350b of the fourth protrusion 2350 (e.g., the second portion 2350b of each of the one or more fourth protrusions) are each independently configured to be disposed within the receptacle 2500, such that the receptacle 2500 is configured to receive and collect: the first purified aqueous solution from the first distillate layer 2220 via the second protrusion 2250 (e.g., via each of the one or more second protrusions 2250) and the second purified aqueous solution from the second distillate layer 2320 via the fourth protrusion 2350 (e.g., via each of the one or more fourth protrusions 2350). In some examples, the distal end 2274 of the second conduit 2270 (e.g., the distal end of each of the one or more second conduits 2270) and the distal end 2374 of the fourth conduit 2370 (e.g., the distal end of each of the one or more fourth conduits 2370) each independently form a watertight and/or an impermeable seal with the receptacle 2500.

Systems 2100 Further Comprising a Third Stage 4120

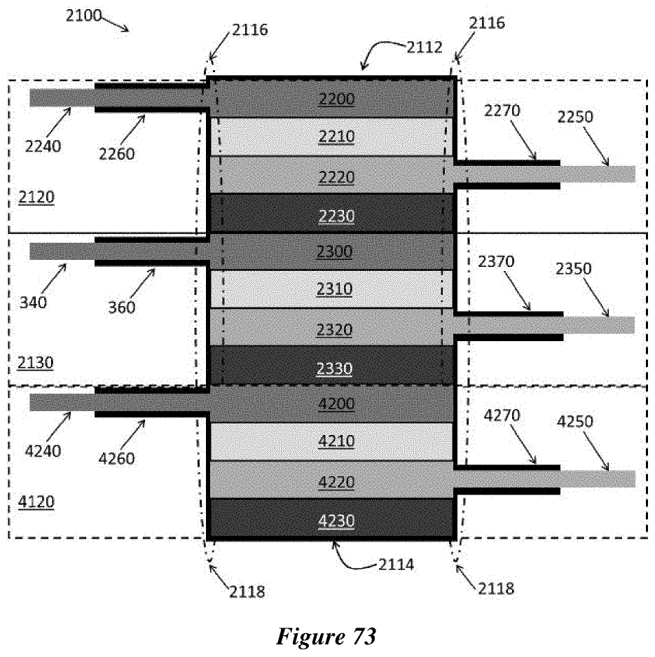

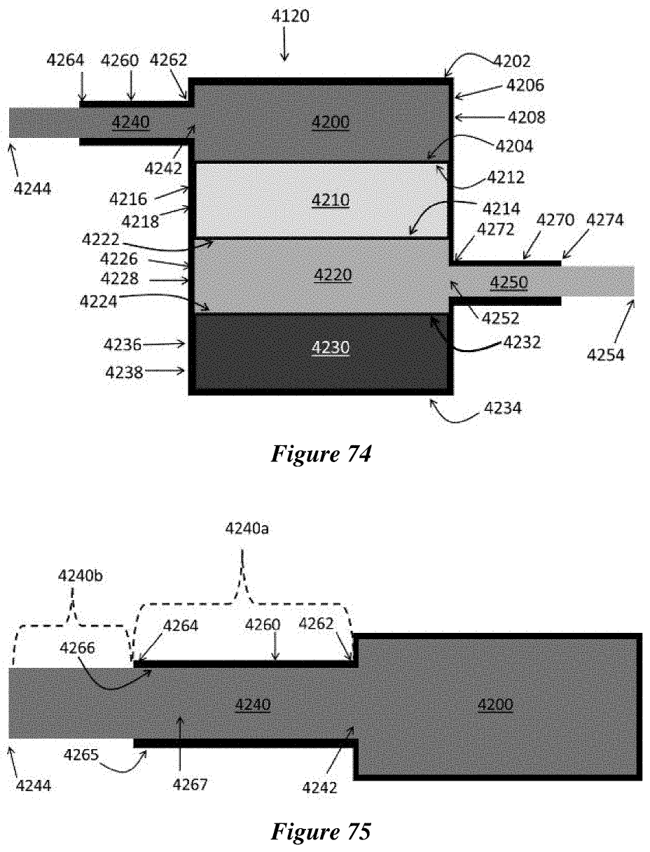

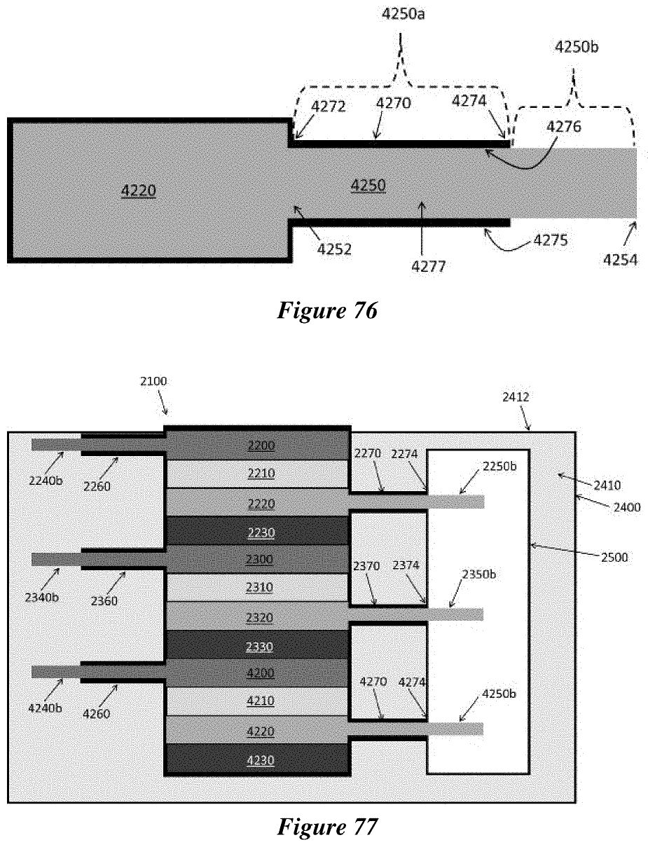

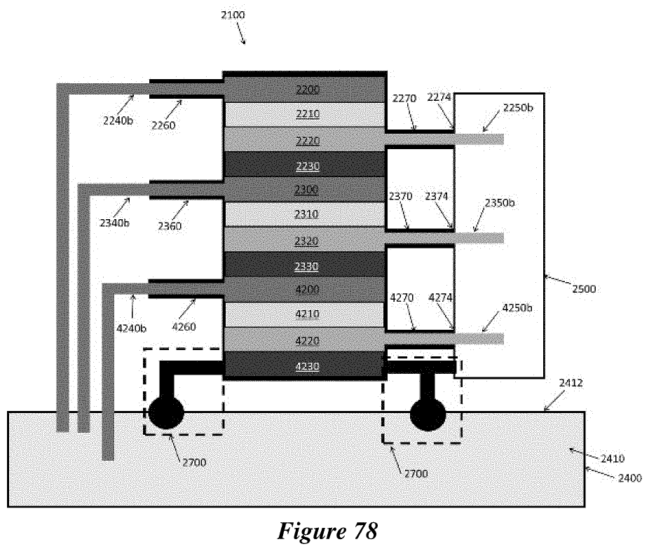

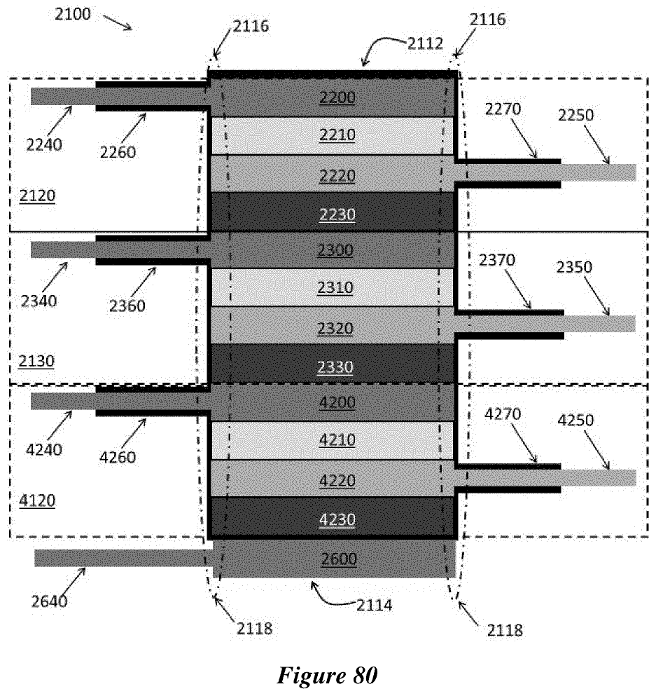

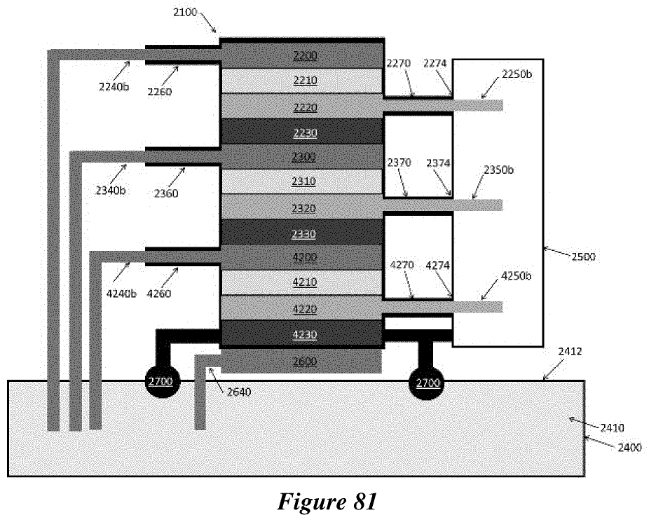

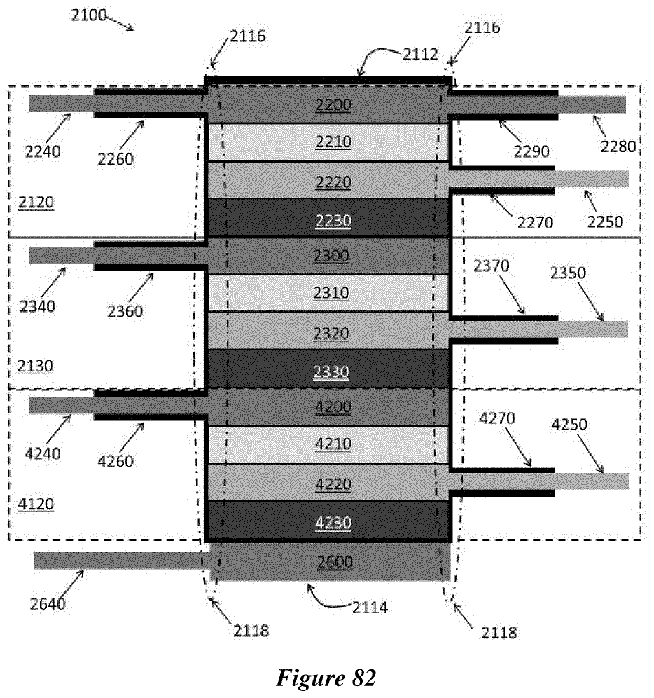

Referring now to FIG. 73-FIG. 82, in some examples the system 2100 further comprises a third stage 4120. The third stage 4120 comprises: a third feedwater layer 4200; a third membrane distillation layer 4210; a third distillate layer 4220; and a third thermally conductive layer 4230. The third feedwater layer 4200 is disposed on top of and in physical and fluid contact with the third membrane distillation layer 4210; the third membrane distillation layer 4210 is disposed on top of and in physical and fluid contact with the third distillate layer 4220 (e.g., such that the third membrane distillation layer 4210 is sandwiched between the third feedwater layer 4200 and the third distillate layer 4220); and the third distillate layer 4220 is disposed on top of and in physical and thermal contact with the third thermally conductive layer 4230 (e.g., such that the third distillate layer 4220 is sandwiched between the third membrane distillation layer 4210 and the third thermally conductive layer 5230). The second stage 2130 is stacked on top of the third stage 4120, such that the second thermally conductive layer 2330 is disposed on top of and in physical and thermal contact with the third feedwater layer 4200. In some examples, the third thermally conductive layer 4230 is substantially impermeable (e.g., watertight).

The third feedwater layer 4200 has a top surface 4202, a bottom surface 4204 opposite and spaced apart from the top surface 4202, and a perimeter 4206 defined by an edge 4208. In some examples, the top surface 4202 and the bottom surface 4204 of the third feedwater layer 4200 are substantially parallel to each other. The top surface 4202 and the bottom surface 4204 of the third feedwater layer 4200 can, independently, be any shape. In some examples, the top surface 4202 and the bottom surface 4204 of the third feedwater layer 4200 can, independently, be substantially circular, ovate, ovoid, elliptic, triangular, rectangular, polygonal, etc. In some examples, the top surface 4202 and the bottom surface 4204 of the third feedwater layer 4200 can be substantially the same shape. In some examples, the top surface 4202 and the bottom surface 4204 of the third feedwater layer 4200 can be substantially rectangular.

The third membrane distillation layer 4210 has a top surface 4212, a bottom surface 4214 opposite and spaced apart from the top surface 4212, and a perimeter 4216 defined by an edge 4218. In some examples, the top surface 4212 and the bottom surface 4214 of the third membrane distillation layer 4210 are substantially parallel to each other. The top surface 4212 and the bottom surface 4214 of the third membrane distillation layer 4210 can, independently, be any shape. In some examples, the top surface 4212 and the bottom surface 4214 of the third membrane distillation layer 4210 can, independently, be substantially circular, ovate, ovoid, elliptic, triangular, rectangular, polygonal, etc. In some examples, the top surface 4212 and the bottom surface 4214 of the third membrane distillation layer 4210 can be substantially the same shape. In some examples, the top surface 4212 and the bottom surface 4214 of the third membrane distillation layer 4210 can be substantially rectangular.

The third distillate layer 4220 has a top surface 4222, a bottom surface 4224 opposite and spaced apart from the top surface 4222, and a perimeter 4226 defined by an edge 4228. In some examples, the top surface 4222 and the bottom surface 4224 of the third distillate layer 4220 are substantially parallel to each other. The top surface 4222 and the bottom surface 4224 of the third distillate layer 4220 can, independently, be any shape. In some examples, the top surface 4222 and the bottom surface 4224 of the third distillate layer 4220 can, independently, be substantially circular, ovate, ovoid, elliptic, triangular, rectangular, polygonal, etc. In some examples, the top surface 4222 and the bottom surface 4224 of the third distillate layer 4220 can be substantially the same shape. In some examples, the top surface 4222 and the bottom surface 4224 of the third distillate layer 4220 can be substantially rectangular.

The third thermally conductive layer 4230 has a top surface 4232, a bottom surface 4234 opposite and spaced apart from the top surface 4232, and a perimeter 4236 defined by an edge 4238. In some examples, the top surface 4232 and the bottom surface 4234 of the third thermally conductive layer 4230 are substantially parallel to each other. The top surface 4232 and the bottom surface 4234 of the third thermally conductive layer 4230 can, independently, be any shape. In some examples, the top surface 4232 and the bottom surface 4234 of the third thermally conductive layer 4230 can, independently, be substantially circular, ovate, ovoid, elliptic, triangular, rectangular, polygonal, etc. In some examples, the top surface 4232 and the bottom surface 4234 of the third thermally conductive layer 4230 can be substantially the same shape. In some examples, the top surface 4232 and the bottom surface 4234 of the third thermally conductive layer 4230 can be substantially rectangular.

In certain examples, the system 2100 can further comprise: a sixth protrusion 4240 (e.g., one or more sixth protrusions 4240) and a seventh protrusion 4250 (e.g., one or more seventh protrusions 4250).

The sixth protrusion 4240 extends from a portion of the edge 4208 of the third feedwater layer 4200 from a proximal end 4242 to a distal end 4244 opposite and spaced apart from the proximal end 4242, the sixth protrusion 4240 being fluidly connected to the fourth feedwater layer 4200 from which it extends. In some examples, the system 2100 comprises a plurality of sixth protrusions 4240, wherein each of the plurality of sixth protrusions 4240 extends from a portion of the edge 4208 of the third feedwater layer 4200 from a proximal end 4242 to a distal end 4244 opposite and spaced apart from the proximal end 4242, the sixth protrusion 4240 being fluidly connected to the fourth feedwater layer 4200 from which it extends. In some examples, at least a portion of the sixth protrusion 4240 (e.g., at least the first portion 4240a) is integrally formed with the fourth feedwater layer 4200 from which it extends. In some examples, at least a portion of each of the plurality of sixth protrusions 4240 (e.g., at least the first portion 4240a) is integrally formed with the fourth feedwater layer 4200 from which it extends.

The seventh protrusion 4250 extends from a portion of the edge 4228 of the third distillate layer 4220 from a proximal end 4252 to a distal end 4254 opposite and spaced apart from the proximal end 4252, the seventh protrusion 4250 being fluidly connected to the third distillate layer 4220 from which it extends. In some examples, the system comprises a plurality of seventh protrusions 4250, wherein each of the plurality of seventh protrusions 4250 extends from a portion of the edge 4228 of the third distillate layer 4220 from a proximal end 4252 to a distal end 4254 opposite and spaced apart from the proximal end 4252, the seventh protrusion 4250 being fluidly connected to the third distillate layer 4220 from which it extends. In some examples, at least a portion of the seventh protrusion 4250 (e.g., at least the first portion 4250a) is integrally formed with the third distillate layer 4220 from which it extends. In some examples, at least a portion of each of the plurality of seventh protrusions 4250 (e.g., at least the first portion 4250a) is integrally formed with the third distillate layer 4220 from which it extends.

In certain examples, the system further comprises: a sixth conduit 4260 (e.g., one or more sixth conduits 4260); and a seventh conduit 4270 (e.g., one or more seventh conduits 4270); wherein the perimeter 2116 of the system is perforated by the sixth conduit 4260 (e.g., each of the one or more sixth conduits 4260) and the seventh conduit 4270 (e.g., each of the one or more seventh conduits 4270).

The sixth conduit 4260 (e.g., each of the one or more sixth conduits 4260) extends from the perimeter 2116 of the system from a proximal end 4262 to a distal end 4264. The sixth conduit 4260 (e.g., each of the one or more sixth conduits 4260) has an exterior surface 4265 that is substantially impermeable (e.g., watertight) and an interior surface 4266 that defines a lumen 4267. The lumen 4267 of the sixth conduit 4260 contains a first portion 4240a of the sixth protrusion 4240 and a second portion 4240b of the sixth protrusion 4240 extends beyond the distal end 4264 of the sixth conduit 4260. For example, the lumen 4267 of each of the one or more sixth conduits 4260 contains a first portion 4240a of each of the one or more sixth protrusions 4240, and a second portion 4240b of each of the one or more sixth protrusions 4240 extends beyond the distal end 4264 of each of the one or more sixth conduits 4260.

The seventh conduit 4270 (e.g., each of the one or more seventh conduits 4270) extends from the perimeter 2116 of the system from a proximal end 4272 to a distal end 4274. The seventh conduit 4270 (e.g., each of the one or more seventh conduits 4270) has an exterior surface 4275 that is substantially impermeable (e.g., watertight) and an interior surface 4276 that defines a lumen 4277. The lumen 4277 of the seventh conduit 4270 contains a first portion 4250a of the seventh protrusion 4250 and a second portion 4250b of the seventh protrusion 4250 extends beyond the distal end 4274 of the second conduit 4270. For example, the lumen 4277 of each of the one or more seventh conduits 4270 contains a first portion 4250a of each of the one or more seventh protrusions 4250, and a second portion 4250b of each of the one or more seventh protrusions 4250 extends beyond the distal end 4274 of each of the one or more second conduits 4270.

In some examples, the second portion 4240b of each of the one or more sixth protrusions 4240 is fluidly connected to the first portion 4240a. The second portion 4240b of each of the one or more sixth protrusions 4240 can be fluidly connected to the first portion 4240a using any suitable means, such as those known in the art. For example, the second portion 4240b of each of the one or more sixth protrusions 4240 can be fluidly connected to the first portion 4240a using an adhesive, solvent welding, heat, pressure, etc., or a combination thereof. In some examples, the second portion 4240b of each of the one or more sixth protrusions 4240 can be removably attached to the first portion 4240a, for example such that the second portion 4240b can be removed and replaced. For example, the second portion 4240b of each of the one or more sixth protrusions 4240 can be interchangeable.

In some examples, the second portion 4240b of each of the one or more sixth protrusions 4240 can further comprise one or more treatment components, e.g. one or more treatment components can be impregnated in the second portion 4240b of each of the one or more sixth protrusions 4240. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 4250b of each of the one or more seventh protrusions 4250 is fluidly connected to the first portion 4250a. The second portion 4250b of each of the one or more seventh protrusions 4250 can be fluidly connected to the first portion 4250a using any suitable means, such as those known in the art. For example, the second portion 4250b of each of the one or more seventh protrusions 4250 can be fluidly connected to the first portion 4250a using an adhesive, solvent welding, heat, pressure, etc., or a combination thereof. In some examples, the second portion 4250b of each of the one or more seventh protrusions 4250 can be removably attached to the first portion 4250a, for example such that the second portion 4250b can be removed and replaced. For example, the second portion 4250b of each of the one or more seventh protrusions 4250 can be interchangeable.

In some examples, the second portion 4250b of each of the one or more seventh protrusions 4250 can further comprise one or more treatment components, e.g. one or more treatment components can be impregnated in the second portion 4250b of each of the one or more seventh protrusions 4250. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, each of the feedwater layers of the system can further comprise an outflow protrusion (e.g. one or more outflow protrusions), wherein the outflow protrusion (e.g., each of the one or more outflow protrusions) extends from a portion of the edge of said feedwater layer from a proximal end to a distal end opposite and spaced apart from the proximal end, the outflow protrusion (e.g., each of the one or more outflow protrusions) being fluidly connected to the feedwater layer from which it extends. In some examples, at least a portion of the outflow protrusion (e.g., at least a portion of each of the one or more outflow protrusions) is integrally formed with the feedwater layer from which it extends.

In certain examples, the system further comprises an outflow conduit (e.g. one or more outflow conduits), wherein the perimeter of the system is perforated by the outflow conduit (e.g., each of the one or more outflow conduits). The outflow conduit (e.g., each of the one or more outflow conduits) extends from the perimeter of the system from a proximal end to a distal end. The outflow conduit (e.g., each of the one or more outflow conduits) has an exterior surface that is substantially impermeable (e.g., watertight) and an interior surface that defines a lumen. The lumen of the outflow conduit contains a first portion of the outflow protrusion and a second portion of the outflow protrusion extends beyond the distal end of the outflow conduit. For example, the lumen of each of the one or more outflow conduits contains a first portion of each of the one or more outflow protrusions, and a second portion of each of the one or more outflow protrusions extends beyond the distal end of each of the one or more outflow conduits.

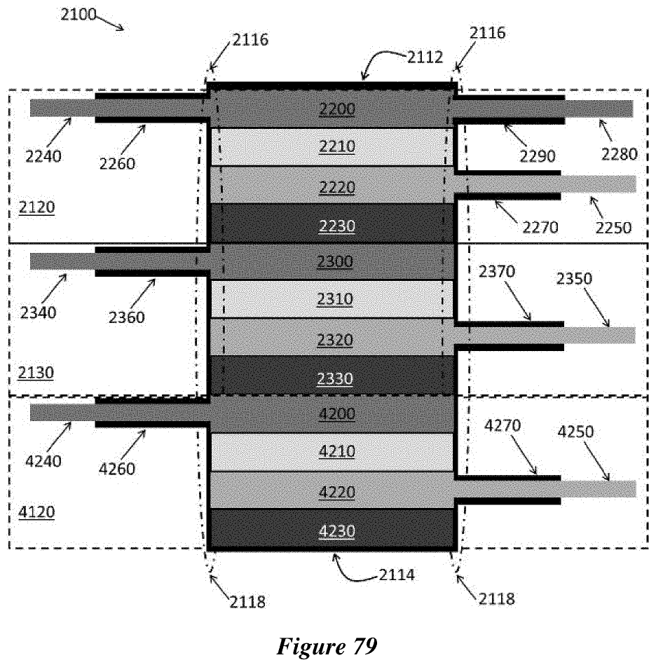

For example, referring now to FIG. 79, the first feedwater layer 2200 can further comprise a first outflow protrusion 2280 (e.g., one or more first outflow protrusions 2280), the first outflow protrusion 2280 (e.g., each of the one or more first outflow protrusions 2280) extends from a portion of the edge of the first feedwater layer 2200 from a proximal end to a distal end opposite and spaced apart from the proximal end, the first outflow protrusion 2280 (e.g., each of the one or more first outflow protrusions 2280) being fluidly connected to the first feedwater layer 2200 from which it extends. In some examples, at least a portion of the first outflow protrusion 2280 (e.g., at least a portion of each of the one or more first outflow protrusions 2280) is integrally formed with the first feedwater layer 2280 from which it extends. In certain examples, the system further comprises an outflow conduit 2290 (e.g. one or more outflow conduits 2290), wherein the perimeter 2116 of the system is perforated by the outflow conduit 2290 (e.g., each of the one or more outflow conduits 2290). The outflow conduit 2290 (e.g., each of the one or more outflow conduits 2290) extends from the perimeter 2116 of the system from a proximal end to a distal end. The outflow conduit 2290 (e.g., each of the one or more outflow conduits 2290) has an exterior surface that is substantially impermeable (e.g., watertight) and an interior surface that defines a lumen. The lumen of the outflow conduit 2290 contains a first portion of the outflow protrusion 2280 and a second portion of the outflow protrusion 2280 extends beyond the distal end of the outflow conduit 2290. For example, the lumen of each of the one or more outflow conduits 2290 contains a first portion of each of the one or more outflow protrusions 2280, and a second portion of each of the one or more outflow protrusions 2280 extends beyond the distal end of each of the one or more outflow conduits 2290.

For example, the system can be configured such that there is a driving force to produce update of a liquid and/or solution by the feedwater protrusion(s), from the feedwater protrusion(s) across the feedwater layer to the outflow protrusion(s), and out the outflow protrusion(s). The driving force can, for example, be gravity based (e.g., the feedwater protrusion(s) are elevated above the outflow protrusions(s)), capillary based (e.g., increasing capillary force from the feedwater protrusions(s) to the outlet protrusion(s), etc.

The system 2100 further comprises: a top surface 2112; a bottom surface 2114 opposite and spaced apart from the top surface 2112; a perimeter 2116 defined by an edge 2118. In some examples, the top surface 2112 and the bottom surface 2114 of are substantially parallel to each other.

In some examples, the top surface 2112 and the perimeter 2116 of the system 2100 are each substantially impermeable (e.g., to ions, solutions, and/or liquids). In some examples, the top surface 2112 and the perimeter 2116 of the system 2100 are each substantially watertight.

In some examples, the bottom surface 2114 is substantially impermeable (e.g., to ions, solutions, and/or liquids). In some examples, the bottom surface 2114 is substantially watertight. In certain examples, the bottom surface 2114 of the system comprises the third thermally conductive layer 4230.

In some examples, the system further comprises a terminal feedwater layer 2600, wherein the third stage 4120 is stacked on top of the terminal feedwater layer 2600, such that the third thermally conductive layer 4230 is disposed on top of an in physical and thermal contact with the terminal feedwater layer 2600. In some examples, the bottom surface 2114 comprises the terminal feedwater layer 2600.

The terminal feedwater layer 2600 has a top surface 2602, a bottom surface 2604 opposite and spaced apart from the top surface 2602, and a perimeter 2606 defined by an edge 2608. In some examples, the top surface and the bottom surface of the terminal feedwater layer are substantially parallel to each other. The layer can have an average thickness, the average thickness being the average dimension from the top surface to the bottom surface.

The top surface 2602 and the bottom surface 2604 of the terminal feedwater layer 2600 can, independently, be any shape. In some examples, the top surface 2602 and the bottom surface 2604 of the terminal feedwater layer 2600 can, independently, be substantially circular, ovate, ovoid, elliptic, triangular, rectangular, polygonal, etc. In some examples, the top surface 2602 and the bottom surface 2604 of the terminal feedwater layer 2600 can be substantially the same shape. In some examples, the top surface 2602 and the bottom surface 2604 of the terminal feedwater layer 2600 can be substantially rectangular.

In some examples, the terminal feedwater layer 2600 can further comprise an terminal feedwater protrusion 2640 (e.g., one or more terminal feedwater protrusions 2640), wherein the terminal feedwater protrusion 2640 (e.g., each of the one or more terminal feedwater protrusions 2640) extends from a portion of the edge 2608 of the terminal feedwater layer 2600 from a proximal end 2642 to a distal end 2644 opposite and spaced apart from the proximal end 2642, the terminal feedwater protrusion 2640 (e.g., each of the one or more terminal feedwater protrusions 2640) being fluidly connected to the terminal feedwater layer 2600 from which it extends. In some examples, at least a portion of the terminal feedwater protrusion 2640 (e.g., at least a portion of each of the one or more terminal feedwater protrusions 2640) is integrally formed with the terminal feedwater layer 2600 from which it extends.

The system 2100 is configured to be flexible. For example, the system 2100 is flexible such that the system 2100 can be rolled and/or folded when being stored (e.g., to be more spatially compact) and then unrolled and/or unfolded when deployed. In some examples, the system 2100 is further configured to be lightweight, such that the system can be easily transported.

In some examples, the system 2100 is configured to be deployed in reservoir 2400 containing a contaminated aqueous solution 2410, the contaminated aqueous solution 2410 having a surface 2412.

In some examples, the system is configured to be deployed on land or on a vehicle, wherein the system is deployed proximate a contaminated aqueous solution 2410, e.g. proximate a reservoir containing a contaminated aqueous solution 2410.

In some examples, the system 2100 is configured to be buoyant, such that the system 2100 floats in the contaminated aqueous solution 2410 when deployed therein, such that at least the solar absorber layer 2110 is disposed above the surface 2412 of the contaminated aqueous solution 2410.

In some examples, the system 2100 further comprises a buoyant frame 2700 that is configured to be coupled to the system 2100 and/or the receptacle 2500 such that the system 2100 and/or the receptacle 2500 is buoyant. In some examples, the buoyant frame 2700 comprises external floats or buoys coupled to a frame, said frame itself being buoyant or non-buoyant.

In certain examples, at least a portion of the system 2100 is disposed above the surface 2412 of the contaminated aqueous solution 2410. In certain examples, the system 2100 is disposed above the surface 2412 of the contaminated aqueous solution 2410, for example such that the bottom surface 2114 is disposed above the surface 2412 of the contaminated aqueous solution 2410, e.g. such that there is an air gap between the bottom surface 2114 of the device and the surface 2412 of the contaminated aqueous solution 2410.

In certain examples, wherein the system 2100 includes the a terminal feedwater layer 2600, the system 2100 is configured to be buoyant such that the terminal feedwater layer 2600 is disposed above the surface 2412 of the contaminated aqueous solution 2410, e.g. such that there is an air gap between the bottom surface 2604 of the terminal feedwater layer 2600 and the surface 2412 of the contaminated aqueous solution 2410.

When the system is deployed, the second portion 4240b of the sixth protrusion 4240 (e.g., the second portion of each of the one or more sixth protrusions 4240) is configured to be in contact with the contaminated aqueous solution 2410. The third feedwater layer 4200 is configured to receive a third portion of the contaminated aqueous solution from the sixth protrusion 4240, said third portion of the contaminated aqueous solution being a third feed solution. The second thermally conductive layer 2330 is configured to collect the second latent heat of condensation and conduct the collected second latent heat of condensation to the third feedwater layer 4200 to thereby distill the at least a portion of the third feed solution through the third membrane distillation layer 4210, thereby producing a third distillate in the third distillate layer 4220. The third distillate layer 4220 is configured to receive the third distillate from the third membrane distillation layer 4210 and condense the third distillate to form a third condensate and release a third latent heat of condensation. Distilling said portion of the third feed solution through the third membrane distillation layer 4210 purifies said portion of the third feed solution to produce a third purified aqueous solution as the third condensate. The distal end 4274 of the seventh conduit 4270 (e.g., the distal end 4274 of each of the one or more seventh conduits 4270) is configured to be fluidly connected to the receptacle 2500, such that the second portion 4250b of the seventh protrusion 4250 (e.g., the second portion 4250b of each of the one or more seventh protrusions 4250) is configured to be disposed within the receptacle 2500, such that the receptacle 2500 is configured to receive and collect: the third purified aqueous solution from the third distillate layer 4220 via the seventh protrusion 4250 (e.g., via each of the one or more seventh protrusions 4250). In some examples, the distal end 4274 of the seventh conduit 4270 (e.g., the distal end 4274 of each of the one or more seventh conduits 4270) forms a watertight and/or impermeable seal with the receptacle 2500.

Systems 2100 Further Comprising One or More Additional Stages 5120 and a Final Stage 5130

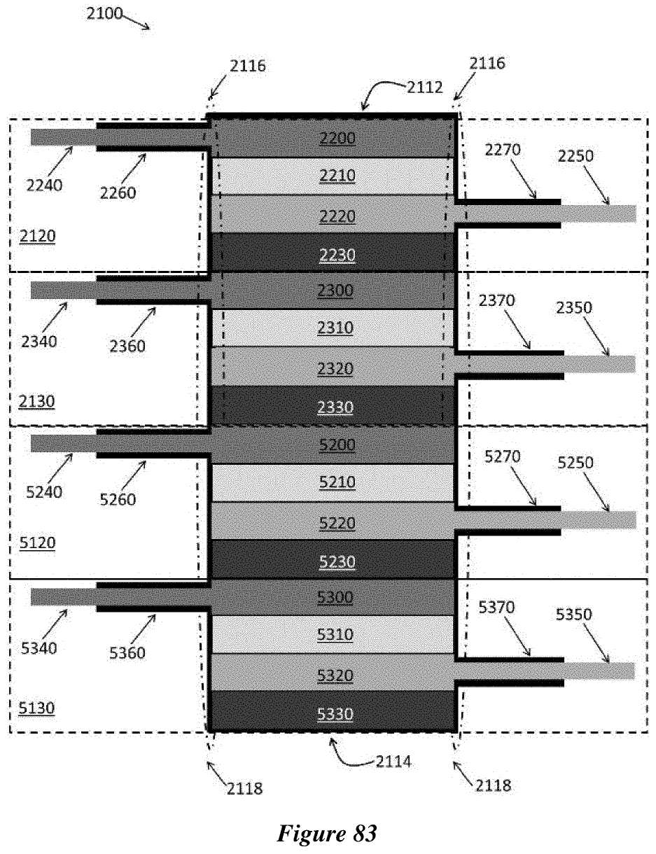

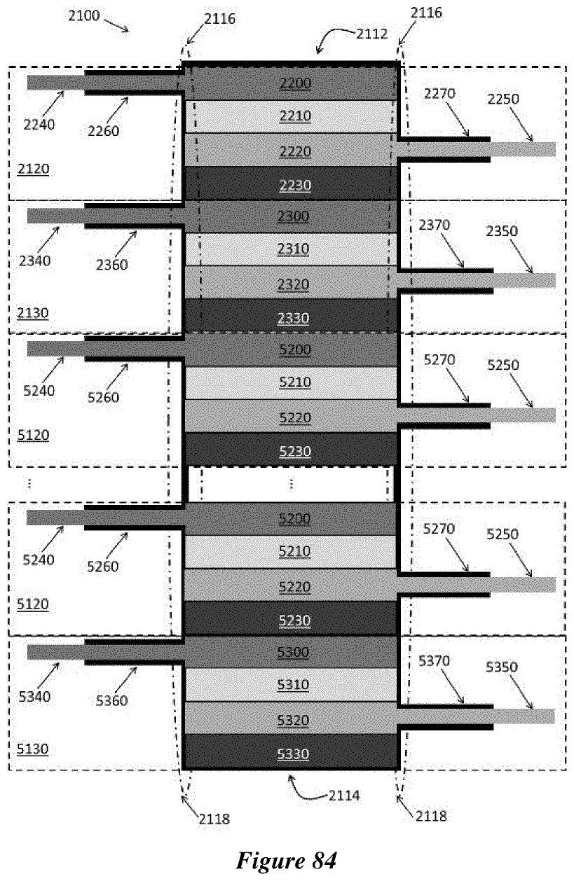

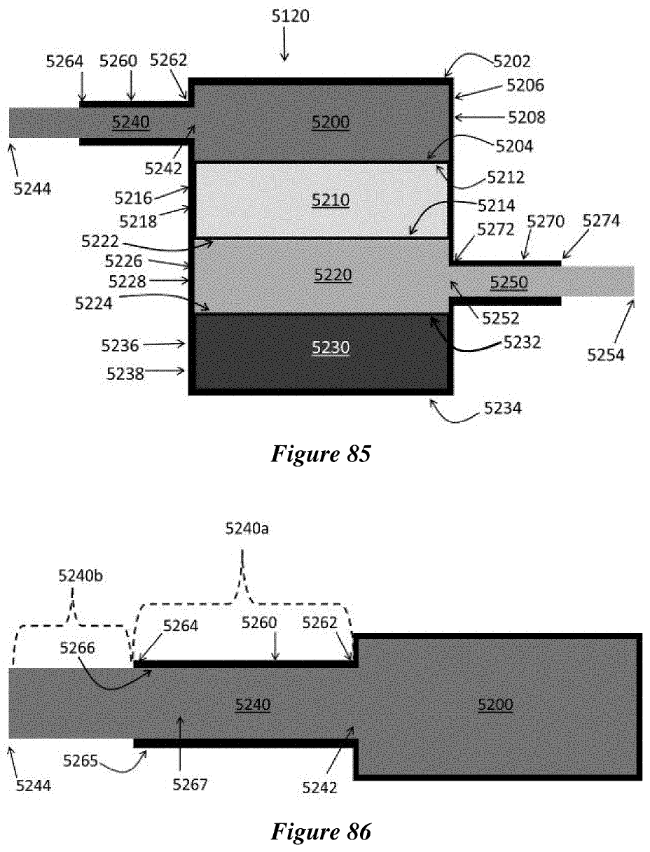

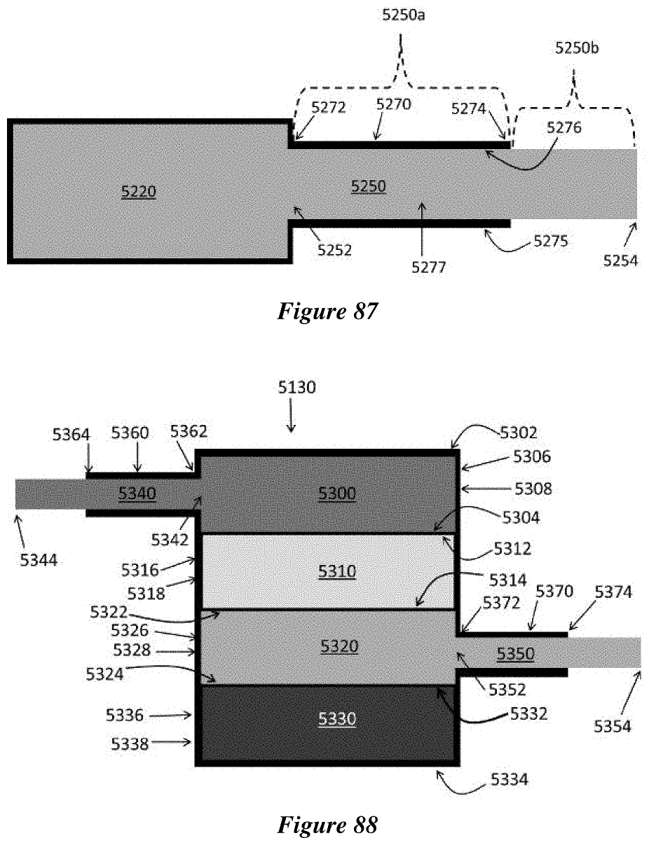

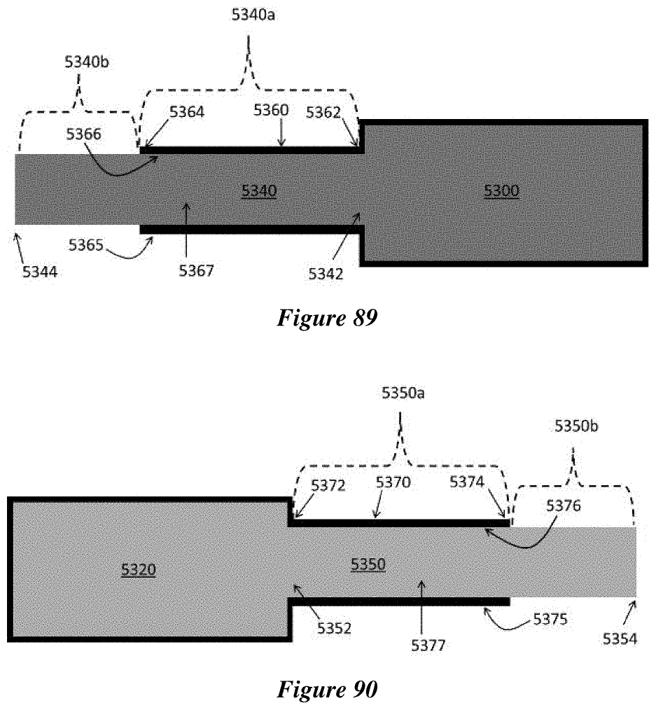

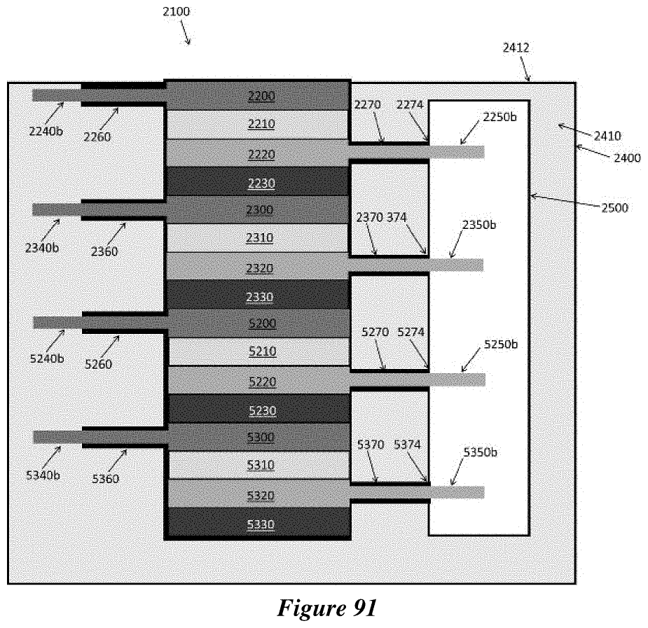

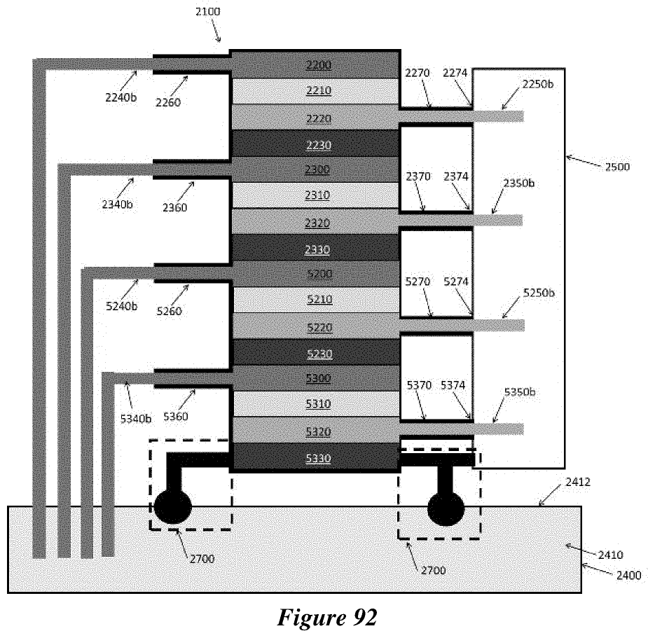

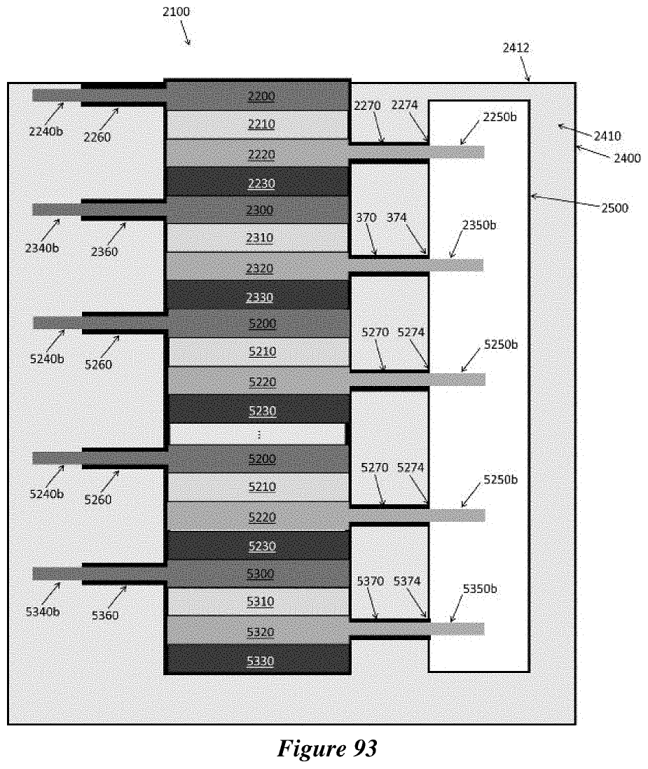

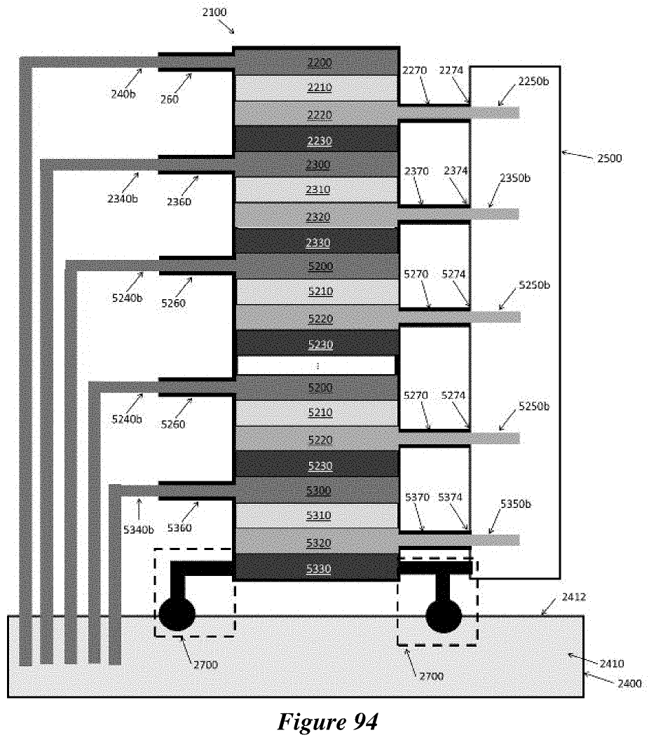

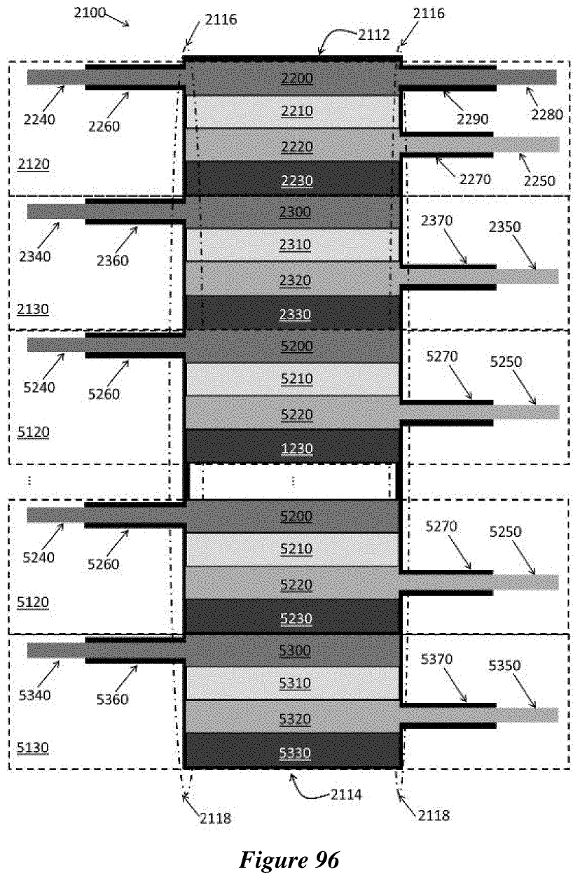

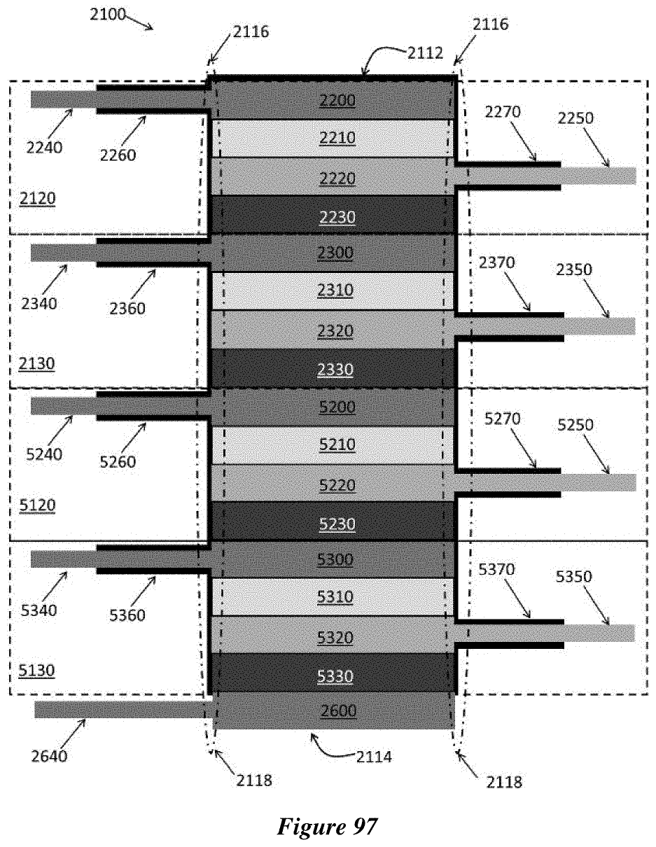

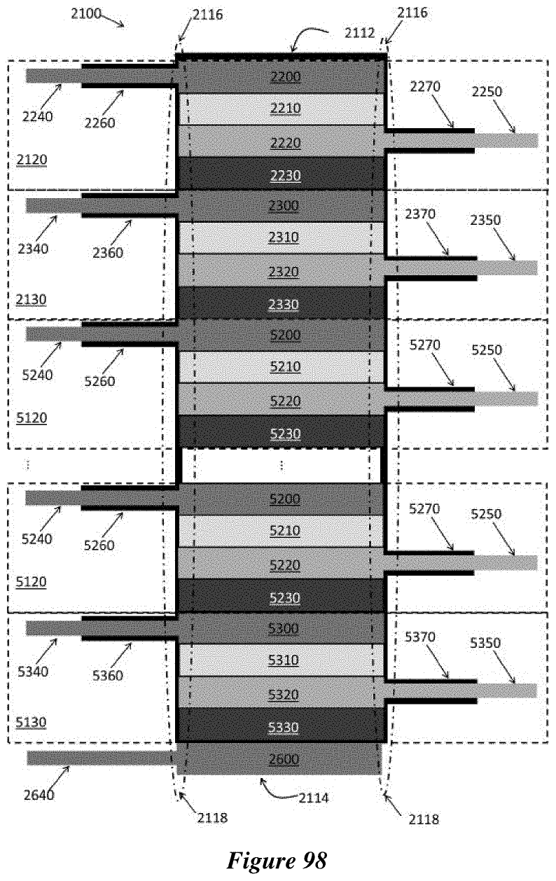

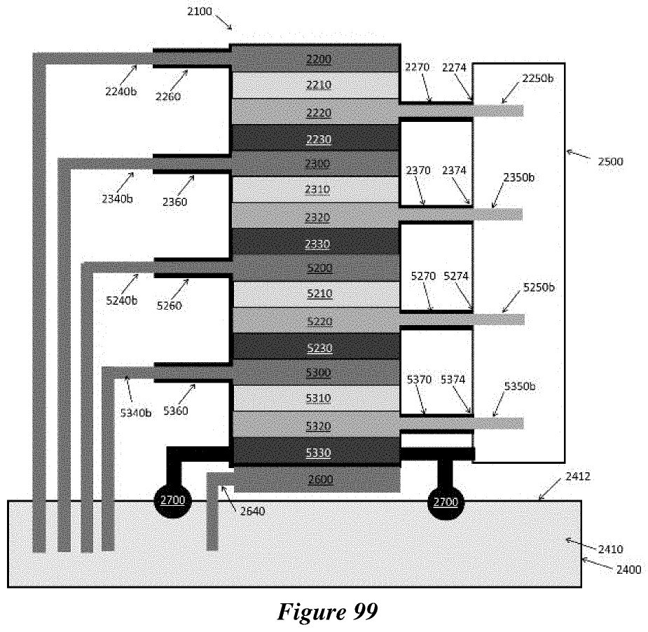

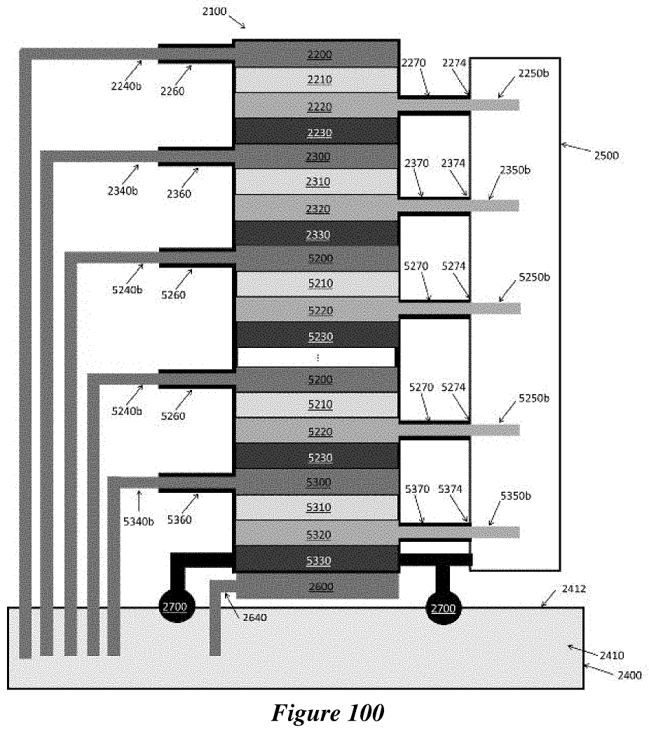

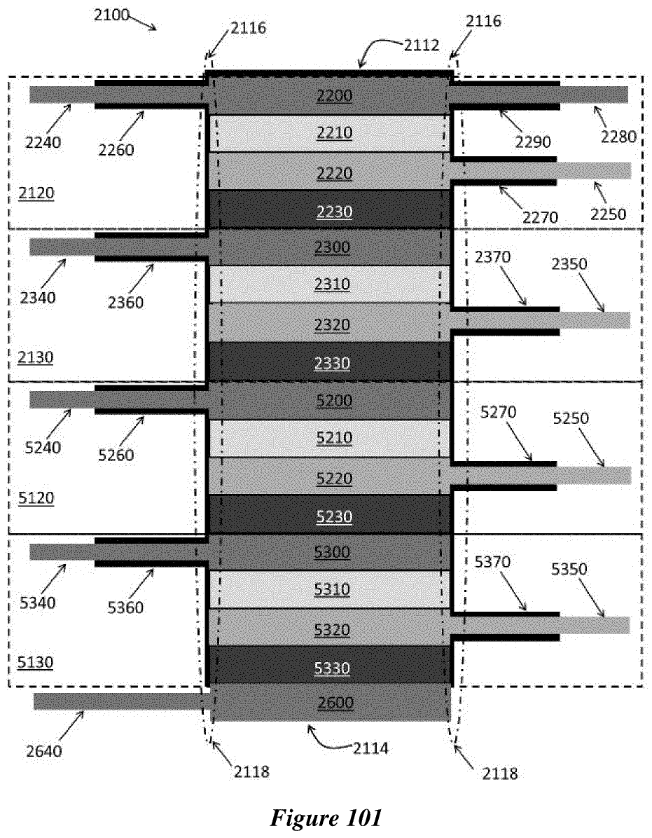

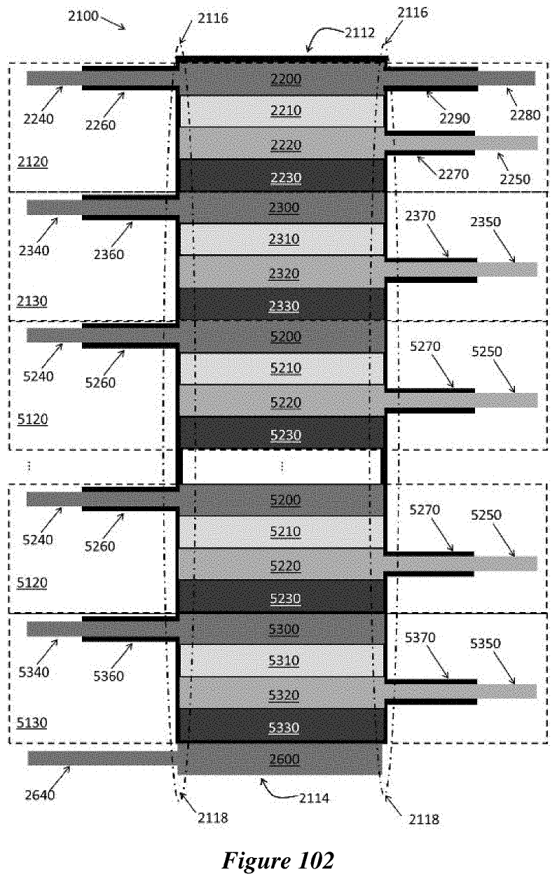

Referring now to FIG. 83-FIG. 102, in some examples the system 2100 further comprises: one or more additional stages 5120; and a final stage 5130.

Each of the one or more additional stages 5120 independently comprises: a feedwater layer 5200; a membrane distillation layer 5210; a distillate layer 5220; and a thermally conductive layer 5230. In each of the one or more additional stages independently, the feedwater layer 5200 is disposed on top of and in physical and fluid contact with the membrane distillation layer 5210; the membrane distillation layer 5210 is disposed on top of and in physical and fluid contact with the distillate layer 5220 (e.g., such that the membrane distillation layer 5210 is sandwiched between the feedwater layer 5200 and the distillate layer 5220); and the distillate layer 5220 is disposed on top of and in physical and thermal contact with the thermally conductive layer 5230 (e.g., such that the distillate layer 5220 is sandwiched between the membrane distillation layer 5210 and the thermally conductive layer 5230).

Each of the one or more additional feedwater layers 5200 has a top surface 5202, a bottom surface 5204 opposite and spaced apart from the top surface 5202, and a perimeter 5206 defined by an edge 5208. In some examples, the top surface 5202 and the bottom surface 5204 of each of the one or more additional feedwater layers 5200 are substantially parallel to each other. The top surface 5202 and the bottom surface 5204 of each of the one or more additional feedwater layers 5200 can, independently, be any shape. In some examples, the top surface 5202 and the bottom surface 5204 of each of the one or more additional feedwater layers 5200 can, independently, be substantially circular, ovate, ovoid, elliptic, triangular, rectangular, polygonal, etc. In some examples, the top surface 5202 and the bottom surface 5204 of each of the one or more additional feedwater layers 5200 can be substantially the same shape. In some examples, the top surface 5202 and the bottom surface 5204 of each of the one or more additional feedwater layers 5200 can be substantially rectangular.

Each of the one or more additional membrane distillation layers 5210 has a top surface 5212, a bottom surface 5214 opposite and spaced apart from the top surface 5212, and a perimeter 5216 defined by an edge 5218. In some examples, the top surface 5212 and the bottom surface 5214 of each of the one or more additional membrane distillation layers 5210 are substantially parallel to each other. The top surface 5212 and the bottom surface 5214 of each of the one or more additional membrane distillation layers 5210 can, independently, be any shape. In some examples, the top surface 5212 and the bottom surface 5214 of each of the one or more additional membrane distillation layers 5210 can, independently, be substantially circular, ovate, ovoid, elliptic, triangular, rectangular, polygonal, etc. In some examples, the top surface 5212 and the bottom surface 5214 of each of the one or more additional membrane distillation layers 5210 can be substantially the same shape. In some examples, the top surface 5212 and the bottom surface 5214 of each of the one or more additional membrane distillation layers 5210 can be substantially rectangular.

Each of the one or more additional distillate layers 5220 has a top surface 5222, a bottom surface 5224 opposite and spaced apart from the top surface 5222, and a perimeter 5226 defined by an edge 5228. In some examples, the top surface 5222 and the bottom surface 5224 of each of the one or more additional distillate layers 5220 are substantially parallel to each other. The top surface 5222 and the bottom surface 5224 of each of the one or more additional distillate layers 5220 can, independently, be any shape. In some examples, the top surface 5222 and the bottom surface 5224 of each of the one or more additional distillate layers 5220, independently, be substantially circular, ovate, ovoid, elliptic, triangular, rectangular, polygonal, etc. In some examples, the top surface 5222 and the bottom surface 5224 of each of the one or more additional distillate layers 5220 can be substantially the same shape. In some examples, the top surface 5222 and the bottom surface 5224 of each of the one or more additional distillate layers 5220 can be substantially rectangular.

Each of the one or more additional thermally conductive layers 5230 has a top surface 5232, a bottom surface 5234 opposite and spaced apart from the top surface 5232, and a perimeter 5236 defined by an edge 5238. In some examples, the top surface 5232 and the bottom surface 5234 of each of the one or more additional thermally conductive layers 5230 are substantially parallel to each other. The top surface 5232 and the bottom surface 5234 of each of the one or more additional thermally conductive layers 5230 can, independently, be any shape. In some examples, the top surface 5232 and the bottom surface 5234 of each of the one or more additional thermally conductive layers 5230 can, independently, be substantially circular, ovate, ovoid, elliptic, triangular, rectangular, polygonal, etc. In some examples, the top surface 5232 and the bottom surface 5234 of each of the one or more additional thermally conductive layers 5230 can be substantially the same shape. In some examples, the top surface 5232 and the bottom surface 5234 of each of the one or more additional thermally conductive layers 5230 can be substantially rectangular.

The final stage 5130 comprises: a final feedwater layer 5300; a final membrane distillation layer 5310; a final distillate layer 5320; and a final thermally conductive layer 5330. The final feedwater layer 5300 is disposed on top of and in physical and fluid contact with the final membrane distillation layer 5310; the final membrane distillation layer 5310 is disposed on top of and in physical and fluid contact with the final distillate layer 5320 (e.g., such that the final membrane distillation layer 5310 is sandwiched between the final feedwater layer 5300 and the final distillate layer 5320); and the final distillate layer 5320 is disposed on top of and in physical and thermal contact with the final thermally conductive layer 5330 (e.g., such that the final distillate layer 5320 is sandwiched between the final membrane distillation layer 5310 and the final thermally conductive layer 5330).

The final feedwater layer 5300 has a top surface 5302, a bottom surface 5304 opposite and spaced apart from the top surface 5302, and a perimeter 5306 defined by an edge 5308. In some examples, the top surface 5302 and the bottom surface 5304 of the final feedwater layer 5300 are substantially parallel to each other. The top surface 5302 and the bottom surface 5304 of the final feedwater layer 5300 can, independently, be any shape. In some examples, the top surface 5302 and the bottom surface 5304 of the final feedwater layer 5300 can, independently, be substantially circular, ovate, ovoid, elliptic, triangular, rectangular, polygonal, etc. In some examples, the top surface 5302 and the bottom surface 5304 of the final feedwater layer 5300 can be substantially the same shape. In some examples, the top surface 5302 and the bottom surface 5304 of the final feedwater layer 5300 can be substantially rectangular.

The final membrane distillation layer 5310 has a top surface 5312, a bottom surface 5314 opposite and spaced apart from the top surface 5312, and a perimeter 5316 defined by an edge 5318. In some examples, the top surface 5312 and the bottom surface 5314 of the final membrane distillation layer 5310 are substantially parallel to each other. The top surface 5312 and the bottom surface 5314 of the final membrane distillation layer 5310 can, independently, be any shape. In some examples, the top surface 5312 and the bottom surface 5314 of the final membrane distillation layer 5310 can, independently, be substantially circular, ovate, ovoid, elliptic, triangular, rectangular, polygonal, etc. In some examples, the top surface 5312 and the bottom surface 5314 of the final membrane distillation layer 5310 can be substantially the same shape. In some examples, the top surface 5312 and the bottom surface 5314 of the final membrane distillation layer 5310 can be substantially rectangular.

The final distillate layer 5320 has a top surface 5322, a bottom surface 5324 opposite and spaced apart from the top surface 5322, and a perimeter 5326 defined by an edge 5328. In some examples, the top surface 5322 and the bottom surface 5324 of the final distillate layer 5320 are substantially parallel to each other. The top surface 5322 and the bottom surface 5324 of the final distillate layer 5320 can, independently, be any shape. In some examples, the top surface 5322 and the bottom surface 5324 of the final distillate layer 5320 can, independently, be substantially circular, ovate, ovoid, elliptic, triangular, rectangular, polygonal, etc. In some examples, the top surface 5322 and the bottom surface 5324 of the final distillate layer 5320 can be substantially the same shape. In some examples, the top surface 5322 and the bottom surface 5324 of the final distillate layer 5320 can be substantially rectangular.

The final thermally conductive layer 5330 has a top surface 5332, a bottom surface 5334 opposite and spaced apart from the top surface 5332, and a perimeter 5336 defined by an edge 5338. In some examples, the top surface 5332 and the bottom surface 5334 of the final thermally conductive layer 5330 are substantially parallel to each other. The top surface 5332 and the bottom surface 5334 of the final thermally conductive layer 5330 can, independently, be any shape. In some examples, the top surface 5332 and the bottom surface 5334 of the final thermally conductive layer 5330 can, independently, be substantially circular, ovate, ovoid, elliptic, triangular, rectangular, polygonal, etc. In some examples, the top surface 5332 and the bottom surface 5334 of the final thermally conductive layer 5330 can be substantially the same shape. In some examples, the top surface 5332 and the bottom surface 5334 of the final thermally conductive layer 5330 can be substantially rectangular.

In certain examples, the second stage 2130 is stacked on top of the one or more additional stages 5120, which are in turn stacked on top the final stage 5130, such that the thermally conductive layer of a preceding stage is disposed on top of and in physical and thermal contact with the feedwater layer of a subsequent stage. In some examples, each of the one or more additional thermally conductive layers 5230 and the final thermally conductive layer 5330 are each substantially impermeable (e.g., watertight).

In certain examples, each of the one or more additional feedwater layers 5200 further comprises an additional feedwater protrusion 5240 (e.g., one or more additional feedwater protrusions 5240), wherein the additional feedwater protrusion 5240 (e.g., each of the one or more additional feedwater protrusions 5240) extends from a portion of the edge 5208 of said additional feedwater layer 5200 from a proximal end 5242 to a distal end 5244 opposite and spaced apart from the proximal end 5242, the additional feedwater protrusion 5240 (e.g., each of the one or more additional feedwater protrusions 5240) being fluidly connected to the additional feedwater layer 5200 from which it extends. In some examples, at least a portion of the additional feedwater protrusion 5240 (e.g., at least a portion of each of the one or more additional feedwater protrusions 5240), such as at least the first portion 5240, is integrally formed with the additional feedwater layer 5200 from which it extends.

In certain examples, each of the one or more additional distillate layers 5220 further comprises an additional distillate protrusion 5250 (e.g., one or more additional distillate protrusions 5250), wherein the additional distillate protrusion 5250 (e.g., each of the one or more additional distillate protrusions 5250) extends from a portion of the edge 5228 of said additional distillate layer 5220 from a proximal end 5252 to a distal end 5254 opposite and spaced apart from the proximal end 5252, the additional distillate protrusion 5250 (e.g., each of the one or more additional distillate protrusions 5250) being fluidly connected to the additional distillate layer 5220 from which it extends. In some examples, at least a portion of the additional distillate protrusion 5250 (e.g., at least a portion of each of the one or more additional distillate protrusions 5250), such as at least the first portion 5250a, is integrally formed with the additional distillate layer 5220 from which it extends.

In certain examples, the final feedwater layer 5300 further comprises a final feedwater protrusion 5340 (e.g., one or more final feedwater protrusions 5340), wherein the final feedwater protrusion 5340 (e.g., each of the one or more final feedwater protrusions 5340) extends from a portion of the edge 5308 of the final feedwater layer 5300 from a proximal end 5342 to a distal end 5344 opposite and spaced apart from the proximal end 5342, the final feedwater protrusion 5340 (e.g., each of the one or more final feedwater protrusions 5340) being fluidly connected to the final feedwater layer 5300 from which it extends. In some examples, at least a portion of the final feedwater protrusion 5340 (e.g., at least a portion of each of the one or more final feedwater protrusions 5340), such as at least the first portion 5340a, is integrally formed with the final feedwater layer 5300 from which it extends.

In some examples, the final distillate layer 5320 further comprises a final distillate protrusion 5350 (e.g., one or more final distillate protrusions 5350), wherein the final distillate protrusion 5350 (e.g., each of the one or more final distillate protrusions 5350) extends from a portion of the edge 5328 of the final distillate layer 5320 from a proximal end 5352 to a distal 5354 end opposite and spaced apart from the proximal end 5352, the final distillate protrusion 5350 (e.g., each of the one or more final distillate protrusions 5350) being fluidly connected to the final distillate layer 5320 from which it extends. In some examples, at least a portion of the final distillate protrusion 5350 (e.g., at least a portion of each of the one or more final distillate protrusions 1350), such as at least the first portion 5350a, is integrally formed with the final distillate layer 5320 from which it extends.

In certain examples, the system further comprises: one or more additional feedwater conduits 5260; one or more additional distillate conduits 5270; a final feedwater conduit 5360 (e.g., one or more final feedwater conduits 5360); and a final distillate conduit 5370 (e.g., one or more final distillate conduits 5370); wherein the perimeter 2116 of the system is perforated by each of the one or more additional feedwater conduits 5260, one or more additional distillate conduits 5270, the final feedwater conduit 5360 (e.g., each of the one or more final feedwater conduits 5360), and the final distillate conduit 5370 (e.g., each of the one or more final distillate conduits 5370).

Each of the one or more additional feedwater conduits 5260 extends from the perimeter 2116 of the system from a proximal end 5262 to a distal end 5264. Each of the one or more additional feedwater conduits 5260 has an exterior surface 5265 that is substantially impermeable (e.g., watertight) and an interior surface 5266 that defines a lumen 5267. The lumen 5267 of each of the one or more additional feedwater conduits 5260 contains a first portion 5240a of each of the one of the one or more additional feedwater protrusions 5240 and a second portion 5240b of said feedwater protrusion 5240 extends beyond the distal end 5264 of said feedwater conduit 5260.

Each of the one or more additional distillate conduits 5270 extends from the perimeter 2116 of the system from a proximal end 5272 to a distal end 5274. Each of the one or more additional distillate conduits 5270 has an exterior surface 5275 that is substantially impermeable (e.g., watertight) and an interior surface 5276 that defines a lumen 5277. The lumen 5277 of each of the one or more additional distillate conduits 5270 contains a first portion 5250a of each of the one of the one or more additional distillate protrusions 5250 and a second portion 5250b of said distillate protrusion 5250 extends beyond the distal end 5274 of said distillate conduit 5270.

The final feedwater conduit 5360 (e.g., each of the one or more final feedwater conduits 5360) extends from the perimeter 2116 of the system from a proximal end 5362 to a distal end 5364. The final feedwater conduit 5360 (e.g., each of the one or more final feedwater conduits 5360) has an exterior surface 5365 that is substantially impermeable (e.g., watertight) and an interior surface 5366 that defines a lumen 5367. The lumen 5367 of the final feedwater conduit 5360 contains a first portion 5340a of the final feedwater protrusion 5340 and a second portion 5340b of the final feedwater protrusion 5340 extends beyond the distal end 5364 of the final feedwater conduit 5360. For example, the lumen 5367 of each of the one or more final feedwater conduits 5360 contains a first portion 5340a of each of the one or more final feedwater protrusion 5340, and a second portion 5340b of each of the one or more final feedwater protrusions 5340 extends beyond the distal end 5364 of each of the one or more final feedwater conduit 5360.

The final distillate conduit 5370 (e.g., each of the one or more final distillate conduits 5370) extends from the perimeter 2116 of the system from a proximal end 5372 to a distal end 5374. The final distillate conduit 5370 (e.g., each of the one or more final distillate conduits 5370) has an exterior surface 5375 that is substantially impermeable (e.g., watertight) and an interior surface 5376 that defines a lumen 5377. The lumen 5377 of the final distillate conduit 5370 contains a first portion 5350a of the final distillate protrusion 5350 and a second portion 5350b of the final distillate protrusion 5350 extends beyond the distal end 5374 of the final distillate conduit 5370. For example, the lumen 5377 of each of the one or more final distillate conduits 5370 contains a first portion 5350a of each of the one or more final distillate protrusions 5350, and a second portion 5350b of each of the one or more final distillate protrusions 5350 extends beyond the distal end 5374 of each of the one or more final distillate conduits 5370.

In some examples, the second portion 5240b of each of the one or more additional feedwater protrusions 5240 is fluidly connected to the first portion 5240a. The second portion 5240b of each of the one or more additional feedwater protrusions 5240 can be fluidly connected to the first portion 5240a using any suitable means, such as those known in the art. For example, the second portion 5240b of each of the one or more additional feedwater protrusions 5240 can be fluidly connected to the first portion 5240a using an adhesive, solvent welding, heat, pressure, etc., or a combination thereof. In some examples, the second portion 5240b of each of the one or more additional feedwater protrusions 5240 can be removably attached to the first portion 5240a, for example such that the second portion 5240b can be removed and replaced. For example, the second portion 5240b of each of the one or more additional feedwater protrusions 5240 can be interchangeable.

In some examples, the second portion 5240b of each of the one or more additional feedwater protrusions 5240 can further comprise one or more treatment components, e.g., one or more treatment components can be impregnated in the second portion 5240b of each of the one or more additional feedwater protrusions 5240. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 5250b of each of the one of the one or more additional distillate protrusions 5250 is fluidly connected to the first portion 5250a. The second portion 5250b of each of the one of the one or more additional distillate protrusions 5250 can be fluidly connected to the first portion 5250a using any suitable means, such as those known in the art. For example, the second portion 5250b of each of the one of the one or more additional distillate protrusions 5250 can be fluidly connected to the first portion 5250a using an adhesive, solvent welding, heat, pressure, etc., or a combination thereof. In some examples, the second portion 5250b of each of the one of the one or more additional distillate protrusions 5250 can be removable attached to the first portion 5250a, for example such that the second portion 5250b can be removed and replaced. For example, the second portion 5250b of each of the one of the one or more additional distillate protrusions 5250 can be interchangeable.

In some examples, the second portion 5250b of each of the one of the one or more additional distillate protrusions 5250 can further comprise one or more treatment components, e.g., one or more treatment components can be impregnated in the second portion 5250b of each of the one of the one or more additional distillate protrusions 5250. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 5340b of the one or more final feedwater protrusions 5340 is fluidly connected to the first portion 5340a. The second portion 5340b of the one or more final feedwater protrusions 5340 can be fluidly connected to the first portion 5340a using any suitable means, such as those known in the art. For example, the second portion 5340b of the one or more final feedwater protrusions 5340 can be fluidly connected to the first portion 5340a using an adhesive, solvent welding, heat, pressure, etc., or a combination thereof. In some examples, the second portion 5340b of the one or more final feedwater protrusions 5340 can be removably attached to the first portion 5340a, for example such that the second portion 5340b can be removed and replaced. For example, the second portion 5340b of the one or more final feedwater protrusions 5340 can be interchangeable.

In some examples, the second portion 5340b of the one or more final feedwater protrusions 5340 can further comprise one or more treatment components, e.g., one or more treatment components can be impregnated in the second portion 5340b of the one or more final feedwater protrusions 5340. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, the second portion 5350b of the final distillate protrusion 5350 is fluidly connected to the first portion 5350a. The second portion 5350b of the final distillate protrusion 5350 can be fluidly connected to the first portion 5350a using any suitable means, such as those known in the art. For example, the second portion 5350b of the final distillate protrusion 5350 can be fluidly connected to the first portion 5350a using an adhesive, solvent welding, heat, pressure, etc., or a combination thereof. In some examples, the second portion 5350b of the final distillate protrusion 5350 can be removably attached to the first portion 5350a, for example such that the second portion 5350b can be removed and replaced. For example, the second portion 5350b of the final distillate protrusion 5350 can be interchangeable.

In some examples, the second portion 5350b of the final distillate protrusion 5350 can further comprise one or more treatment components, e.g., one or more treatment components can be impregnated in the second portion 5350b of the final distillate protrusion 5350. The one or more treatment components can, for example, be selected to treat the contaminated aqueous solution and/or reduce or prevent biofouling or organic fouling (e.g., reduce or prevent biofilm or organic fouling layer formation). The one or more treatment components can comprise any suitable compound or composition, such as those known in the art. In some examples, the one or more treatment component(s) can comprise chitosan, silver (e.g., silver nanoparticles and/or a silver compound), underwater oleophobic coatings, or a combination thereof. The one or more treatment component(s) can, in some examples, also comprise a hydrogel incorporated with fouling resistant properties.

In some examples, each of the feedwater layers of the system can further comprise an outflow protrusion (e.g. one or more outflow protrusions), wherein the outflow protrusion (e.g., each of the one or more outflow protrusions) extends from a portion of the edge of said feedwater layer from a proximal end to a distal end opposite and spaced apart from the proximal end, the outflow protrusion (e.g., each of the one or more outflow protrusions) being fluidly connected to the feedwater layer from which it extends. In some examples, at least a portion of the outflow protrusion (e.g., at least a portion of each of the one or more outflow protrusions) is integrally formed with the feedwater layer from which it extends.

In certain examples, the system further comprises an outflow conduit (e.g. one or more outflow conduits), wherein the perimeter of the system is perforated by the outflow conduit (e.g., each of the one or more outflow conduits). The outflow conduit (e.g., each of the one or more outflow conduits) extends from the perimeter of the system from a proximal end to a distal end. The outflow conduit (e.g., each of the one or more outflow conduits) has an exterior surface that is substantially impermeable (e.g., watertight) and an interior surface that defines a lumen. The lumen of the outflow conduit contains a first portion of the outflow protrusion and a second portion of the outflow protrusion extends beyond the distal end of the outflow conduit. For example, the lumen of each of the one or more outflow conduits contains a first portion of each of the one or more outflow protrusions, and a second portion of each of the one or more outflow protrusions extends beyond the distal end of each of the one or more outflow conduits.

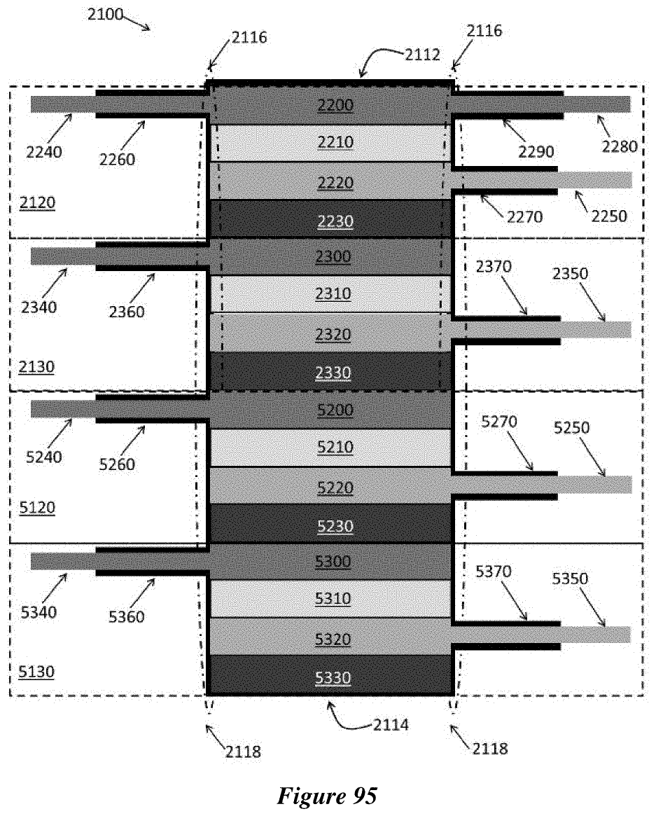

For example, referring now to FIG. 95, the first feedwater layer 2200 can further comprise a first outflow protrusion 2280 (e.g., one or more first outflow protrusions 2280), the first outflow protrusion 2280 (e.g., each of the one or more first outflow protrusions 2280) extends from a portion of the edge of the first feedwater layer 2200 from a proximal end to a distal end opposite and spaced apart from the proximal end, the first outflow protrusion 2280 (e.g., each of the one or more first outflow protrusions 2280) being fluidly connected to the first feedwater layer 2200 from which it extends. In some examples, at least a portion of the first outflow protrusion 2280 (e.g., at least a portion of each of the one or more first outflow protrusions 2280) is integrally formed with the first feedwater layer 2280 from which it extends.

In certain examples, the system further comprises an outflow conduit 2290 (e.g. one or more outflow conduits 2290), wherein the perimeter 2116 of the system is perforated by the outflow conduit 2290 (e.g., each of the one or more outflow conduits 2290). The outflow conduit 2290 (e.g., each of the one or more outflow conduits 2290) extends from the perimeter 2116 of the system from a proximal end to a distal end. The outflow conduit 2290 (e.g., each of the one or more outflow conduits 2290) has an exterior surface that is substantially impermeable (e.g., watertight) and an interior surface that defines a lumen. The lumen of the outflow conduit 2290 contains a first portion of the outflow protrusion 2280 and a second portion of the outflow protrusion 2280 extends beyond the distal end of the outflow conduit 2290. For example, the lumen of each of the one or more outflow conduits 2290 contains a first portion of each of the one or more outflow protrusions 2280, and a second portion of each of the one or more outflow protrusions 2280 extends beyond the distal end of each of the one or more outflow conduits 2290.

For example, the system can be configured such that there is a driving force to produce update of a liquid and/or solution by the feedwater protrusion(s), from the feedwater protrusion(s) across the feedwater layer to the outflow protrusion(s), and out the outflow protrusion(s). The driving force can, for example, be gravity based (e.g., the feedwater protrusion(s) are elevated above the outflow protrusions(s)), capillary based (e.g., increasing capillary force from the feedwater protrusions(s) to the outlet protrusion(s), etc.

The system 2100 further comprises: a top surface 2112; a bottom surface 2114 opposite and spaced apart from the top surface 2112; a perimeter 2116 defined by an edge 2118. In some examples, the top surface 2112 and the bottom surface 2114 of are substantially parallel to each other.

In some examples, the top surface 2112 and the perimeter 2116 of the system 2100 are each substantially impermeable (e.g., to ions, solutions, and/or liquids). In some examples, the top surface 2112 and the perimeter 2116 of the system 2100 are each substantially watertight. In some examples, the bottom surface 2114 is substantially impermeable (e.g., to ions, solutions, and/or liquids). In some examples, the bottom surface 2114 is substantially watertight. In certain examples, the bottom surface 2114 of the system comprises the final thermally conductive layer 5330.

In some examples, the system further comprises a terminal feedwater layer 2600, wherein the final stage 5130 is stacked on top of the terminal feedwater layer 2600, such that the final thermally conductive layer 5330 is disposed on top of an in physical and thermal contact with the terminal feedwater layer 2600. In some examples, the bottom surface 2114 comprises the terminal feedwater layer 2600.

The terminal feedwater layer 2600 has a top surface 2602, a bottom surface 2604 opposite and spaced apart from the top surface 2602, and a perimeter 2606 defined by an edge 2608. In some examples, the top surface and the bottom surface of the terminal feedwater layer are substantially parallel to each other. The layer can have an average thickness, the average thickness being the average dimension from the top surface to the bottom surface.

The top surface 2602 and the bottom surface 2604 of the terminal feedwater layer 2600 can, independently, be any shape. In some examples, the top surface 2602 and the bottom surface 2604 of the terminal feedwater layer 2600 can, independently, be substantially circular, ovate, ovoid, elliptic, triangular, rectangular, polygonal, etc. In some examples, the top surface 2602 and the bottom surface 2604 of the terminal feedwater layer 2600 can be substantially the same shape. In some examples, the top surface 2602 and the bottom surface 2604 of the terminal feedwater layer 2600 can be substantially rectangular.

In some examples, the terminal feedwater layer 2600 can further comprise an terminal feedwater protrusion 2640 (e.g., one or more terminal feedwater protrusions 2640), wherein the terminal feedwater protrusion 2640 (e.g., each of the one or more terminal feedwater protrusions 2640) extends from a portion of the edge 2608 of the terminal feedwater layer 2600 from a proximal end 2642 to a distal end 2644 opposite and spaced apart from the proximal end 2642, the terminal feedwater protrusion 2640 (e.g., each of the one or more terminal feedwater protrusions 2640) being fluidly connected to the terminal feedwater layer 2600 from which it extends. In some examples, at least a portion of the terminal feedwater protrusion 2640 (e.g., at least a portion of each of the one or more terminal feedwater protrusions 2640) is integrally formed with the terminal feedwater layer 2600 from which it extends.

The system 2100 is configured to be flexible. For example, the system 2100 is flexible such that the system 2100 can be rolled and/or folded when being stored (e.g., to be more spatially compact) and then unrolled and/or unfolded when deployed. In some examples, the system 2100 is further configured to be lightweight, such that the system can be easily transported.

In some examples, the system 2100 is configured to be deployed in reservoir 2400 containing a contaminated aqueous solution 2410, the contaminated aqueous solution 2410 having a surface 2412.

In some examples, the system is configured to be deployed on land or on a vehicle, wherein the system is deployed proximate a contaminated aqueous solution 2410, e.g. proximate a reservoir containing a contaminated aqueous solution 2410.

In some examples, the system 2100 is configured to be buoyant, such that the system 2100 floats in the contaminated aqueous solution 2410 when deployed therein.

In some examples, the system 2100 further comprises a buoyant frame 2700 that is configured to be coupled to the system 2100 and/or the receptacle 2500 such that the system 2100 and/or the receptacle 2500 is buoyant. In some examples, the buoyant frame 2700 comprises external floats or buoys coupled to a frame, said frame itself being buoyant or non-buoyant.

In certain examples, at least a portion of the system 2100 is disposed above the surface 2412 of the contaminated aqueous solution 2410. In certain examples, the system 2100 is disposed above the surface 2412 of the contaminated aqueous solution 2410, for example such that the bottom surface 2114 is disposed above the surface 2412 of the contaminated aqueous solution 2410, e.g. such that there is an air gap between the bottom surface 2114 of the device and the surface 2412 of the contaminated aqueous solution 2410.

In certain examples, wherein the system 2100 includes the a terminal feedwater layer 2600, the system 2100 is configured to be buoyant such that the terminal feedwater layer 2600 is disposed above the surface 2412 of the contaminated aqueous solution 2410, e.g. such that there is an air gap between the bottom surface 2604 of the terminal feedwater layer 2600 and the surface 2412 of the contaminated aqueous solution 2410.

When the system is deployed, the second portion 5240b of each of the one or more additional feedwater protrusions 5240 and the second portion 5340b of the final feedwater protrusion 5340 (e.g., the second portion 5340b of each of the one or more final feedwater protrusions 5340) are each independently configured to be in contact with the contaminated aqueous solution 2410. Each of the one or more additional feedwater layers 5200 is independently configured to receive a portion of the contaminated aqueous solution from its respective feedwater protrusion 5240, said portion of the contaminated aqueous solution being a feed solution. The final feedwater layer 5300 is configured to receive a final portion of the contaminated aqueous solution from the final feedwater protrusion 5340, said final portion of the contaminated aqueous solution being a final feed solution. The thermally conductive layer of a preceding stage is configured to collect the latent heat of condensation released during the formation of the condensate in said preceding stage and conduct the collected latent heat of condensation to the feedwater layer of a subsequent stage to thereby distill at least a portion of the feed solution through the membrane distillation layer of said subsequent stage, thereby producing a distillate in said distillate layer. Said distillate layer is configured to receive said distillate from said membrane distillation layer and condense the distillate to form a condensate and release a latent heat of condensation. Distilling said portion of the feed solution through the membrane distillation layer purifies said portion of the feed solution to produce a purified aqueous solution as the condensate. The distal end 5274 of each of the one or more additional distillate conduits 5270 and the distal end 5374 of the final distillate conduit 5370 (e.g., the distal end 5374 of each of the one or more final distillate conduits 5370) are each independently configured to be fluidly connected to the receptacle 2500, such that the second portion 5250b of each of the one or more additional distillate protrusions 5250 and the second portion 5350b of the final distillate protrusion 5350 (e.g., the second portion 5350b of each of the one or more final distillate protrusion 5350) are each independently configured to be disposed within the receptacle 2500, such that the receptacle 2500 is configured to receive and collect the purified aqueous solution from each of the one or more additional distillate layers 5220 via their respective distillate protrusions 5250 and from the final distillate layer 5320 via the final distillate protrusion 5350 (e.g., via each of the one or more final distillate protrusions 5350). In some examples, the distal end 5274 of each of the one or more additional distillate conduits 5270 and the distal end 5374 of the final distillate conduit 5370 (e.g., the distal end 5374 of each of the one or more final distillate conduits 5370) are each independently configured to form a watertight and/or impermeable seal with the receptacle 2500.

Systems 100 and 2100

In any of the example systems disclosed herein, each of the solar absorber layer, the feedwater layers, the membrane distillation layers, the distillate layers, and the thermally conductive layers independently can have an average lateral dimension (e.g., diameter when the surface is substantially circular, diagonal when the surface is substantially rectangular, bisector when the surface is substantially triangular). For example, the average lateral dimension can be 50 millimeters (mm) or more (e.g., 75 mm or more, 100 mm or more, 125 mm or more, 150 mm or more, 200 mm or more, 250 mm or more, 300 mm or more, 400 mm or more, 500 mm or more, 750 mm or more, 1 meter (m) or more, 5 meters or more, 10 meters or more, or 50 meters or more). In some examples, the average lateral dimension can be 100 meters (m) or less (e.g., 50 m or less, 10 m or less, 5 m or less, 1 m or less, 750 mm or less, 500 mm or less, 300 mm or less, 250 mm or less, 200 mm or less, 150 mm or less, 125 mm or less, 100 mm or less, or 75 mm or less). The average lateral dimension of each of layers can independently range from any of the minimum values described above to any of the maximum values described above. For example, the average lateral dimension can be from 50 mm to 100 m (e.g., from 50 mm to 1 m, from 1 m to 100 m, from 50 mm to 100 mm, from 100 mm to 1 m, from 1 m to 10 m, from 10 m to 100 m, from 100 mm to 100 m, from 50 mm to 50 m, or from 100 mm to 50 m).

The solar absorber layer can comprise any material consistent with the methods, devices, and systems disclosed herein. In some examples, the solar absorber layer comprises a material with a high solar thermal absorptivity. In some examples, the solar absorber layer comprises paint (e.g., black paint), a carbonaceous material, metal oxides, composite metals, spectrally selective commercial absorbers, or a combination thereof.

The solar absorber layer can, for example, have an average thickness of 1 mm or more (e.g., 2 mm or more, 3 mm or more, 4 mm or more, 5 mm or more, 10 mm or more, 15 mm or more, 20 mm or more, 30 mm or more, 40 mm or more, 50 mm or more, 75 mm or more, 100 mm or more, 125 mm or more, 150 mm or more, or 175 mm or more). In some examples, the solar absorber layer can have an average thickness of 200 mm or less (e.g., 175 mm or less, 150 mm or less, 125 mm or less, 100 mm or less, 75 mm or less, 50 mm or less, 40 mm or less, 30 mm or less, 25 mm or less, 15 mm or less, 10 mm or less, or 5 mm or less). The average thickness of the solar absorber layer can range from any of the minimum values described above to any of the maximum values described above. For example, the solar absorber layer can have an average thickness of from 1 mm to 200 mm (e.g., from 1 mm to 10 mm, from 10 mm to 200 mm, from 1 mm to 40 mm, from 40 mm to 80 mm, from 80 mm to 120 mm, from 120 mm to 160 mm, from 160 mm to 200 mm, from 5 mm to 200 mm, from 1 mm to 175 mm, or from 5 mm to 175 mm).

In some examples, the first feedwater layer can further comprise a solar absorber material, e.g. integrated therein. The solar absorber material can comprise any material consistent with the methods, devices, and systems disclosed herein. In some examples, the solar absorber material comprises a material with a high solar thermal absorptivity. In some examples, the solar absorber material comprises paint (e.g., black paint), a carbonaceous material, metal oxides, composite metals, spectrally selective commercial absorbers, or a combination thereof.

Each of the protrusions and their respective feedwater or distillate layers can comprise any material consistent with the methods, devices, and systems disclosed herein. In some examples, each of the protrusions and their respective feedwater or distillate layers can independently comprise a hydrophilic material, such as a hydrophilic polymer. In some examples, each of the protrusions and their respective feedwater or distillate layers can independently comprise cellulose or derivatives thereof, polyacrylonitrile or derivatives thereof, or combinations thereof. In some examples, each of the protrusions and their respective feedwater or distillate layers can independently comprise cellulose, cotton, nylon, acrylic, polyester, wool, rayon, polyacrylonitrile, hydrogel; derivatives thereof; and combinations thereof. In some examples, each of the protrusions and their respective feedwater or distillate layers can independently comprise a porous hydrophilic material. In some examples, each of the protrusions and their respective feedwater or distillate layers can independently comprise a porous cellulosic hydrophilic material.

In some examples, any of the impermeable and/or watertight components of any of the systems disclosed herein (e.g., any of the surfaces, the layers, the protrusions, the conduits, etc.) can be provided by any suitable material (e.g., a coating or a film), such as a polymer (e.g., a polymer coating or film). Examples of polymers include, but are not limited to, polyolefins (e.g., polypropylene, polyethylene, polyisobutylene, polymethylpentene, polybutylene, ethylene propylene rubber, and ethylene propylene diene monomer rubber), polycarbonates, ethylene vinyl acetate, polyesters (e.g., polyglycolic acid, polylactic acid, polycaprolactone, polyhydroxyalkanoates, polyethylene terephthalate (PET), polybutylene terephthalate, polytrimethylene terephthalate, and polyethylene naphthalate), polyurethanes, polyamides (e.g., Nylon), polyimides, polystyrene, polyacrylates, ABS (acrylonitrile butadiene styrene copolymers), vinyl polymers (e.g., polyvinyl chloride), fluoropolymers (e.g., polytetrafluoroethylene (PTFE), polyvinylidene fluoride (PVDF)), copolymers thereof, and blends thereof. The coating or film can, in some examples, also be insulative. In some examples, the coating or film can be highly transmissive to solar irradiance. For example, the composition of the coating/film can be selected to maximize the amount of solar irradiance that can pass through, e.g. to the solar absorber and/or first feedwater layer, while minimizing the amount of heat that can escape from the solar absorber and/or first feedwater layer back into the environment rather than being conducted into the device and used to produce water vapor. In some examples, each of the protrusions and their respective feedwater or distillate layers can independently comprise a polymer. Examples of polymers include, but are not limited to, polyolefins (e.g., polypropylene, polyethylene, polyisobutylene, polymethylpentene, polybutylene, ethylene propylene rubber, and ethylene propylene diene monomer rubber), polycarbonates, polyesters (e.g., polyglycolic acid, polylactic acid, polycaprolactone, polyhydroxyalkanoates, polyethylene terephthalate (PET), polybutylene terephthalate, polytrimethylene terephthalate, and polyethylene naphthalate), polyurethanes, polyamides (e.g., Nylon), polyimides, polystyrene, polyacrylates, ABS (acrylonitrile butadiene styrene copolymers), vinyl polymers (e.g., polyvinyl chloride), fluoropolymers (e.g., polytetrafluoroethylene (PTFE), polyvinylidene fluoride (PVDF)), copolymers thereof, and blends thereof.

In some examples, each of the protrusions and their respective feedwater or distillate layer comprise air, e.g. such that the conduits and their respective feedwater or distillate layers are hollow.

Each feedwater and/or distillate layer independently can have an average thickness of 100 μm or more (e.g., 150 μm or more, 200 μm or more, 250 μm or more, 300 μm or more, 400 μm or more, 500 μm or more, 750 μm or more, 1 millimeter (mm) or more, 2 mm or more, 3 mm or more, 4 mm or more, 5 mm or more, 10 mm or more, 15 mm or more, 20 mm or more, 30 mm or more, or 40 mm or more). In some examples, each feedwater and/or distillate layer can independently have an average thickness of 50 mm or less (e.g., 40 mm or less, 30 mm or less, 25 mm or less, 15 mm or less, 10 mm or less, 5 mm or less, 4 mm or less, 3 mm or less, 2 mm or less, 1 mm or less, 750 μm or less, 500 μm or less, 400 μm or less, 300 μm or less, 250 μm or less, 200 μm or less, or 150 μm or less). The average thickness of each of the feedwater and/or distillate layers can independently range from any of the minimum values described above to any of the maximum values described above. For example, each of the feedwater and/or distillate layers can independently have an average thickness of from 100 μm to 50 mm (e.g., from 100 μm to 1 mm, from 1 mm to 50 mm, from 200 μm to 50 mm, from 100 μm to 40 mm, or from 200 μm to 40 mm).

Each membrane distillation layer can independently comprise any material consistent with the methods, devices, and systems disclosed herein. In some examples, each membrane distillation layer can independently comprise a porous distillation membrane. The porous distillation membrane can comprise any membrane suitable for membrane distillation, such as those known in the art. In some examples, the porous distillation membrane can comprise a polymer, such as a hydrophobic polymer. Examples of suitable polymers include, but are not limited to, polyolefins (e.g., polypropylene, polyethylene, polyisobutylene, polymethylpentene, polybutylene, ethylene propylene rubber, and ethylene propylene diene monomer rubber), polycarbonates, polyesters (e.g., polyglycolic acid, polylactic acid, polycaprolactone, polyhydroxyalkanoates, polyethylene terephthalate (PET), polybutylene terephthalate, polytrimethylene terephthalate, and polyethylene naphthalate), polyurethanes, polyamides (e.g., Nylon), polyimides, polystyrene, polyacrylates, ABS (acrylonitrile butadiene styrene copolymers), vinyl polymers (e.g., polyvinyl chloride), fluoropolymers (e.g., polytetrafluoroethylene (PTFE), polyvinylidene fluoride (PVDF)), copolymers thereof, and blends thereof. In some examples, the polymer can comprise polytetrafluoroethylene, polyvinylidene chloride, polyvinylidene fluoride, polyethylene, polypropylene, polymethylmethacrylate, polystyrene, polyester, polyethylene terephthalate, polyamide; derivatives thereof, copolymers thereof, blends thereof, or combinations thereof. In some examples, the polymer can comprise polyvinylidene fluoride (PVDF), polypropylene, polytetrafluoroethylene (PTFE), polyamide; derivatives thereof; or combinations thereof. In some examples, the top surface of each membrane distillation layer is superhydrophobic.

The porous distillation membrane can, for example, be permeated by a plurality of pores. The plurality of pores can have any shape, such as, for example a polyhedron (e.g., a platonic solid, a prism, a pyramid), a cylinder, a hemicylinder, an elliptical cylinder, a hemi-elliptical cylinder, a cone, a semicone, etc. The plurality of pores can have an average pore size. As used herein “pore size” refers to the largest cross-sectional dimension of a pore in a plane perpendicular to the longitudinal axis of the pore. For example, in the case of a substantially cylindrical pore, the pore size would be the diameter of the pore. In some examples, the average pore size can be substantially the same for the entire thickness of the porous distillation membrane. In some examples, the average pore size can vary with the thickness of the porous distillation membrane (e.g., tapered or conical pores). The average pore size can be determined, for example, using electron microscopy (e.g., scanning electron microscopy (SEM), scanning transmission electron microscopy (STEM)), Brunauer-Emmett-Teller (BET) measurements, porosimetry, or a combination thereof.

The plurality of pores can, for example, have an average pore size of 100 nanometers (nm) or more (e.g., 150 nm or more, 200 nm or more, 250 nm or more, 300 nm or more, 400 nm or more, 500 nm or more, 750 nm or more, 1 μm or more, 2 μm or more, 3 μm or more, 4 μm or more, 5 μm or more, 10 μm or more, 15 μm or more, 20 μm or more, 30 μm or more, or 40 μm or more). In some examples, the plurality of pores can have an average pore size of 50 μm or less (e.g., 40 μm or less, 30 μm or less, 25 μm or less, 15 μm or less, 10 μm or less, 5 μm or less, 4 μm or less, 3 μm or less, 2 μm or less, 1 μm or less, 750 nm or less, 500 nm or less, 400 nm or less, 300 nm or less, 250 nm or less, 200 nm or less, or 150 nm or less). The pore size of the plurality of pores can range from any of the minimum values described above to any of the maximum values described above. For example, the plurality of pores can have an average pore size of from 100 nm to 50 μm (e.g., from 100 nm to 1 μm, from 1 μm to 50 μm, from 200 nm to 50 μm, from 100 nm to 40 μm, or from 200 nm to 40 μm).

Each membrane distillation layer independently can have an average thickness of 100 μm or more (e.g., 150 μm or more, 200 μm or more, 250 μm or more, 300 μm or more, 400 μm or more, 500 μm or more, 750 μm or more, 1 millimeter (mm) or more, 2 mm or more, 3 mm or more, 4 mm or more, 5 mm or more, 10 mm or more, 15 mm or more, 20 mm or more, 30 mm or more, or 40 mm or more). In some examples, each membrane distillation layer can independently have an average thickness of 50 mm or less (e.g., 40 mm or less, 30 mm or less, 25 mm or less, 15 mm or less, 10 mm or less, 5 mm or less, 4 mm or less, 3 mm or less, 2 mm or less, 1 mm or less, 750 μm or less, 500 μm or less, 400 μm or less, 300 μm or less, 250 μm or less, 200 μm or less, or 150 μm or less). The average thickness of each of the membrane distillation layers can independently range from any of the minimum values described above to any of the maximum values described above. For example, each of the membrane distillation layers can independently have an average thickness of from 100 μm to 50 mm (e.g., from 100 μm to 1 mm, from 1 mm to 50 mm, from 200 μm to 50 mm, from 100 μm to 40 mm, or from 200 μm to 40 mm).

Each of the thermally conductive layers can independently comprise any material consistent with the methods, devices, and systems disclosed herein. In some examples, each of the thermally conductive layers independently comprises a thermally conductive and corrosion resistant material, such as a corrosion resistant metal, such as aluminum (e.g., aluminum foil), stainless steel, or a combination thereof. In some examples, each of the thermally conductive layers can independently comprise a polymeric material that is substantially impermeable and able to withstand the operating temperatures of the system. In some examples, the thermally conductive layer can comprise a material with a low thermal conductivity, but wherein the thickness of the thermally conductive layer is selected such that the temperature drop across the layer is minimized (e.g., 5° C. or less or 1° C. or less).

Each thermally conductive layer independently can have an average thickness of 100 μm or more (e.g., 150 μm or more, 200 μm or more, 250 μm or more, 300 μm or more, 400 μm or more, 500 μm or more, 750 μm or more, 1 millimeter (mm) or more, 2 mm or more, 3 mm or more, 4 mm or more, 5 mm or more, 10 mm or more, 15 mm or more, 20 mm or more, 30 mm or more, or 40 mm or more). In some examples, each thermally conductive layer can independently have an average thickness of 50 mm or less (e.g., 40 mm or less, 30 mm or less, 25 mm or less, 15 mm or less, 10 mm or less, 5 mm or less, 4 mm or less, 3 mm or less, 2 mm or less, 1 mm or less, 750 μm or less, 500 μm or less, 400 μm or less, 300 μm or less, 250 μm or less, 200 μm or less, or 150 μm or less). The average thickness of each of the thermally conductive layers can independently range from any of the minimum values described above to any of the maximum values described above. For example, each of the thermally conductive layers can independently have an average thickness of from 100 μm to 50 mm (e.g., from 100 μm to 1 mm, from 1 mm to 50 mm, from 200 μm to 50 mm, from 100 μm to 40 mm, or from 200 μm to 40 mm).

The system can, for example, have one or more stages in total (e.g., 2 or more, 3 or more, 4 or more, 5 or more, 6 or more, 7 or more, 8 or more, 9 or more, 10 or more, 11 or more, 12 or more, 13 or more, 14 or more, 15 or more, 20 or more, 25 or more).

Each stage can independently have an average thickness of 100 μm or more (e.g., 150 μm or more, 200 μm or more, 250 μm or more, 300 μm or more, 400 μm or more, 500 μm or more, 750 μm or more, 1 millimeter (mm) or more, 2 mm or more, 3 mm or more, 4 mm or more, 5 mm or more, 10 mm or more, 15 mm or more, 20 mm or more, 30 mm or more, or 40 mm or more). In some examples, each stage can independently have an average thickness of 50 mm or less (e.g., 40 mm or less, 30 mm or less, 25 mm or less, 15 mm or less, 10 mm or less, 5 mm or less, 4 mm or less, 3 mm or less, 2 mm or less, 1 mm or less, 750 μm or less, 500 μm or less, 400 μm or less, 300 μm or less, 250 μm or less, 200 μm or less, or 150 μm or less). The average thickness of each of stage can independently range from any of the minimum values described above to any of the maximum values described above. For example, each of the stages can independently have an average thickness of from 100 μm to 50 mm (e.g., from 100 μm to 1 mm, from 1 mm to 50 mm, from 200 μm to 50 mm, from 100 μm to 40 mm, or from 200 μm to 40 mm).

In some examples, the top surface of the system can have an average area of 25 cm² or more (e.g., 30 cm² or more, 40 cm² or more, 50 cm² or more, 75 cm² or more, 100 cm² or more, 125 cm² or more, 150 cm² or more, 200 cm² or more, 250 cm² or more, 300 cm² or more, 400 cm² or more, 500 cm² or more, 750 cm² or more, 1000 cm² or more, 1250 cm² or more, 1500 cm² or more, 2000 cm² or more, 2500 cm² or more, 5000 cm² or more, 7500 cm² or more, 1 m² or more, 2 m² or more, 3 m² or more, 4 m² or more, 5 m² or more, 10 m² or more, 15 m² or more, 20 m² or more, 30 m² or more, or 40 m² or more). In some examples, the top surface of the system can have an average area of 50 m² or less (e.g., 40 m² or less, 30 m² or less, 20 m² or less, 15 m² or less, 10 m² or less, 5 m² or less, 4 m² or less, 3 m² or less, 2 m² or less, 1 m² or less, 7500 cm² or less, 5000 cm² or less, 2500 cm² or less, 2000 cm² or less, 1500 cm² or less, 1250 cm² or less, 1000 cm² or less, 750 cm² or less, 500 cm² or less, 400 cm² or less, 300 cm² or less, 250 cm² or less, 200 cm² or less, 150 cm² or less, 125 cm² or less, 100 cm² or less, 75 cm² or less, 50 cm² or less, 40 cm² or less, or 30 cm² or less). The average area of the top surface of the system can range from any of the minimum values described above to any of the maximum values described above. For example, the top surface of the system independently have an area of from 25 cm² to 50 m² (e.g., from 25 cm² to 1 m², from 1 m² to 50 m², from 25 cm² to 250 cm², from 250 cm² to 2500 cm², from 2500 cm² to 1 m², from 1 m² to 25 m², from 25 m² to 50 m², from 50 cm² to 50 m², from 25 cm² to 40 m², or from 50 cm² to 40 m²).

In some examples, the system has a specific water productivity of 1 liters of water per square meter of area of the top surface of the system per hour (L m⁻² h⁻¹, LMH) or more (e.g., 1.5 LMH or more, 2 LMH or more, 2.5 LMH or more, 3 LMH or more, 3.5 LMH or more, 4 LMH or more, 4.5 LMH or more, 5 LMH or more, 6 LMH or more, 7 LMH or more, 8 LMH or more, 9 LMH or more, or 10 LMH or more).

The contaminated aqueous solution can comprise any type of water, treated or untreated. For example, the contaminated aqueous solution can comprise hard water, hard brine, sea water, brackish water, fresh water, flowback or produced water, wastewater (e.g., reclaimed or recycled), river water, lake or pond water, aquifer water, brine (e.g. reservoir or synthetic brine), slickwater, flood surge water, or a combination thereof. In some examples, the contaminated aqueous solution can comprise hard water, hard brine, sea water, brackish water, flowback or produced water, wastewater (e.g., reclaimed or recycled), brine (e.g. reservoir or synthetic brine), slickwater, or a combination thereof. In some examples, the contaminated aqueous solution comprises seawater. In some examples, the contaminated aqueous solution comprises saline water (e.g., high salinity water).

In some examples, the purified aqueous solution can comprise water, such as fresh water (e.g., potable or drinking water).

In some examples, the system is configured as a portable solar-driven system for potable water production.

In some examples, the system is configured to be robust, such that the system can be rolled and/or folded to be stored and then unrolled/unfolded to be deployed multiple times without the layers being damaged or delaminating, such that the specific water productivity is substantially unaffected

In some examples, the system further comprises the receptacle 500.

In some examples, the system further comprises one or more pumps configured to pump the contaminated aqueous solution into each feedwater layer and/or to pump the purified aqueous solution into the receptacle.

In some examples, the system can further comprise a means (e.g., via pumping, gravity driven flow, etc.) for evacuating the purified water from the receptacle into another storage vessel, such as a land based storage vessel. For example, the receptacle can be decoupled from the system, transported proximate to the other storage vessel, and the purified aqueous solution can be decanted (e.g. poured, pumped, etc.) into the other storage vessel. In some examples, the system further comprises one or more pumps and/or conduits configured to pump the purified aqueous solution from the receptacle to the other storage vessel.

Also disclosed herein are methods of making the systems disclosed herein. The methods can, for example, comprise disposing each of the layers within a stage on top of one another, subsequently stacking each of the stages on top of one another and disposing or coating the solar absorber layer on the top surface. In some examples, the methods can further comprise making each of the layers. In some examples, the methods can comprise layer-by-layer electrospinning, electrospraying, solution casting, sintering, solvent welding (with liquid or vapor phase solvent), or phase inversion of the layers.

Also disclosed herein are methods of sealing the perimeter of each layer and/or methods of sealing the layers together. As used herein, “sealed” and variants thereof (e.g., seal, sealing, and the like) refer to a fluid impermeable barrier the prevents communication of fluids into or out of the seal. The methods can, for example, comprise using layer-by-layer electrospinning of the layers, solvent induced welding, an adhesive, heat pressing, clamps, or a combination thereof to seal the perimeter of each layer and/or to seal the layers together. In some examples, the sealing can be accomplished in a manner that allows for the system to be flexible and/or lightweight while remaining substantially watertight. For example, the sealing can be accomplished without a rigid sealing means, e.g. without a rigid plate-and-frame and/or nuts-and-bolts.

Also disclosed herein are methods of using the systems disclosed herein. For example, the methods can comprise deploying the system in a contaminated aqueous solution and exposing the system to solar radiation to form a purified aqueous solution. In some examples, the purified aqueous solution comprises water, such as fresh water (e.g., potable or drinking water).

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

The growing demand for desalination to augment water supply coupled with concerns about the environmental impacts of powering desalination using fossil fuel have spurred substantial interest in developing desalination systems that are powered by renewable energy. Tremendous interest in developing integrated solar-thermal desalination (STD) systems has emerged.

Solar-thermal desalination (STD) is a potentially low-cost, sustainable approach for providing high-quality fresh water in the absence of water and energy infrastructures. Despite recent efforts to advance STD by improving heat-absorbing materials and system designs, several factors, such as modularity, mobility, and productivity, limit the practical application of STD systems. Accordingly, a need still exists for improved STD systems.

Described herein are solar thermal desalination (STD) systems, wherein the system is based on a flexible, solar-driven, multi-stage membrane distillation (MD) system which can have one or more of the following characteristics: High productivity: exceed typical solar still by multiple folds; High product water quality; Completely passive: no pump and any mechanical or electrical component; Highly portable: flexible, roll-able, lightweight; Modular: can be scaled linearly to accommodate different capacity demand; Robust: advanced material strategies used for antifouling properties; and/or Low capital cost for acquisition, installation, maintenance, repair, or a combination thereof.

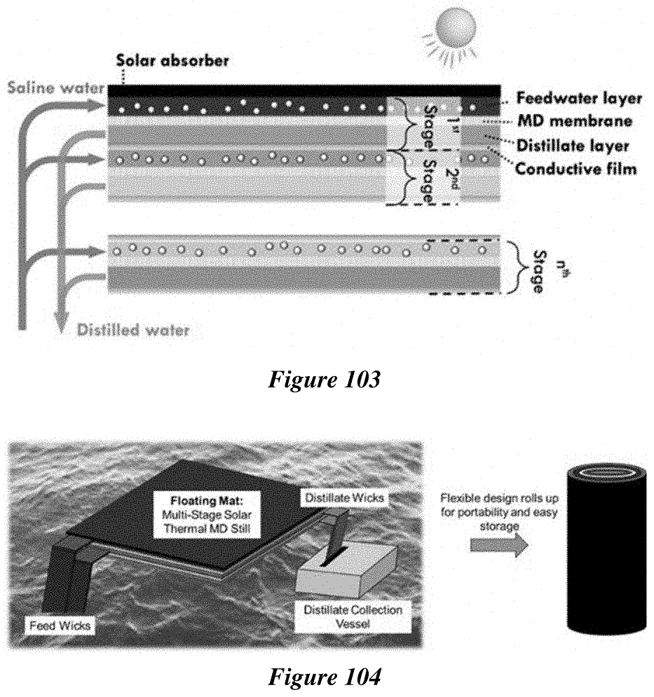

The technical design of the system is illustrated in FIG. 103 and the working principle is as follows: The non-porous solar absorber (commercial or lab-fabricated) on the top layer efficiently absorbs solar radiation and converts it to heat. The feed water layer right underneath the solar absorber is heated up and water evaporates. Water vapor passes through a hydrophobic microporous membrane (i.e., the MD membrane) and condenses in the distillate layer underneath the MD membrane. The heat released in the distillate layer conducts through a flexible, thermally conductive film to the feed water layer of the next stage.

Starting from the top, a feed water layer, an MD membrane, a distillate layer, and the conductive film at the bottom, together comprise a stage. Each stage has a thickness of less than 2 mm. The system comprises multiple (n>5) such stages and a topping solar absorber.

The feed side of each MD membrane can be superhydrophobic as to avoid mineral scaling that may block the membrane and reduce drinking water productivity and salt rejection (Su C et al. Environ. Sci. Technol. 2019, 53(20), 11801-11809; Hou D et al. J. Memb. Sci. 2020, 599, 117708; Xiao Z et al. Desalination. 2019, 466, 36-43; Yin Y et al. Environ. Sci. Water Res. Technol. 2019, 5, 2004-2014; Zheng R et al. Water Res. 2019, 155(15), 152-161). Each feed water or distillate layer can be filled with a hydrophilic porous matrix with part of it extending out of the feed water or distillate channel. This extended part can serve as a wick to transport saline water into the feed water channel and distilled water out of the distillate channel via capillary forces. The bottom of the last stage is placed directly in or on the feed water reservoir whether it's offshore (e.g., in the ocean) or on-land.

The multi-stage MD design allows for latent heat recovery (Christie K S S et al. Environ. Int. 2020, 138, 105588; Lin S et al. J. Memb. Sci. 2014, 453, 498-515; Lin S. Environ. Sci. Technol. 2020, 54(1), 76-84). Specifically, latent heat recovery is realized by reusing the heat released in the vapor condensation in one stage to evaporate feed water in the next stage. The capability of latent heat recovery can allow the system to achieve a high specific water productivity (SWP). The impact of latent heat recovery in designing high-performance STD has only been emphasized very recently (Wang Z et al. Sci. Adv. 2019, 5, 0-35). Because a passive STD system does not require any electricity or fuel input, the primary cost of water production is the capital cost. A high SWP means a smaller system footprint and lower capital cost, which can minimize the levelized cost of water production (LCOW).

The entire Solar-Aqua-Flex system can be fabricated as a flexible, integrated “mat” without any solid housing and can thus be rollable (FIG. 104). The system can be fabricated using advanced film-processing techniques, including electro-spinning, to fabricate a flexible integrated system. All existing MD systems, driven by solar energy or not, have heavy plastic or metal housings that hold the different layers tightly in contact with each other (Chiavazzo E et al. Nat. Sustain. 2017, 1, 763-772; Dsilva Winfred Rufuss D et al. Renew. Sustain. Energy Rev. 2016, 63, 464-496; Wang W et al. Nat. Commun. 2019, 10, 3012; Xu Z et al. Energy Environ. Sci. 2020, 3, 830-839; Sharshir S W et al. Process Saf. Environ. Prot. 2019, 124, 204-212). Therefore, an STD system with a large area for receiving solar radiation is heavy, bulky, and not appropriate for potable application. The system disclosed herein will overcome this practical challenge to be a portable STD with a high SWP.

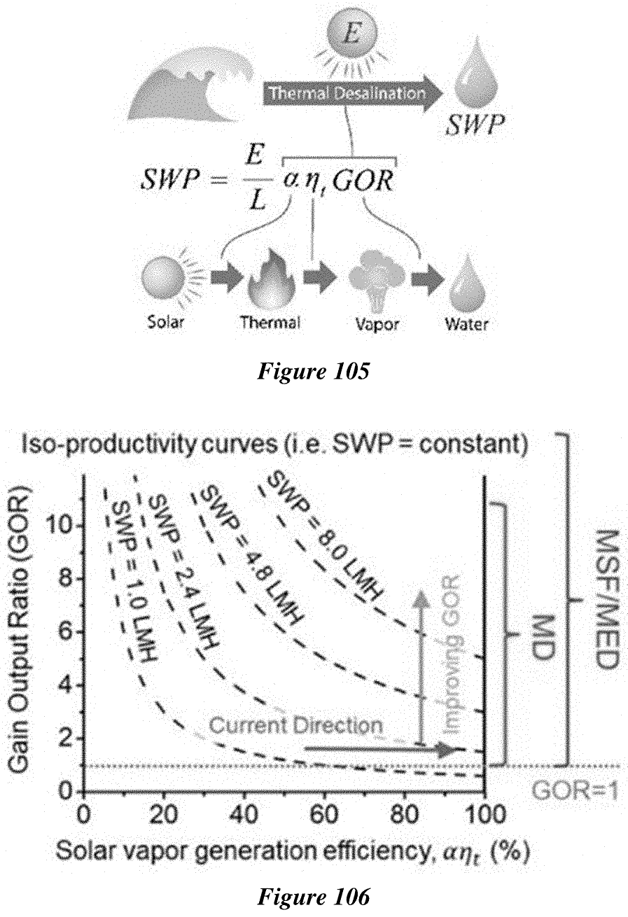

While the solar still (the primitive form of an STD system) has existed for hundreds of years, its efficiency is rather unsatisfactory. The efficiency of an STD is generally quantified by its specific water productivity (SWP), defined as the volume of water produced per area of the STD system per time. In Wang et al. (Science Advances, 2019, 5, eaax0763), a framework was presented for quantifying the SWP of an STD system which can be summarized by a simple and universally applicable governing equation for STD as shown in FIG. 105. Briefly, the analysis suggests that research focusing on improving the solar-absorptivity (a) of the solar absorber and on enhancing the thermal efficiency (ηₜ, quantifying the percentage of generated heat utilized for evaporation) has a margin of return because their product, namely the solar-to-vapor generation efficiency, αηₜ, is theoretically capped at one (FIG. 106). The more rewarding direction for improving the SWP is to maximize recovering the latent heat released in condensation. The extent of latent heat recovery is commonly quantified in distillation processes using the metric gained output ratio (GOR) which can be much higher than one (FIG. 106) (Christie K S S et al. Environ. Int. 2020, 138, 105588; Lin S et al. J. Memb. Sci. 2014, 453, 498-515; Lin S. Environ. Sci. Technol. 2020, 54(1), 76-84). The proposed design is guided by these rationales to maximize the GOR while maintaining a high solar-to-vapor generation efficiency, αηₜ.

The systems described herein can achieve an SWP of at least 5.0 L m⁻² h⁻¹ (LMH), as compared to the thermodynamic limit of 1.6 LMH for any STD system without latent heat recovery. This can be achieved if an αηₜ of 80% (realistic based on literature) and a GOR of ˜4 (practical for multi-stage MD) is attained. The thermal management is intrinsically optimized in the multi-stage design herein, as there is no pathway for direct heat conduction from the solar absorber to the source water reservoir—a phenomenon that many single-stage solar evaporators are designed to avoid. Notably, the state-of-the-art STD (that actually produces clean water), fabricated following the design proposed in Wang et al. (Science Advances, 2019, 5, eaax0763), can already achieve an SWP close to 6.0 LMH (Wang Z et al. Sci. Adv. 2019, 5, 0-35), which suggests that the above stated technical goal is feasible. However, the reported system in Wang et al. (Science Advances, 2019, 5, eaax0763) relies on a plate-and-frame architecture and is neither flexible nor portable. Lastly, the fabrication of the system is technically feasible via layer-by-layer electrospinning (LbL-e) and other advanced film processing techniques for fabricating composite MD membranes.

There are two main technical milestones in order to develop an operational prototype of the system: (1) fabrication, design, and system integration, and (2) bench-top and pilot scale testing. The prototype will be a thin, flexible, mat that floats on the feed water when deployed for production and rolls up into a cylinder for transport and storage (FIG. 104).

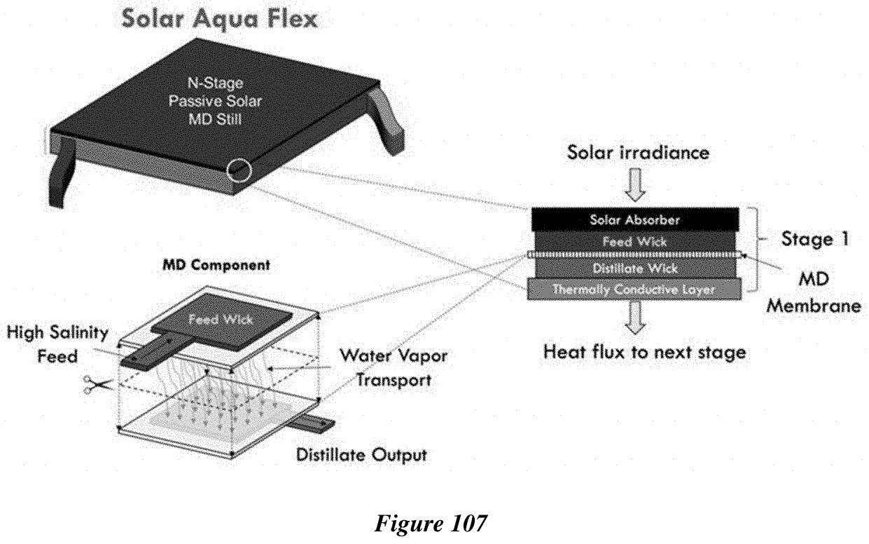

Fabrication, Design, and System Integration: An LbL-e approach can be used to fabricate each stack (or stage) comprising two hydrophilic layers (feed and distillate) and one MD membrane. The MD membrane can overlap both wicking layers in order to seal the feed and distillate wicks and avoid contaminating or losing the distillate. The feed side of the MD membrane can be superhydrophobic as to avoid mineral scaling that can block the membrane pores (Su C et al. Environ. Sci. Technol. 2019, 53(20), 11801-11809). The different stages can be integrated by adhering the next stage's feed water layer to the thermally conductive layer of the current stage. Within each stage, the wicking layers can have tabs that protrude from the stack in order to connect the each of the feed and distillate layers to an external wick (FIG. 107). For offshore applications, the “blanket” can be supported by a buoyant frame that supports the weight of the system when it intakes water via capillary forces.

In the initial stages of performance testing the materials and design strategies can be optimized in order to fabricate a complete system with the goal of simplicity and low capital cost in mind. Specifically, the material for the wicks can be chosen such that the wicking rate is maximized for fast start-up time. The solar absorber layer can comprise either commercial flexible solar absorbers or the solar absorber layer can be fabricated to maximize solar absorptivity and minimize radiative heat loss. Several low-cost solutions exist that satisfy this condition (Zhuang S et al. Adv. Sci. 2018, 5, 1700497; Xu N et al. Adv. Mater. 2017, 29, 1-5; Wang J et al. Adv. Mat. 2017, 29(3), 1-6). Finally, the perimeter of each layer of material can be sealed with state-of-the-art fabrication techniques, including solvent induced welding (Su C et al. Environ. Sci. Technol. 2019, 53(20), 11801-11809; Su C et al. J. Memb. Sci. 2020, 595, 117548) and modification of surface energy so layers can be effectively bind with commercial adhesives.

Performance Testing: In the early design stages the system's MD performance will be evaluated based on SWP under 1 sun (simulated) and the product water quality. The system's ability to handle high salinity waters and seawater will be verified with simulated feed solutions that mimic the common salt species and concentrations in these feed waters. In the early design stage, the system will be tuned to maximize SWP without sacrificing product water quality or system flexibility. Then the system will be tested outdoor for its real-world performance.

After validating the system in lab-scale performance testing, the system will be scaled up for pilot testing. The target footprint of the system in this stage will be on the order of 0.1-1 m². The system will be tested with simulated feed waters under the actual conditions the end user will be subjected to. After any final adjustments, the prototype will be tested in the field.

The proposed system has one or more of the following benefits: light weight, flexible, and absence of any mechanical and electrical components, in addition to its intended function of providing high-quality product water from saline, contaminated feed water. As such, the market where the system is the most competitive includes, but is not limited to, off-grid, small-scale, portable desalination, such as in remote costal and island areas and for forward operation bases. Possible end-users include, for example, recreational campers, homesteaders, coastal villagers, and armed forces. However, due to the low-cost and modularity of the system, it will compete well with other technologies for larger scale applications to provide water to a medium-size community where clean water is not accessible.

The system provides high purity water from saline feed water in an effective and affordable manner Compared to conventional solar stills, the multi-stage nature of the proposed system substantially enhances the SWP, making it more efficient and reducing the system footprint. Compared to other multi-stage MD systems recently emerging in literature, the proposed system is light, flexible, highly portable, and easy to deploy. A system of 1 m² can easily produce more than 25 L of water in a sunny day, which is enough to satisfy the daily drinking requirements of around 5 people. With the integration of the high productivity (SWP) that is typically achievable with large, sophisticated systems and the portability that is typical of low-productivity solar stills, the system will open up new market segments as it provides a low-cost solution for potable off-grid water production.

### Example 2

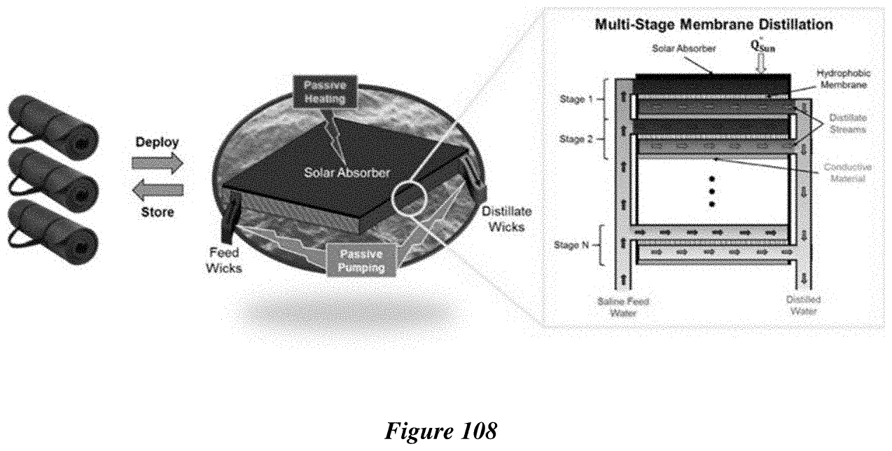

Described herein are systems, for example for off-grid, solar powered, drinking water production. An example system is shown in FIG. 108. The system can have one or more of the following benefits: No moving mechanical parts; No operating costs (passive); Flexible, portable, and modular self-contained device; Diverse water treatment capabilities; High productivity and product water quality; and/or Robust anti-fouling properties.

Additional details of the proposed systems are discussed below.

A flexible solar concentrator can be incorporated so that the top surface of the device can effectively increase its solar absorbing area which can increase overall system productivity.

The system can be integrated with solar thermal energy storage systems as to continue freshwater production during the non-daylight hours.

The feed-side hydrophilic wicking materials can be impregnated with antimicrobial coatings as to inhibit biofouling.

Operational strategies can be developed to help mitigate fouling during non-daylight hours. For example, a small portion of the collected distilled water can be used to rinse the feed side of the system and/or the feed side of the system can stay in the source water so that sparingly soluble scaling salts with inverse solubility temperature relationships (CaCO₃ and CaSO₄) can dissolve back into the source water when the system cools during non-daylight hours.

Hydrophobic coatings can be applied around the edges of the feed side wicking materials within the device as to inhibit salt crystals from creeping outside of the designated areas within the system. Ultimately this limits contamination from the feed to distillate wicking layers.

The device produces potable drinking water for off-grid scenarios where conventional energy and water utilities are scarce or nonexistent altogether. The device requires no external energy sources (other than heat from the sun) and no mechanical or moving parts, enabling easy maintenance practices. Finally, the device is flexible such that it can be rolled up for maximum portability; the device can be packaged densely such that one box, or one person, can hold several devices that provide drinking water for multiple people. Potential vendors/end-users include humanitarian water providers, disaster relief water providers, recreational users (campers, fishers, boaters), and small scale military operations.

The device can enhance evaporation rates in solar evaporation ponds. There is minimal to zero additional operating costs associated with implementing the device as it is completely passive. The device offers enhanced freshwater recovery for the facility and the modular system's output and size scale linearly such that additional device area can be added depending on the end-users water treatment needs. Potential vendors include industrial wastewater treatment EPC firms that design and operate water treatment processes for end users with evaporation ponds in the mining, power, oil & gas, chemical, landfill, food & beverage, pulp & paper, concrete, and agriculture industrial sectors. Additionally, salt production operations that utilize solar evaporation ponds to concentrate their salts may utilize this device in order to increase their solid crystal production rate.

The mat-like design comprises a layered composite membrane distillation system with thickness on the order of several millimeters.

The device is flexible so that it can be rolled up for enhanced portability, high packaging density, and easy storage.

The device can float directly on the source water, requiring no additional space for on-site use.

For a proof of concept, 3-stage devices with 25 square centimeter solar absorbing area can be fabricate and tested for approximately 12 hours. Different design strategies related to separating the dirty feedwater wicking materials and the pure distilled water wicking materials such that fresh potable water can be produced without distillate contamination can be investigated. Additionally, different wicking layer thickness can be investigated to optimize thermal-to-vapor generation efficiency and antifouling properties. A thermal resistor element connected to variable power supply can be used to heat the top surface of the device at an equivalent power of the sun in order to test the performance of the device. Performance metrics of interest include, but are not limited to, the total water vapor flux, long-term stability of water vapor flux, top and bottom surface temperatures, and final product water quality (conductivity). For proof of concept tests, the simulated feedwater can be 3.5 wt % NaCl solution that is held at room temperature (˜20° C.), which are comparable concentrations and surface temperatures of real seawater.

After the design is optimized in the proof of concept phase, more stages will be added to the device to determine the optimal freshwater productivity while considering the tradeoff in additional material costs. The device's performance will be tested in benchtop experiments with the thermal resistor element and simulated wastewater.

With the optimized multi-stage design, the solar absorbing surface will be optimized. A halogen lamp solar simulator will be used to illuminate the top surface of the device and test its performance under photothermal heating similar to that of the sun. Performance metrics related to the solar absorbing layer include solar spectrum absorptivity and maximum top surface temperature.

After the base multi-stage design is optimized, more complex simulated and real wastewaters containing potential fouling species can be tested. The long term performance (>24 hrs) will be tested in benchtop experiments with the thermal resistor heating element and solar simulator heating element. The device will also be used through multiple on-and-off cycles (with the system being rolled up when not in use) to simulate daytime use and nighttime storage. Special anti-biofouling and/or anti-scaling coatings can be applied to the feed wicking materials and the feed side surface of the hydrophobic membrane and operational strategies for limiting salt or microbial growth during system downtime will be designed in order to enhance the long term reliability and robust performance of the device. Design iterations may be necessary to ensure that repeated rolling up for nighttime storage does not limit the device lifetime. The next phase will be scaling up the device size to 0.1-1 square meters.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A flexible membrane distillation system for purifying a contaminated aqueous solution to form a purified aqueous solution for collection in a receptacle; the system comprising:
a solar absorber layer; and
a first stage;
wherein the first stage comprises: a first feedwater layer; a first membrane distillation layer; a first distillate layer; and a first thermally conductive layer;
wherein the first feedwater layer is disposed on top of and in physical and fluid contact with the first membrane distillation layer; the first membrane distillation layer is disposed on top of and in physical and fluid contact with the first distillate layer; and the first distillate layer is disposed on top of and in physical and thermal contact with the first thermally conductive layer; and
wherein the solar absorber layer is disposed on top of and in physical and thermal contact with the first feedwater layer;
wherein each of the first feedwater layer, the first membrane distillation layer, the first distillate layer, and the first thermally conductive layer, independently has a top surface, a bottom surface opposite and spaced apart from the top surface, and a perimeter defined by an edge;
wherein the system further comprises: a first protrusion; and a second protrusion;
wherein the first protrusion extends from a portion of the edge of the first feedwater layer from a proximal end to a distal end opposite and spaced apart from the proximal end, the first protrusion being fluidly connected to the first feedwater layer from which it extends;
wherein the second protrusion extends from a portion of the edge of the first distillate layer from a proximal end to a distal end opposite and spaced apart from the proximal end, the second protrusion being fluidly connected to the first distillate layer from which it extends;
wherein the system further comprises: a top surface; a bottom surface opposite and spaced apart from the top surface; a perimeter defined by an edge; a first conduit; and a second conduit;
wherein the top surface, the bottom surface, and the perimeter of the system are each substantially impermeable;
wherein the perimeter of the system is perforated by the first conduit and the second conduit;
wherein each of the first conduit and the second conduit independently extends from the perimeter of the system from a proximal end to a distal end;
wherein each of the first conduit and the second conduit independently has an exterior surface that is substantially impermeable and an interior surface that defines a lumen;
wherein the lumen of the first conduit contains a first portion of the first protrusion and a second portion of the first protrusion extends beyond the distal end of the first conduit;
wherein the lumen of the second conduit contains a first portion of the second protrusion and a second portion of the second protrusion extends beyond the distal end of the second conduit;
wherein the system is configured to be flexible;
wherein the second portion of the first protrusion is configured to be in contact with the contaminated aqueous solution;
wherein the first feedwater layer is configured to receive a first portion of the contaminated aqueous solution from the first protrusion, said first portion of the contaminated aqueous solution being a first feed solution;
wherein the solar absorber layer is configured to collect solar heat and conduct the collected heat to the first feedwater layer to thereby distill at least a portion of the first feed solution through the first membrane distillation layer, thereby producing a first distillate in the first distillate layer;
wherein the first distillate layer is configured to receive the first distillate from the first membrane distillation layer and condense the first distillate to form a first condensate and release a first latent heat of condensation;
wherein distilling said portion of the first feed solution through the first membrane distillation layer purifies said portion of the first feed solution to produce a first purified aqueous solution as the first condensate;
wherein the first thermally conductive layer is configured to collect the first latent heat of condensation and conduct the collected first latent heat of condensation;
wherein the distal end of the second conduit is configured to be fluidly connected to the receptacle, such that the second portion of the second protrusion is configured to be disposed within the receptacle, such that the receptacle is configured to receive and collect the first purified aqueous solution from the first distillate layer via the second protrusion.

2. The system of claim 1, wherein the system further comprises:
a second stage, wherein the second stage comprises: a second feedwater layer; a second membrane distillation layer; a second distillate layer; and a second thermally conductive layer;
wherein the second feedwater layer is disposed on top of and in physical and fluid contact with the second membrane distillation layer; the second membrane distillation layer is disposed on top of and in physical and fluid contact with the second distillate layer; and the second distillate layer is disposed on top of and in physical and thermal contact with the second thermally conductive layer;
wherein the first stage is stacked on top of the second stage, such that the first thermally conductive layer is disposed on top of and in physical and thermal contact with the second feedwater layer;
wherein each of the second feedwater layer, the second membrane distillation layer, the second distillate layer, and the second thermally conductive layer independently has a top surface, a bottom surface opposite and spaced apart from the top surface, and a perimeter defined by an edge;
wherein the system further comprises: a third protrusion; and a fourth protrusion;
wherein third protrusion extends from a portion of the edge of the second feedwater layer from a proximal end to a distal end opposite and spaced apart from the proximal end, the third protrusion being fluidly connected to the second feedwater layer from which it extends; and
wherein the fourth protrusion extends from a portion of the edge of the second distillate layer from a proximal end to a distal end opposite and spaced apart from the proximal end, the fourth protrusion being fluidly connected to the second distillate layer from which it extends;
wherein the system further comprises: a third conduit; and a fourth conduit;
wherein the perimeter of the system is perforated by the third conduit and the fourth conduit;
wherein each of the third conduit and the fourth conduit independently extends from the perimeter of the system from a proximal end to a distal end;
wherein each of the third conduit and the fourth conduit independently has an exterior surface that is substantially impermeable and an interior surface that defines a lumen;
wherein the lumen of the third conduit contains a first portion of the third protrusion and a second portion of the third protrusion extends beyond the distal end of the third conduit;
wherein the lumen of the fourth conduit contains a first portion of the fourth protrusion and a second portion of the fourth protrusion extends beyond the distal end of the fourth conduit;
wherein the second portion of the third protrusion is configured to be in contact with the contaminated aqueous solution;
wherein the second feedwater layer is configured to receive a second portion of the contaminated aqueous solution from the third protrusion, said second portion of the contaminated aqueous solution being a second feed solution;
wherein the first thermally conductive layer is configured to collect the first latent heat of condensation and conduct the collected first latent heat of condensation to the second feedwater layer to thereby distill at least a portion of the second feed solution through the second membrane distillation layer, thereby producing a second distillate in the second distillate layer;
wherein the second distillate layer is configured to receive the second distillate from the second membrane distillation layer and condense the second distillate to form a second condensate and release a second latent heat of condensation;
wherein distilling said portion of the second feed solution through the second membrane distillation layer purifies said portion of the second feed solution to produce a second purified aqueous solution as the second condensate;
wherein the distal end of the fourth conduit is configured to be fluidly connected to the receptacle, such that the second portion of the fourth protrusion is configured to be disposed within the receptacle, such that the receptacle is configured to receive and collect the second purified aqueous solution from the second distillate layer via the fourth protrusion.

3. The system of claim 2, wherein the system further comprises:
a third stage; wherein the third stage comprises: a third feedwater layer; a third membrane distillation layer; a third distillate layer; and a third thermally conductive layer;
wherein the third feedwater layer is disposed on top of and in physical and fluid contact with the third membrane distillation layer; the third membrane distillation layer is disposed on top of and in physical and fluid contact with the third distillate layer; and the third distillate layer is disposed on top of and in physical and thermal contact with the third thermally conductive layer; and
wherein the second stage is stacked on top of the third stage, such that the second thermally conductive layer is disposed on top of and in physical and thermal contact with the third feedwater layer;
wherein the bottom surface of the system comprises the third thermally conductive layer;
wherein each of the third feedwater layer, the third membrane distillation layer, the third distillate layer, and the third thermally conductive layer independently has a top surface, a bottom surface opposite and spaced apart from the top surface, and a perimeter defined by an edge;
wherein the system further comprises: a sixth protrusion; a seventh protrusion; and
wherein the sixth protrusion extends from a portion of the edge of the third feedwater layer from a proximal end to a distal end opposite and spaced apart from the proximal end, the sixth protrusion being fluidly connected to the fourth feedwater layer from which it extends;
wherein the seventh protrusion extends from a portion of the edge of the third distillate layer from a proximal end to a distal end opposite and spaced apart from the proximal end, the seventh protrusion being fluidly connected to the third distillate layer from which it extends;
wherein the system further comprises: a sixth conduit; and a seventh conduit;
wherein the perimeter of the system is perforated by the sixth conduit and the seventh conduit;
wherein each of the sixth conduit and the seventh conduit independently extends from the perimeter of the system from a proximal end to a distal end;
wherein each of the sixth conduit and the seventh conduit independently has an exterior surface that is substantially impermeable and an interior surface that defines a lumen;
wherein the lumen of the sixth conduit contains a first portion of the sixth protrusion and a second portion of the sixth protrusion extends beyond the distal end of the sixth conduit;
wherein the lumen of the seventh conduit contains a first portion of the seventh protrusion and a second portion of the seventh protrusion extends beyond the distal end of the second conduit;
wherein the second portion of the sixth protrusion is configured to be in contact with the contaminated aqueous solution;
wherein the third feedwater layer is configured to receive a third portion of the contaminated aqueous solution from the sixth protrusion, said third portion of the contaminated aqueous solution being a third feed solution;
wherein the second thermally conductive layer is configured to collect the second latent heat of condensation and conduct the collected second latent heat of condensation to the third feedwater layer to thereby distill the at least a portion of the third feed solution through the third membrane distillation layer, thereby producing a third distillate in the third distillate layer;
wherein the third distillate layer is configured to receive the third distillate from the third membrane distillation layer and condense the third distillate to form a third condensate and release a third latent heat of condensation;
wherein distilling said portion of the third feed solution through the third membrane distillation layer purifies said portion of the third feed solution to produce a third purified aqueous solution as the third condensate;
wherein the distal end of the seventh conduit is configured to be fluidly connected to the receptacle, such that the second portion of the seventh protrusion is configured to be disposed within the receptacle, such that the receptacle is configured to receive and collect: the third purified aqueous solution from the third distillate layer via the seventh protrusion.

4. The system of claim 2, wherein the system further comprises:
one or more additional stages; and a final stage;
wherein each of the one or more additional stages independently comprises: a feedwater layer; a membrane distillation layer; a distillate layer; and a thermally conductive layer;
wherein, in each of the one or more additional stages independently, the feedwater layer is disposed on top of and in physical and fluid contact with the membrane distillation layer; the membrane distillation layer is disposed on top of and in physical and fluid contact with the distillate layer; and the distillate layer is disposed on top of and in physical and thermal contact with the thermally conductive layer; and
wherein the final stage comprises: a final feedwater layer; a final membrane distillation layer; a final distillate layer; and a final thermally conductive layer;
wherein the final feedwater layer is disposed on top of and in physical and fluid contact with the final membrane distillation layer; the final membrane distillation layer is disposed on top of and in physical and fluid contact with the final distillate layer; and the final distillate layer is disposed on top of and in physical and thermal contact with the final thermally conductive layer;
wherein the second stage is stacked on top of the one or more additional stages, which are in turn stacked on top the final stage, such that the thermally conductive layer of a preceding stage is disposed on top of and in physical and thermal contact with the feedwater layer of a subsequent stage;
wherein the bottom surface of the system comprises the final thermally conductive layer;
wherein each of the one or more additional feedwater layers, the final feedwater layer, the one or more additional membrane distillation layers, the final membrane distillation layer, the one or more additional distillate layers, the final distillate layer, the one or more additional thermally conductive layers, and the final thermally conductive layer independently has a top surface, a bottom surface opposite and spaced apart from the top surface, and a perimeter defined by an edge;
wherein the system further comprises: one or more additional feedwater protrusions; one or more additional distillate protrusions; a final feedwater protrusion; and a final distillate protrusion;
wherein each of the one or more additional feedwater protrusions extends from a portion of the edge of one of the one or more additional feedwater layers from a proximal end to a distal end opposite and spaced apart from the proximal end, each of the one or more additional feedwater protrusions being fluidly connected to the additional feedwater layer from which it extends;
wherein each of the one or more additional distillate protrusions extends from a portion of the edge of one or the one or more additional distillate layers from a proximal end to a distal end opposite and spaced apart from the proximal end, each of the one or more additional distillate protrusions being fluidly connected to the additional distillate layer from which it extends;
wherein final feedwater protrusion extends from a portion of the edge of the final feedwater layer from a proximal end to a distal end opposite and spaced apart from the proximal end, the final feedwater protrusion being fluidly connected to the final feedwater layer from which it extends; and
wherein the final distillate protrusion extends from a portion of the edge of the final distillate layer from a proximal end to a distal end opposite and spaced apart from the proximal end, the final distillate protrusion being fluidly connected to the final distillate layer from which it extends;
wherein the system further comprises: one or more additional feedwater conduits; one or more additional distillate conduits; a final feedwater conduit; and a final distillate conduit;
wherein the perimeter of the system is perforated by each of the one or more additional feedwater conduits, one or more additional distillate conduits, the final feedwater conduit, and the final distillate conduit;
wherein each of the one or more additional feedwater conduits, the one or more additional distillate conduits, the final feedwater conduit, and the final distillate conduit independently extends from the perimeter of the system from a proximal end to a distal end;
wherein each of the one or more additional feedwater conduits, the each of the one or more additional distillate conduits, the final feedwater conduit, and the final distillate conduit independently has an exterior surface that is substantially impermeable and an interior surface that defines a lumen;
wherein the lumen of each of the one or more additional feedwater conduits contains a first portion of one of the one or more additional feedwater protrusions and a second portion of said feedwater protrusion extends beyond the distal end of said feedwater conduit;
wherein the lumen of each of the one or more additional distillate conduits contains a first portion of one of the one or more additional distillate protrusions and a second portion of said distillate protrusion extends beyond the distal end of said distillate conduit;
wherein the lumen of the final feedwater conduit contains a first portion of the final feedwater protrusion and a second portion of the final feedwater protrusion extends beyond the distal end of the final feedwater conduit;
wherein the lumen of the final distillate conduit contains a first portion of the final distillate protrusion and a second portion of the final distillate protrusion extends beyond the distal end of the final distillate conduit;
wherein the second portion of each of the one or more additional feedwater protrusions and the second portion of the final feedwater protrusion are each independently configured to be in contact with the contaminated aqueous solution;
wherein each of the one or more additional feedwater layers is independently configured to receive a portion of the contaminated aqueous solution from its respective feedwater protrusion, said portion of the contaminated aqueous solution being a feed solution;
wherein the final feedwater layer is configured to receive a final portion of the contaminated aqueous solution from the final feedwater protrusion, said final portion of the contaminated aqueous solution being a final feed solution;
wherein the thermally conductive layer of a preceding stage is configured to collect the latent heat of condensation released during the formation of the condensate in said preceding stage and conduct the collected latent heat of condensation to the feedwater layer of a subsequent stage to thereby distill at least a portion of the feed solution through the membrane distillation layer of said subsequent stage, thereby producing a distillate in said distillate layer;
wherein said distillate layer is configured to receive said distillate from said membrane distillation layer and condense the distillate to form a condensate and release a latent heat of condensation;
wherein distilling said portion of the feed solution through the membrane distillation layer purifies said portion of the feed solution to produce a purified aqueous solution as the condensate;
wherein the distal end of each of the one or more additional distillate conduits and the distal end of the final distillate conduit are each independently configured to be fluidly connected to the receptacle, such that the second portion of each of the one or more additional distillate protrusions and the second portion of the final distillate protrusion are each independently configured to be disposed within the receptacle, such that the receptacle is configured to receive and collect the purified aqueous solution from each of the one or more additional distillate layers via their respective distillate protrusions and from the final distillate layer via the final distillate protrusion.

5. The system of claim 1, wherein the system further comprises the receptacle.

6. The system of claim 1, wherein the system is buoyant.

7. The system of claim 1, wherein the system further comprises a buoyant frame that is configured to be coupled to the system and/or the receptacle such that the system and/or the receptacle is buoyant.

8. The system of claim 1, wherein the system is configured to be deployed in a reservoir containing the contaminated aqueous solution, the contaminated aqueous solution in the reservoir having a surface, and wherein the system is configured to be buoyant, such that the system floats in the contaminated aqueous solution when deployed therein, such that at least the solar absorber layer is disposed above the surface of the contaminated aqueous solution.

9. The system of claim 1, wherein the solar absorber layer comprises black paint, a carbonaceous material, or a combination thereof.

10. The system of claim 4, wherein each of the protrusions and their respective feedwater or distillate layers independently comprise a hydrophilic polymer.

11. The system of claim 4, wherein each of the protrusions and their respective feedwater or distillate layers independently comprise cellulose or derivatives thereof, polyacrylonitrile or derivatives thereof, or combinations thereof.

12. The system of claim 4, wherein the top surface of each membrane distillation layer is superhydrophobic.

13. The system of claim 4, wherein each membrane distillation layer independently comprises a porous distillation membrane.

14. The system of claim 10, wherein the porous distillation membrane comprises a hydrophobic polymer.

15. The system of claim 10, wherein the porous distillation membrane comprises polyvinylidene fluoride (PVDF), polypropylene, polytetrafluoroethylene (PTFB), polyamide, derivatives thereof, or combinations thereof.

16. The system of claim 4, wherein each of the thermally conductive layers independently comprises a thermally conductive and corrosion resistant material.

17. The system of claim 4, wherein the system has five or more stages in total.

18. The system of claim 1, wherein the system has a specific water productivity of 1 liters of water per square meter of area of the top surface of the system per hour (L m⁻² h⁻¹, LMH) or more.

19. The system of claim 1, wherein the purified aqueous solution comprises potable water.

20. A method of use of the system of claim 1, wherein the method comprises deploying the system in a contaminated aqueous solution and exposing the system to solar radiation to form a purified aqueous solution.
